(19) United States
(12) Patent Application Publication
(10) Pub. No.: US 2024/0430203 A1
(43) Pub. Date: Dec. 26, 2024

(54) REMOTE CONTROL OF VARIABLES FOR ROUTING IN COMMUNICATION NETWORKS

(71) Applicant: CURATED NETWORKS, Santa Cruz, CA (US)

(72) Inventor: Bradley R. Smith, Santa Cruz, CA (US)

(73) Assignee: CURATED NETWORKS, Santa Cruz, CA (US)

(21) Appl. No.: 18/752,538

(22) Filed: Jun. 24, 2024

Related U.S. Application Data
(60) Provisional application No. 63/522,886, filed on Jun. 23, 2023.

(51) Int. Cl. H04L 47/17; H04L 45/00

(52) U.S. Cl. CPC H04L 47/17; H04L 45/14

(57) ABSTRACT

Systems, methods, and computer-readable media for providing remote control of Boolean variables defining expressions determining resource utilization of a communication network are provided.

### CROSS-REFERENCE TO RELATED APPLICATION(S)

This application claims the benefit of prior filed U.S. Provisional Patent Application No. 63/522,886, filed Jun. 23, 2023, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to communication networks and, more particularly, to remote control of Boolean variables defining expressions determining resource utilization of communication networks.

### BACKGROUND OF THE DISCLOSURE

Internet routing may be based on use of a best path to a given destination. Some best-path models may limit communication applications to the use of a single-path in an Internet environment. Furthermore, a common use of destination-based forwarding in the Internet is a particularly aggressive form of single-path communication. With destination-based forwarding, the path used to carry traffic through an intermediate node to a destination is often an extension of the path from the intermediate node to the destination. This strong tendency for traffic to be concentrated on a subset of available paths may result in inefficient use of network resources, such as with traffic experiencing congestion while network resources may be idle.

### SUMMARY OF THE DISCLOSURE

This document describes systems, methods, and computer-readable media for providing remote control of Boolean variables defining expressions determining resource utilization of communication networks.

For example, a method for communicating data in a data network including a plurality of router nodes is provided, where the method may include computing, for each router node of the plurality of router nodes, a best set of routes subject to a partial ordering, assigning, at each router node of the plurality of router nodes, a local label that is unique to the particular router node for each computed route of the computed best set of routes for the particular router node, and defining, at a first router node of the plurality of router nodes, a next hop label for a first computed route of the computed best set of routes for the first router node based on the local label assigned for the first computed route at a second router node of the plurality of router nodes that is the next hop router node from the first router node for the first computed route.

As yet another example, a method for communicating data in a data network including a plurality of router nodes is provided, where the method may include defining Boolean variables reflecting states relevant to policies for resource utilization of the data network, defining Boolean expressions with the defined Boolean variables for providing constraints, computing routes and forwarding traffic within the data network based on the defined Boolean expressions, determining when a state change occurs that results in a change in a value of any defined Boolean variable, and, in response to the determining, at least one of recomputing the routes or updating forwarding rules associated with the routes.

As yet another example, a method for communicating data in a data network including a plurality of router nodes is provided, where the method may include identifying Boolean variables relevant to policies for resource utilization of the data network, classifying each identified Boolean variable as at least one of a routing variable or a forwarding variable, using at least one classified routing variable to carry out a routing computation for the data network, and using at least one classified forwarding variable to carry out a path selection computation for the data network.

As yet another example, a method for communicating data in a data network including a plurality of router nodes is provided, where the method may include computing, for each router node of the plurality of router nodes, a best set of routes subject to a partial ordering, assigning, at each router node of the plurality of router nodes, a local label that is unique to the particular router node for each computed route of the computed best set of routes for the particular router node, and defining, at each router node of the plurality of router nodes, a next hop label for each computed route of the computed best set of routes for the particular router node based on the local label assigned for the particular computed route at the router node that is the next hop router node from the particular router node for the particular computed route.

As yet another example, a method for communicating data in a system including a data network and a remote data device communicatively coupled to the data network is provided, where the data network includes a plurality of router nodes, and where the method may include computing with the data network, for each router node of the plurality of router nodes, a best set of routes subject to a partial ordering, assigning with the data network, at each router node of the plurality of router nodes, a local label that is unique to the particular router node for each computed route of the computed best set of routes for the particular router node, defining with the data network, at a first router node of the plurality of router nodes, a next hop label for a first computed route of the computed best set of routes for the first router node based on the local label assigned for the first computed route at a second router node of the plurality of router nodes that is the next hop router node from the first router node for the first computed route, receiving, at the first router node, at least one initial packet of a flow, determining, with the data network, a plurality of flow constraints of the flow based on the received at least one initial packet, wherein the determining may include identifying a first flow constraint of the plurality of flow constraints, and wherein the identifying includes accessing, with the data network, a value of a first Boolean constraint variable from the remote data device using a web uniform resource locator (“URL”)-based interface, selecting the first computed route from the computed best set of routes for the first router node based on at least the identified first flow constraint, and forwarding, from the first router node to the second router node, a packet of the flow along with the defined next hop label for the selected first computed route for the first router node

As yet another example, a method for communicating data in a system including a data network and a remote data device communicatively coupled to the data network is provided, where the data network includes a plurality of router nodes, and where the method may include defining Boolean variables reflecting states relevant to policies for resource utilization of the data network, defining Boolean expressions with the defined Boolean variables for providing constraints, computing routes and forwarding traffic within the data network based on the defined Boolean expressions, determining when a state change occurs that results in a change in a value of any defined Boolean variable, wherein the determining may include accessing, with the data network, a value of a first Boolean constraint variable from the remote data device using a web uniform resource locator (“URL”)-based interface, and in response to the determining, at least one of: recomputing the routes or updating forwarding rules associated with the routes.

As yet another example, a method for communicating data in a system including a data network and a remote data device communicatively coupled to the data network is provided, where the data network includes a plurality of router nodes, and where the method may include identifying Boolean variables relevant to policies for resource utilization of the data network, wherein the identifying may include accessing, with the data network, a value of a first identified Boolean variable of the identified Boolean variables from the remote data device using a web uniform resource locator (“URL”)-based interface, classifying each identified Boolean variable as at least one of: a routing variable or a forwarding variable, using at least one classified routing variable to carry out a routing computation for the data network, and using at least one classified forwarding variable to carry out a path selection computation for the data network.

As yet another example, a data processing system is provided that includes a processor to execute instructions and a memory coupled with the processor to store instructions, which when executed by the processor, cause the processor to perform operations to generate an application programming interface (“API”) that allows an API-calling component to perform the following operations: define Boolean variables reflecting states relevant to policies for resource utilization of a data network; define Boolean expressions with the defined Boolean variables for providing constraints; compute routes and forward traffic within the data network based on the defined Boolean expressions; determine when a state change occurs that results in a change in a value of any defined Boolean variable by accessing, with the data network, a value of a first Boolean constraint variable from a remote data device using a web uniform resource locator (“URL”)-based interface; and, in response to the determining, at least one of: recompute the routes; or update forwarding rules associated with the routes.

As yet another example, a data processing system is provided that includes a memory to store program code and a processor to execute the program code to generate an application programming interface (“API”), including means for defining Boolean variables reflecting states relevant to policies for resource utilization of a data network, means for defining Boolean expressions with the defined Boolean variables for providing constraints, means for computing routes and forwarding traffic within the data network based on the defined Boolean expressions, means for determining when a state change occurs that results in a change in a value of any defined Boolean variable by accessing, with the data network, a value of a first Boolean constraint variable from a remote data device using a web uniform resource locator (“URL”)-based interface, and, in response to the determining, at least one of means for recomputing the routes or means for updating forwarding rules associated with the routes.

As yet another example, a machine-readable storage medium that provides instructions that, if executed by a processor, will cause the processor to generate an application programming interface (“API”) that allows an API-implementing component to perform operations is provided, the operations including defining Boolean variables reflecting states relevant to policies for resource utilization of a data network, defining Boolean expressions with the defined Boolean variables for providing constraints, computing routes and forwarding traffic within the data network based on the defined Boolean expressions, determining when a state change occurs that results in a change in a value of any defined Boolean variable, wherein the determining includes accessing, with the data network, a value of a first Boolean constraint variable from a remote data device using a web uniform resource locator (“URL”)-based interface, and, in response to the determining, at least one of recomputing the routes or updating forwarding rules associated with the routes.

As yet another example, a data processing system is provided that includes an application programming interface (“API”)-implementing component and an API to interface the API-implementing component with an API-calling component, wherein the API includes means for defining Boolean variables reflecting states relevant to policies for resource utilization of a data network, means for defining Boolean expressions with the defined Boolean variables for providing constraints, means for computing routes and forwarding traffic within the data network based on the defined Boolean expressions, means for determining when a state change occurs that results in a change in a value of any defined Boolean variable, wherein the determining includes accessing, with the data network, a value of a first Boolean constraint variable from a remote data device using a web uniform resource locator (“URL”)-based interface, and, in response to the determining, at least one of means for recomputing the routes or means for updating forwarding rules associated with the routes.

As yet another example, a data processing system is provided that includes a processor to execute instructions and a memory coupled with the processor to store instructions, which when executed by the processor, cause the processor to perform operations to generate an application programming interface (“API”)-implementing component that implements an API, wherein the API exposes one or more functions to an API-calling component, the API including a function to define Boolean variables reflecting states relevant to policies for resource utilization of a data network, a function to define Boolean expressions with the defined Boolean variables for providing constraints, a function to compute routes and forward traffic within the data network based on the defined Boolean expressions, a function to determine when a state change occurs that results in a change in a value of any defined Boolean variable by accessing, with the data network, a value of a first Boolean constraint variable from a remote data device using a web uniform resource locator (“URL”)-based interface, and, in response to the determining, at least one of a function to recompute the routes or a function to update forwarding rules associated with the routes.

As yet another example, a data processing system is provided that includes a processor to execute instructions and a memory coupled with the processor to store instructions, which when executed by the processor, cause the processor to interface a component of the data processing system with an application programming interface (“API”)-calling component and to perform the following operations: defining Boolean variables reflecting states relevant to policies for resource utilization of a data network, defining Boolean expressions with the defined Boolean variables for providing constraints, computing routes and forwarding traffic within the data network based on the defined Boolean expressions, determining when a state change occurs that results in a change in a value of any defined Boolean variable, wherein the determining includes accessing, with the data network, a value of a first Boolean constraint variable from a remote data device using a web uniform resource locator (“URL”)-based interface, and, in response to the determining, at least one of recomputing the routes or updating forwarding rules associated with the routes.

As yet another example, an apparatus is provided that includes a machine-readable storage medium that provides instructions that, when executed by a machine, will cause the machine to allow an application programming interface (“API”)-calling component to perform operations, the operations including defining Boolean variables reflecting states relevant to policies for resource utilization of a data network, defining Boolean expressions with the defined Boolean variables for providing constraints, computing routes and forwarding traffic within the data network based on the defined Boolean expressions, determining when a state change occurs that results in a change in a value of any defined Boolean variable, wherein the determining includes accessing, with the data network, a value of a first Boolean constraint variable from a remote data device using a web uniform resource locator (“URL”)-based interface, and, in response to the determining, at least one of recomputing the routes or updating forwarding rules associated with the routes.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic diagram illustrating a system including portion of a communications network including multiple router devices and a central network controller device, according to some embodiments of the disclosure;

FIG. TA is a more detailed schematic view of a system device of the system of FIG. 1, according to some embodiments of the disclosure;

FIG. 2 is a schematic diagram illustrating data structures used by a routing process, according to some embodiments of the disclosure;

FIG. 3 is a schematic diagram illustrating path selection of flows in a network router device, according to some embodiments of the disclosure;

FIG. 4 illustrates a flowchart of an exemplary process for packet routing, according to some embodiments of the disclosure;

FIG. 5 shows a part of a network where the number of hops between routing devices varies and where each device does or does not satisfy a particular Boolean test, according to some embodiments of the disclosure;

FIGS. 6A and 6B show a pair of truth tables corresponding to FIG. 5;

FIG. 7 shows routing table entries computed for a Boolean Constrained Multipath Routing algorithm, according to some embodiments of the disclosure with respect to the network of FIG. 5;

FIG. 8 shows, for different routes, the truth assignments to variables in Boolean constraints of FIG. 7, according to some embodiments of the disclosure;

FIGS. 9 and 10 show routing table entries of illustrative data structures with respect to the network of FIG. 5, according to some embodiments of the disclosure;

FIG. 11 shows destination independent multipath forwarding table entries of an illustrative data structure with respect to the network of FIG. 5, according to some embodiments of the disclosure;

FIGS. 12 and 13 illustrate flowcharts of exemplary processes for providing multipath routing, according to some embodiments of the disclosure;

FIG. 14 shows a part of a network with different links associated with different Boolean constraints and with different nodes associated with different communication table data structures, according to some embodiments of the disclosure;

FIG. 15 illustrates a flowchart of an exemplary process for providing autonomic network routing, according to some embodiments of the disclosure;

FIG. 16 shows a part of another network with different links associated with different Boolean constraints, according to some embodiments of the disclosure;

FIG. 17 shows a part of yet another network with different links associated with different Boolean constraints, according to some embodiments of the disclosure;

FIG. 18 illustrates a flowchart of an exemplary process for processing Boolean constraints for use in multipath routing, according to some embodiments of the disclosure;

FIG. 19 is a block diagram of an illustrative application programming interface (“API”) architecture, according to some embodiments of the disclosure;

FIG. 20 is a block diagram of an illustrative API software stack, according to some embodiments of the disclosure;

FIG. 21 is a Hasse diagram of shortest-and-widest constraints, according to some embodiments of the disclosure;

FIG. 22 is a graph that plots weights of paths with bandwidth and latency metrics, according to some embodiments of the disclosure;

FIG. 23 is a graph that depicts regions satisfied by each path of the graph of FIG. 22, according to some embodiments of the disclosure;

FIG. 24 is a graph that shows the dominant paths of the graph of FIG. 23, according to some embodiments of the disclosure;

FIG. 25-27 are computations illustrating a process of building a path one hop at a time, according to some embodiments of the disclosure;

FIG. 28 shows a part of a network configured for support of quality of service requirements, according to some embodiments of the disclosure;

FIG. 29 shows a part of a network configured for support of multilevel security requirements, according to some embodiments of the disclosure;

FIG. 30 is a schematic diagram illustrating a system configured to provide support for zero trust security applied to a three layer web application architecture, according to some embodiments of the disclosure;

FIG. 31 is a schematic diagram illustrating a system configured to provide support for a time-of-day backup scenario, according to some embodiments of the disclosure;

FIG. 32 shows a part of a network configured for support of multilevel security requirements, according to some embodiments of the disclosure;

FIG. 33 shows a table of test results for a system, according to some embodiments of the disclosure;

FIGS. 34-40C are views of at least portions of screens of a graphical user interface of a networking with constraints system, according to some embodiments of the disclosure;

FIGS. 41, 41A, and 41B are a group of truth tables illustrating a OneHot function; and

FIGS. 42-44 are views of at least portions of screens of a graphical user interface of a networking with constraints system, according to some embodiments of the disclosure.

### DETAILED DESCRIPTION OF THE DISCLOSURE

Systems, methods, and computer-readable media for providing remote control of Boolean variables defining expressions determining resource utilization of a data network providing multipath routing in communication networks are provided.

The Internet may be based on a single-path communications model. This model may impose significant constraints on the ability of the Internet to satisfy any quality-of-service (“QoS”) requirements of network applications and may result in significant inefficiencies in the use of network resources that may be manifested as congestion. This has often resulted in over-provisioning Internet-based systems to meet the basic needs of modern communications. With the adoption of the Internet as the converged communication infrastructure for the 21st century, this may not be an acceptable long-term solution.

Two basic approaches to packet switching may be virtual circuits and datagrams. Both schemes may segment messages into limited-size packets, add control information to each packet to accomplish its switching, and rely on statistical multiplexing of the shared communication links. Virtual circuits may emulate circuit-switching, such as used in the early telephone network. The virtual-circuit model may be connection-oriented, in that communication may occur in three phases (e.g., path setup, data transfer, and path teardown), routing may be done once per flow by the ingress node during path setup, and paths may be implemented using label-swap forwarding such that all traffic for a given flow may follow the same path through the network. It is to be understood that the term “path” and the term “route” may be used interchangeably herein (e.g., when referring to a computed path or route between a start node or router and an end node or router).

In contrast, packet switching based on datagrams may be a more drastic departure from the circuit-switching model. Datagram switching may be connectionless in that there may be no phases in the communication process, packets may be transmitted when the source host is ready to transmit, routing may be computed at every router in the network on an event-driven basis, and the forwarding decision may be made on a hop-by-hop basis as packets flow through the network with the result that different packets in a given flow may follow different paths through the network.

The datagram approach to packet switching has a number of strengths. It is robust in the sense that it may co-locate the routing process with the state it computes, manifesting a design principle called fate-sharing. This may ensure that the failure of any single component of an internet does not invalidate one or more states located elsewhere in the internet, effectively localizing the effects of any failures. The datagram model may be efficient and responsive for a couple of reasons. First, by implementing distributed control of forwarding state it may require only simplex communication of topology change events. Second, by assuming a distributed, hop-by-hop routing model, the datagram model may enable the use of more efficient and responsive routing algorithms that can operate with partial information regarding the topology of the network.

Virtual-circuit switching may be based on a centralized routing model in that routes may be computed on-demand, and forwarding may be source-specified through the use of path setup techniques. Hence, virtual circuits may be less robust than datagrams due to the ingress router controlling remote forwarding state in routers along the paths it has set up. The virtual-circuit model may be less efficient and responsive for a couple of reasons. First, by implementing centralized control of forwarding state, it may require duplex communication of topology change events, outbound notification of a topology event, and inbound notification of forwarding state changes. Second, by assuming a centralized routing computation, the virtual-circuit model may require the use of full-topology routing algorithms to ensure every router can compute optimal paths to any destination in an internet.

The architecture of today's Internet may be based on the Catenet model of internetworking. In the Catenet model, networks may be built by the concatenation of disparate networks through the use of routers. The primary goals of the Catenet model, and therefore the Internet architecture, may be to support packet-switched communication between computers over internets composed of networks based on diverse network technologies, and to encourage the development and integration of new networking technologies into these internets.

To achieve these goals, a simple but powerful variant of the datagram communication model may be adopted. Specifically, the Internet routing architecture may be based on a best effort communication model in which the “best” path may be pre-computed by each router to all destinations (e.g., triggered by topology changes), and packets may be forwarded on a best effort basis (and may be dropped or delivered out of order in the event of congestion or routing changes). Packet forwarding may be implemented on a hop-by-hop basis using a destination-address based packet forwarding state computed by the routing process.

This best-effort, distributed, hop-by-hop, datagram routing model has proven surprisingly powerful. Indeed, much of the success of the Internet architecture can be attributed to its routing model. However, largely as a product of its own success, limitations of this model are being encountered as it is applied to more demanding applications.

A significant limitation may be the model only supports a single path to each destination. Specifically, Internet forwarding state may be composed of a single entry for each destination in an internet giving the next-hop router on the path to the destination. As a result, only one path may be supported to any given destination, and that path may be computed to optimize a single metric.

Unfortunately, the single-path limitation of the Internet may not be adequate for many of the demanding applications to which the Internet is currently being applied, such as the need for routing flows according to desired policies.

In addition, single-path routing may result in significant inefficiencies in the use of network resources. With single-path routing, multiple flows can be routed over one or more congested links while other regions of the network are lightly loaded.

In view of the above, it is desirable to improve support for implementing routing policies as well as the use of multiple paths for congestion control while being compatible with the Internet architecture in terms of implementing a datagram communication model (e.g., pre-computation of routes and hop-by-hop forwarding).

Two enhancements to the Internet architecture may attempt to solve the problem of resource management in the context of performance requirements: the Intserv and Diffserv architectures.

A goal of the integrated services (Intserv) architecture may be to define an integrated Internet service model that supports best-effort, real-time, and controlled link sharing requirements. Intserv may make the assumption that network resources may be explicitly controlled and may define an architecture where applications may reserve the network resources required to implement their functionality, and an infrastructure of admission control, traffic classification, and traffic scheduling mechanisms that implement the reservations. In the Intserv architecture, resource reservations may be sent along paths computed by the existing routing infrastructure. As a result, requests may be denied when resources do not exist along the current route when in fact paths exist that could satisfy the request. Intserv may be based on a virtual-circuit communications model and, as such, may have all the limitations of that model relating to robustness, efficiency, and responsiveness discussed above.

In contrast, the differentiated services (Diffserv) architecture may provide resource management without the use of explicit reservations. In Diffserv, a small set of per-hop forwarding behaviors (“PHBs”) may be defined within a Diffserv domain that may provide resource management services appropriate to a class of application resource requirements. Traffic classifiers may be deployed at the edge of a Diffserv domain that classify traffic for one of these PHBs. Inside a Diffserv domain, routing may be performed using traditional hop-by-hop, address-based forwarding mechanisms.

Diffserv may retain the best-effort, distributed, hop-by-hop, datagram routing model of the Internet, and therefore may retain the robustness, efficiency, and responsiveness of the Internet. However, similar to the Intserv model, communications resources to a given flow in a Diffserv environment may be limited to those available along the paths computed by the existing routing infrastructure.

In addition, significant research has been done into multipath solutions for QoS and congestion, with a search for comprehensive solution that may be compatible with the Internet's datagram, hop-by-hop model of communication.

Paganini and Mallada (“A unified approach to congestion control and node-based multipath routing,” IEEE/ACM Transactions on Networking, 17(5):1413-1426, October 2009) may present a solution for implementing congestion control in the network layer. The solution may compute multiple paths per destination in the routing computation and distribute traffic among these paths in response to a local measure of congestion based on queueing delay. Results may be presented from simulations run with a RIP-based implementation of the algorithm. The solution may pre-compute paths and use hop-by-hop forwarding. However it may only address congestion control.

In summary, a comprehensive, multipath solution that both supports policies for flows and addresses congestion that is consistent with the Internet architecture's use of pre-computed routes and hop-by-hop forwarding is desirable.

A solution to the problems of congestion and providing policy-control of the use of network resources for network applications and administrators may be through the routing of traffic over multiple paths between a given source and destination. Constraints can be defined using a Boolean Algebra where Boolean variables may be used to represent policy-relevant properties of network traffic and network state, and Boolean expressions composed of these variables may express the constraints that may be required of flows using the network. A set of paths may simultaneously provide a full range of policies available in the network. This set of paths may be used to load balance traffic (e.g., to avoid congestion) and/or to select paths for flow requests that may meet the policy constraints of the specific flow. These constraints can run from a full range of policies available in a network (e.g., where the application requirements may be not known ahead of time or may be changing), to a set of specific constraint targets that may be selected to meet the needs of a set of applications.

Policy requirements of a flow may be specified in a declarative manner, allowing the network users and administrators to state what performance and policies routes used for a given application should provide without requiring the specification of an exact procedure to be used in selecting appropriate paths. This may make it possible to assign flows to paths that may both satisfy the desired policies and minimize congestion. In comparison, other solutions may require a detailed specification of how to compute paths that meet the requirements for a given communication application.

A possible solution of this disclosure may provide a number of potential commercial advantages in the network routing market. As one example, routes may be selected that satisfy policy constraints (e.g., as specified by the user and/or network owner), which may support a number of specific uses, such as service differentiation for network services (e.g., Bronze, Silver, Gold level network access) that may allow for increased revenue from existing network infrastructure, support for micro-segmentation with a network security model where fine-grained security policies may be enforced down to the workload level that may allow military-style Multi-Level Security (“MLS”) or, more generally, restriction of traffic to subsets of a network, to be enforced in an Internet environment.

Micro-segmentation may be implemented in virtualized environments. More broadly, lack of micro-segmentation capabilities in the Internet may result in the need to physically implement redundant networks to meet these policy constraints. As another example, the computation of multiple paths to each destination may result in the availability of a number of paths that satisfy a given network flow. This may provide the opportunity to select the path from these options that minimizes congestion.

Certain techniques may use Boolean Constrained Multipath Routing (“BCMR”) together with BCMR-compatible forwarding techniques. A BCMR algorithm may compute the shortest set of routes between each source node and destination node that may satisfy the full range of policy constraints possible in the network. This set may be used to route flows over paths that satisfy the desired policy constraints on the use of network resources for a given flow.

Policy constraints may be specified using Boolean expressions that may be composed of a subset of Boolean variables that may represent policy-relevant properties of network traffic, network resources, and network state. For each flow request, there may be a set of Boolean expressions (e.g., specifying the policy constraints for the flow) that may express the desired policies for routing of traffic for the given flow in the network.

A BCMR algorithm may compute, for each truth assignment to the flow's policy constraints, the shortest route from the set of routes where this truth assignment may be satisfying for the flow's policy constraints. This set of routes may represent a best satisfying set of routes between the source and destination that may provide the shortest paths for the full set of truth assignments that may be satisfying for the flow constraints. A traffic classification function may be then defined for assigning new flows to paths that may meet the Boolean constraints relevant for the new flow and may have capacity for the new flow, thereby reducing congestion.

Thus, a solution may be provided to the problems of congestion and providing policy control for network applications through the routing of traffic over multiple paths between a given source and destination. This may enable use of a set of paths that satisfies the full range of policies needed of a network for the applications to be deployed over the network. This set of paths may be used to load balance traffic (e.g., to avoid congestion) and/or to select paths for flow requests that may meet the policy requirements of a specific flow. This set of policies can range from the full range of policies supported by a network (e.g., where the application requirements are not known ahead of time or are changing), to a set of specific targets selected to meet the needs of a set of applications (e.g., for the network to be used for military multi-level-security, a set of Boolean constraints may be defined that provide hierarchical security with the common example of unclassified, secret, and top secret security levels).

A packet routing method may be implemented in a data network by network routing equipment. Preferably, the network may be a wired data network and the packets may be routed over wired connections between network routers. A solution method may include computing, for each source node in the data network and each destination node in the data network, a set of multiple routes providing the shortest paths for a full range of policies from the source node to the destination node. The multiple routes may preferably be precomputed and stored. The full range of policies may be defined by a set of best satisfying routes, which may be defined as follows. Given a flow request, for each route from the source node to the destination node, there may be a set of Boolean constraints that define the policy requirements for the given flow to use that path, and truth assignments (e.g., the flow request truth assignment) to some subset of the Boolean variables contained in this set of Boolean constraints. Each of the shortest satisfying routes may be defined as the shortest route for a truth assignment that satisfies the Boolean constraints in the context of the flow request truth assignment.

A solution method may additionally or alternatively include selecting, for a packet originating from a source node and addressed to a destination node, a route from the computed set of multiple routes, where the selecting may include (i) determining the Boolean constraints for the packet based on traffic classification rules, and (ii) selecting the route that minimizes network congestion and satisfies the Boolean constraint requirements for the packet. A solution method may additionally or alternatively include forwarding the packet in accordance with the selected route.

The selecting may include determining Boolean constraints for the packet based on traffic classification rules that may be specified in terms of contents of the packet, in terms of a user associated with the packet, in terms of a port the packet arrives on, and/or in terms of one or more other environmental factors.

A solution method may additionally or alternatively be implemented in a data network by performing all operations at a single network router device. A solution method may additionally or alternatively be implemented in a data network by performing computing and selecting operations at a central network controller device, and performing a forwarding operation at a network router device. Such an implementation may correspond to a “software-defined networking” approach, a popular example being “OpenFlow.” A solution method may additionally or alternatively be implemented in a data network by performing a computing operation at a central network controller device, and performing selecting and forwarding operations at a network router device.

In some embodiments, selecting a route may include, if a label-swap tag is not present in the packet, computing the label-swap tag from traffic classification rules that may be specified in terms of contents of the packet, in terms of a user associated with the packet, in terms of a port the packet arrives on, and/or in terms of one or more other environmental factors. If a label-swap tag is already present in the packet, the forwarding may include forwarding the packet based on the label-swap tag in the packet.

In some embodiments, selecting a route may include, if a source route is not present in the packet, computing the source route from traffic classification rules that may be specified in terms of contents of the packet, in terms of a user associated with the packet, in terms of a port the packet arrives on, and/or in terms of one or more other environmental factors. If a source route is already present in the packet, the forwarding may include forwarding the packet based on the source route in the packet.

In some embodiments, selecting the route may include, if a segment list is not present in the packet, computing the segment list from traffic classification rules that may be specified in terms of contents of the packet, in terms of a user associated with the packet, in terms of a port the packet arrives on, and/or in terms of one or more other environmental factors. If a segment list is already present in the packet, the forwarding may include forwarding the packet based on the segment list in the packet.

In some embodiments, selecting a route may include performing network load balancing among a computed set of multiple routes.

In addition, in some embodiments, selecting a set of routes may select the dominant set of routes for each satisfying truth assignment, or may select a set of routes that meets specific performance needs of a predetermined set of applications that are to be deployed over the network. This targeted or customized routing model can be valuable in some circumstances (e.g., to reduce the overhead costs of this kind of routing). In general, a method may compute routes with the full range of performance requirements for a satisfying truth assignment when the application mix is not known ahead of time or is continually changing, and the method may compute routes using targeted routing for each satisfying truth assignment when the application mix is fixed or predetermined and efficiency is important.

Therefore, use of the Internet may involve a wide range of applications with diverse requirements in terms of policy constraints. The diverse requirements of these applications may not be well served by existing Internet routing architecture. An architecture that may make use of a set of paths between each source and destination that support the full range of policies available in a network may be beneficial.

The problems of congestion and providing policy-control of the use of network resources for network applications and administrators may be addressed through the routing of traffic over multiple paths between a given source and destination. An example of this policy-control relating to the use of a network may be in a military context where paths may be rated as to the level of sensitivity of content they can carry (e.g., TOP-SECRET, SECRET, UNCLASSIFIED). One path that traverses links that provide a high level of security (e.g., fiber optic links, which may be difficult to tap, in secured facilities, wireless links using strong encryption protocols where the end-points may be in secured facilities, etc.) may be rated to carry TOP-SECRET traffic, while another path composed only of relatively unsecured links (e.g., a path over the public Internet) may be rated to only carry UNCLASSIFIED traffic. In the abstract, these paths may be not comparable. However, in the context of a specific use, one may generally be clearly preferred over the other (e.g., sensitive military operational traffic may require the TOP-SECRET path while general web browsing may make use of the UNCLASSIFIED path).

These constraints can be defined using a Boolean Algebra where Boolean variables may be used to represent policy-relevant properties of network traffic and network state, and Boolean expressions composed of these variables may express the policy constraints required of flows using the network.

Therefore, certain techniques may use a Boolean algebra to define and compute the set of paths in a network that may satisfy constraints defined using the Boolean algebra, as may be described in U.S. Patent Application Publication No. 2020/0236034, which is hereby incorporated by reference herein in its entirety. Additionally, U.S. Pat. No. 9,197,544, which is hereby incorporated by reference herein in its entirety, discusses the use of a path algebra in the context of dominant path routing instead of a Boolean algebra for Boolean constrained routing.

A Boolean algebra can be used in a “General-Policy-Based Dijkstra” algorithm to compute the set of paths that may simultaneously provide the full range of policies (e.g., in terms of the Boolean constraints) available in the network.

The computation of routes subject to Boolean constraints expressing policies, and the use of these paths subject to congestion reduction, may be provided by solution methods herein. This disclosure also provides a forwarding technique based on the routing.

A flow may be defined as a sequence or set or stream of packets that may satisfy or be subject to the same set of constraints (e.g., performance constraints and/or policy constraints and/or service chaining constraints, etc.) (e.g., Boolean constraints only or both Boolean constraints and performance constraints)) and may therefore be subject to the same set of policies. The term flow in the present context might not be related to Internet Protocol version 6 (“IPv6”), and, actually, may be independent of any specific protocol.

One path value (x) may be said to dominate another (y) where the set of truth assignments where y is true is a subset of the truth assignments where x is true (e.g., in their truth tables), whereby the Boolean expression x satisfies more truth assignments than y. For a network example, if there is a shorter path A with path value Boolean expression y and a longer path B with Boolean expression x, route B may ought to be included in the routing tables because, even though it is longer, it satisfies some potential truth assignments that the shorter route A does not satisfy.

In dominant set multipath routing (“DSMR”), dominance in DSMR may be defined differently, such as by U.S. Pat. No. 9,197,544, as follows: “[t]he full range of performance is defined by a set of dominant routes, where each route from the source node to the destination node in the data network has multiple distinct performance metrics defining coordinates of a corresponding point in a multi-dimensional space. The multiple distinct performance metrics defining coordinates of the multi-dimensional space may include, for example, metrics such as a bandwidth metric, a latency metric, a jitter metric, and a reliability metric. Each of the dominant routes is defined as a route that has a corresponding point in the multi-dimensional space that is maximal with respect to a partial order defined on points in the multi-dimensional space corresponding to routes from the source node to the destination node.” Multiple distinct route performance metrics may be represented as points in a multi-dimensional space, such that the routes can be organized using a partial ordering of the points. The term “partial order” may be defined in accordance with its standard mathematical definition (e.g., a partial order on a set R may be a relation that is reflexive, anti-symmetric, and transitive). A partial order may be distinguished from a familiar notion of a linear order (or total order). For example, the relation “≤” (less than or equal) may define a linear order on the set of real numbers. This linear order may have the property that, given two numbers a and b, it is always the case that a≤b or b≤a. With a partial order, however, this property (e.g., as may be called comparability) may not be in general satisfied for any two elements. Moreover, whereas a finite set may have just one unique linear order, it can have multiple distinct partial orderings. Routes in a network may correspond to points in a multi-dimensional space, and a partial order may be defined on this set of points. Weights of a set of paths to a destination may be viewed as a partially ordered set, and a dominant set of weights for such a partial order may be computed as a foundation of a forwarding table.

For BCMR, dominance may be defined very differently, where, for example, a Boolean expression can be described using a truth table with one column for each Boolean variable in the expression, and a final column for the Boolean expression, and where each row may contain a truth assignment of the values of either True or False to each variable (e.g., for n variables, there will be 2ⁿ rows), and the expression column may show the value of the expression given the truth assignments to the variables in that row.

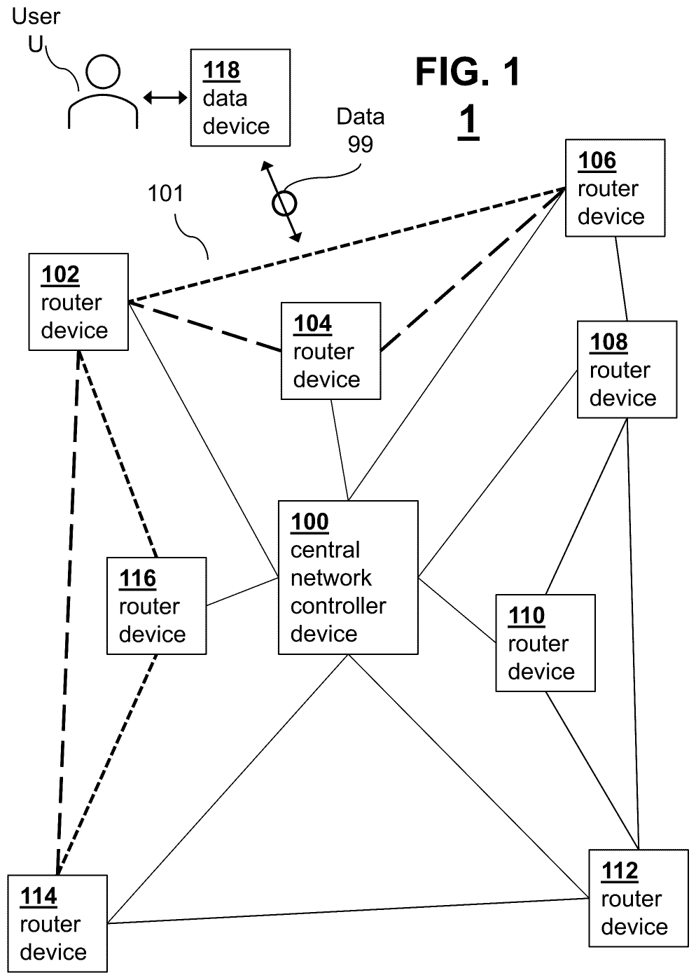

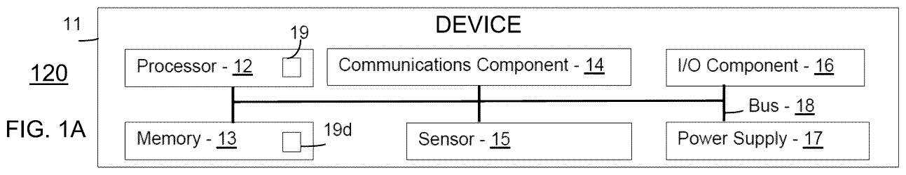

FIG. 1 is a schematic diagram illustrating a portion of any suitable system 1 that may include any suitable network 101 of suitable number of any suitable type(s) of router devices, such as router devices 102, 104, 106, 108, 110, 112, 114, and 116. As shown, in some embodiments, the network may also include any suitable type of central network controller device 100. The dashed lines may indicate two alternate routes between device 106 and device 114. One route, indicated by a short dashed line, passes through intermediate devices 102 and 116. Another route, indicated by a long dashed line, passes through intermediate devices 104 and 102. These two routes might, for example, represent the multiple routes providing a full range of policies from a source node (e.g., device 106) and a destination node (e.g., device 114). Router devices 102-116 may be conventional routers with standard forwarding technologies integrated into these routers and their software, modified to implement one, some, or all of the techniques described herein. In some embodiments, the computing of the multiple paths, the selecting of a route, and/or the forwarding operations described herein may all performed by each of router devices 102-116. In these embodiments, central controller 100 may not be necessary and may be eliminated. In other embodiments, compatible with “Open Flow” approaches to routing, central controller 100 may compute the multiple routes. This precomputed routing information may then be transmitted to each router device. For example, controller 100 may compute the multiple routes from router 106 to router 114, then remotely update the forwarding states of routers as appropriate. Each router with a packet to forward may then independently select a route from the multiple routes and forward the packet over the selected route. This may be particularly useful in the case of a small or medium internet service provider (“ISP”), or organizations such as universities or larger corporations. In yet another embodiment, central controller 100 may not only compute the multiple routes, but may also select routes. For example, a router 106 may query central controller 100 as needed to determine a route to forward a packet over. Central controller 100 may select a route from the multiple routes and inform the router of the selection as a response to the query. In this embodiment, it may not be necessary for central network controller 100 to transmit computed multiple route forwarding information to the router devices. Allowing the central controller to select routes may allow more intelligent congestion control in the network, but may increase latency. As shown in FIG. 1, system 1 may also include one or more data devices, such as data device 118, which may be a source of any suitable data 99 that may be communicatively coupled to one, some, or each of devices 100-116 in any suitable manner for sharing any suitable data with the device(s) of the network for any suitable purpose.

As shown in FIG. 1A, a system device 120 (e.g., one, some, or each of devices 100-118 of system 1 of FIG. 1 or any other suitable subsystem or device that may be configured to work with and/or in system 1) may include a processor component 12, a memory component 13, a communications component 14, a sensor 15, an input/output (“I/O”) component 16, a power supply component 17, a housing 11, and/or a bus 18 that may provide one or more wired or wireless communication links or paths for transferring data and/or power to, from, or between various other components of device 120. In some embodiments, one or more components of device 120 may be combined or omitted. Moreover, device 120 may include other components not combined or included in FIG. 1A and/or several instances of the components shown in FIG. 1A. For the sake of simplicity, only one of each of the components of device 120 is shown in FIG. 1A. I/O component 16 may include at least one input component (e.g., button, mouse, keyboard, etc.) to receive information from a user and/or at least one output component (e.g., audio speaker, video display, haptic component, etc.) to provide information to a user, such as a touch screen that may receive input information through a user's touch of a display screen and that may also provide visual information to a user via that same display screen (e.g., for providing a suitable graphical user interface (“GUI”)). Memory 13 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing data (e.g., forwarding data, table(s), algorithms, etc. (e.g., data 19d))). Communications component 14 may be provided to allow device 120 to communicate with one or more other devices 120 (e.g., any device communication to/from/between device(s) 100-118 of system 1) using any suitable communications protocol. Communications component 14 can be operative to create or connect to a communications network or link of a network. Communications component 14 can provide wireless communications using any suitable short-range or long-range communications protocol, such as Wi-Fi (e.g., an 802.11 protocol), Bluetooth, radio frequency systems (e.g., 1200 MHz, 2.4 GHz, and 5.6 GHz communication systems), near field communication (“NFC”), infrared, protocols used by wireless and cellular telephones and personal e-mail devices, or any other protocol supporting wireless communications. Communications component 14 can also be operative to connect to a wired communications link or directly to another data source wirelessly or via one or more wired connections. Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, Transmission Control Protocol/Internet Protocol (“TCP/IP”), User Datagram Protocol (“UDP”), Asynchronous Transfer Mode (“ATM”), synchronous optical networks (“SONET”), any suitable wireless protocols, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access.

Sensor 15 may be any suitable sensor that may be configured to sense any suitable data for device 120 (e.g., location-based data via a GPS sensor system, motion data, environmental data, biometric data, etc.). Sensor 15 may be a sensor assembly that may include any suitable sensor or any suitable combination of sensors operative to detect movements of device 120 and/or of any user thereof and/or any other characteristics of device 120 and/or of its environment (e.g., physical activity or other characteristics of a user of device 120, light content of the device environment, gas pollution content of the device environment, noise pollution content of the device environment, altitude of the device, etc.). Sensor 15 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 15 may include any suitable sensor components or subassemblies for detecting any suitable movement of device 120 and/or of a user thereof. For example, sensor 15 may include one or more three-axis acceleration motion sensors (e.g., an accelerometer) that may be operative to detect linear acceleration in three directions (i.e., the x- or left/right direction, the y- or up/down direction, and the z- or forward/backward direction). As another example, sensor 15 may include one or more single-axis or two-axis acceleration motion sensors that may be operative to detect linear acceleration only along each of the x- or left/right direction and the y- or up/down direction, or along any other pair of directions. In some embodiments, sensor 15 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 15 may be operative to detect rotation directly or indirectly, rotational movement, angular displacement, tilt, position, orientation, motion along a non-linear (e.g., arcuate) path, or any other non-linear motions. Additionally or alternatively, sensor 15 may include one or more angular rate, inertial, and/or gyro-motion sensors or gyroscopes for detecting rotational movement. For example, sensor 15 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 15 for detecting motion on device 120, such as any suitable pressure sensors, altimeters, or the like. Using sensor 15, device 120 may be configured to determine a velocity, acceleration, orientation, and/or any other suitable motion attribute of device 120. One or more biometric sensors may be multi-modal biometric sensors and/or operative to detect long-lived biometrics, modem liveness (e.g., active, passive, etc.) biometric detection, and/or the like. Sensor 15 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature-processing application that may be accessible to device 120 for attempting to authenticate a user), line-in connector for data and/or power, and/or combinations thereof. In some examples, each sensor can be a separate device, while, in other examples, any combination of two or more of the sensors can be included within a single device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single device. Device 120 can further include a timer that can be used, for example, to add time dimensions to various attributes of any detected element(s). Sensor 15 may include any suitable sensor components or subassemblies for detecting any suitable characteristics of any suitable condition of the lighting of the environment of device 120. For example, sensor 15 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of device 120 (e.g., in lux or lumens per square meter, etc.) and/or for determining the ambient color or white point chromaticity of ambient light in the environment of device 120 (e.g., in hue and colorfulness or in x/y parameters with respect to an x-y chromaticity space, etc.) and/or for determining the UV index or UV radiation in the environment of device 120 (e.g., in UV index units, etc.). Sensor 15 may include any suitable sensor components or subassemblies for detecting any suitable characteristics of any suitable condition of the air quality of the environment of device 120. For example, sensor 15 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of device 120 (e.g., in O₂% per liter, etc.) and/or for determining the air velocity of the ambient air in the environment of device 120 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of device 120 (e.g., in HG % per liter, etc.) and/or for determining the humidity of the ambient air in the environment of device 100 (e.g., in grams of water per cubic meter, etc. (e.g., using a hygrometer)) and/or for determining the temperature of the ambient air in the environment of device 120 (e.g., in degrees Celsius, etc. (e.g., using a thermometer)). Sensor 15 may include any suitable sensor components or subassemblies for detecting any suitable characteristics of any suitable condition of the sound quality of the environment of device 120. For example, sensor 15 may include any suitable sound quality sensor that may include, but is not limited to, one or more microphones or the like that may determine the level of sound pollution or noise in the environment of device 120 (e.g., in decibels, etc.). Sensor 15 may also include any other suitable sensor for determining any other suitable characteristics about a user of device 120 and/or the environment of device 120 and/or any situation within which device 120 may exist. For example, any suitable clock and/or position sensor(s) may be provided to determine the current time and/or time zone within which device 120 may be located. Sensor 15 may be embedded in a body (e.g., housing 11) of device 120, such as along a bottom surface that may be operative to contact a user, or can be positioned at any other desirable location. In some examples, different sensors can be placed in different locations inside or on the surfaces of device 120 (e.g., some located inside housing 11 and some attached to an attachment mechanism (e.g., a wrist band coupled to a housing of a wearable device), or the like). In other examples, one or more sensors can be worn by a user separately as different parts of a single device 120 or as different devices. In such cases, the sensors can be configured to communicate with device 120 using a wired and/or wireless technology (e.g., via communications component 14). In some examples, sensors can be configured to communicate with each other and/or share data collected from one or more sensors.

Power supply 17 can include any suitable circuitry for receiving and/or generating power, and for providing such power to one or more of the other components of device 120. For example, power supply assembly 17 can be coupled to a power grid (e.g., when device 120 is not acting as a portable device or when a battery of the device is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when device 120 is acting as a portable device). Device 120 may also be provided with a housing 11 that may at least partially enclose one or more of the components of device 120 for protection from debris and other degrading forces external to device 120. Each component of device 120 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, device 120 may include other components not combined or included in those shown or several instances of the components shown.

Processor 12 may be used to run one or more applications, such as an application 19 that may be accessible from memory 13 (e.g., as a portion of data 19d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem or otherwise (e.g., a device 118 with a network device 100-116)), application programming interfaces (“APIs”), software development kits (“SDKs”), CURATED applications (e.g., a web application or a native application for enabling device 120 to interact with an online service and/or one or more data devices 118 and/or the like, which may include applications for routing protocols, software-defined networking (“SDN”) modules based on OpenFlow, P4, or other network data plane programming standards, machine learning algorithms, network management functions, etc.), any other suitable applications, and/or the like. For example, processor 12 may load an application 19 as an interface program to determine how instructions or data received via an input component of I/O component 16 or other component of device 120 (e.g., sensor 15 and/or communications component 14) may manipulate the way in which information may be stored (e.g., in memory 13) and/or provided to via an output component of I/O component 16 and/or to another system device via communications component 14. As one example, application 19 may be a third party application that may be running on device 120 (e.g., an application associated with the network of system 1 and/or data device 118) that may be loaded on device 120 (e.g., using communications component 14) via an application market, such as the Apple App Store or Google Play, or that may be accessed via an internet application or web browser (e.g., by Apple Safari or Google Chrome) that may be running on device 120 and that may be pointed to a uniform resource locator (“URL”) whose target or web resource may be managed by or otherwise affiliated with any suitable entity. Any device (e.g., any router device or controller device of a network) may include any suitable special purpose hardware (e.g., hardware support of high-speed packet processing, hardware support of machine learning algorithms, hardware support of Boolean Satisfiability computation, etc.).

Device 120 may be any portable, mobile, wearable, implantable, or hand-held electronic device configured to operate with system 1. Alternatively, device 120 may not be portable during use, but may instead be generally stationary. Device 120 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device (e.g., an Apple Watch™ by Apple Inc.), boom box, modem, router, printer, kiosk, beacon, server, and any combinations thereof that may be useful as a node of a network (e.g., devices 100-116) and/or as a data device (e.g., device 118).

One or more routing algorithms or processes may be provided for computing a set of routes in a network that provide a full range of performance from a source node to a destination node. Certain routing algorithms may be precomputed (e.g., in advance of any particular packet or flow being transmitted onto the network rather than computed on-demand with each new packet or flow).

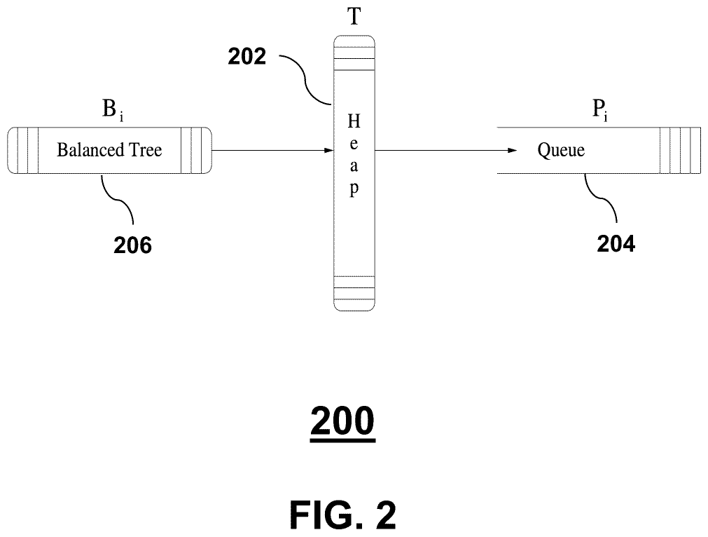

One or more routing algorithms may be based on a data structure model, such as data structure model 200 of FIG. 2. As shown, structure 200 may include a balanced tree 206 (Bᵢ) that may be maintained for each node in a graph to hold newly discovered, temporary labeled routes for that node. A heap 202 (T) may contain a lightest weight entry from each non-empty Bᵢ (e.g., for a maximum of n entries). A queue 204 (Pᵢ) may be maintained for each node that contains a set of permanently labeled routes (e.g., as discovered by the algorithm), for example, in the order in which they are discovered (e.g., which may be in increasing weight).

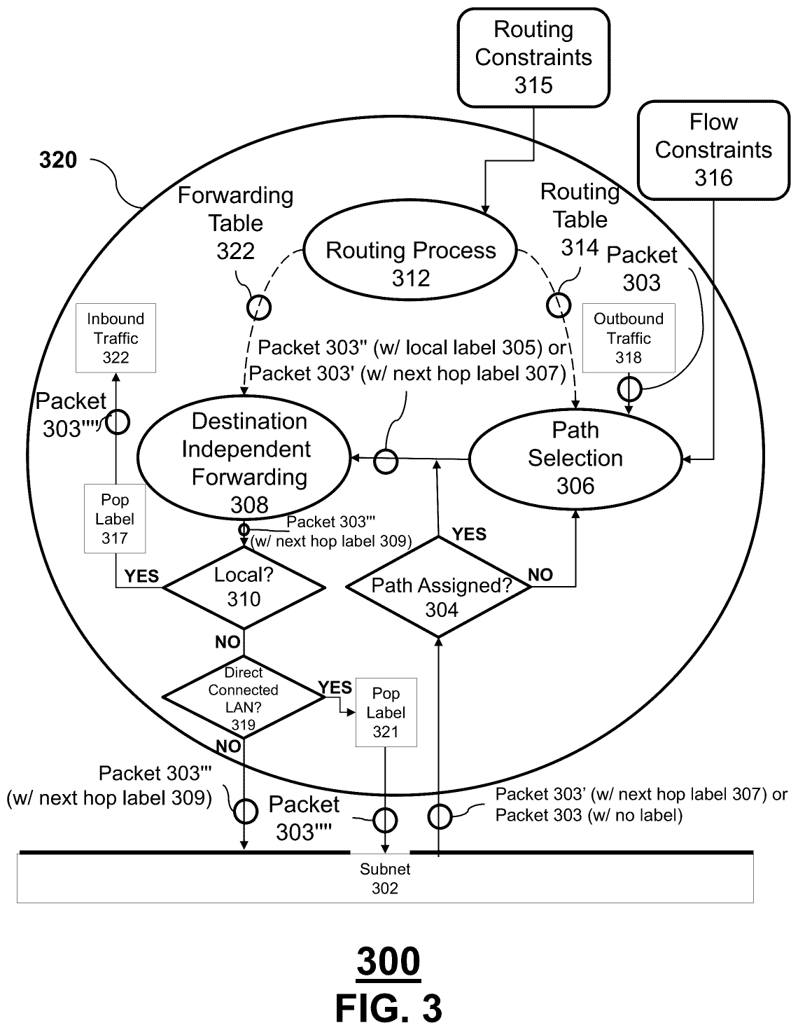

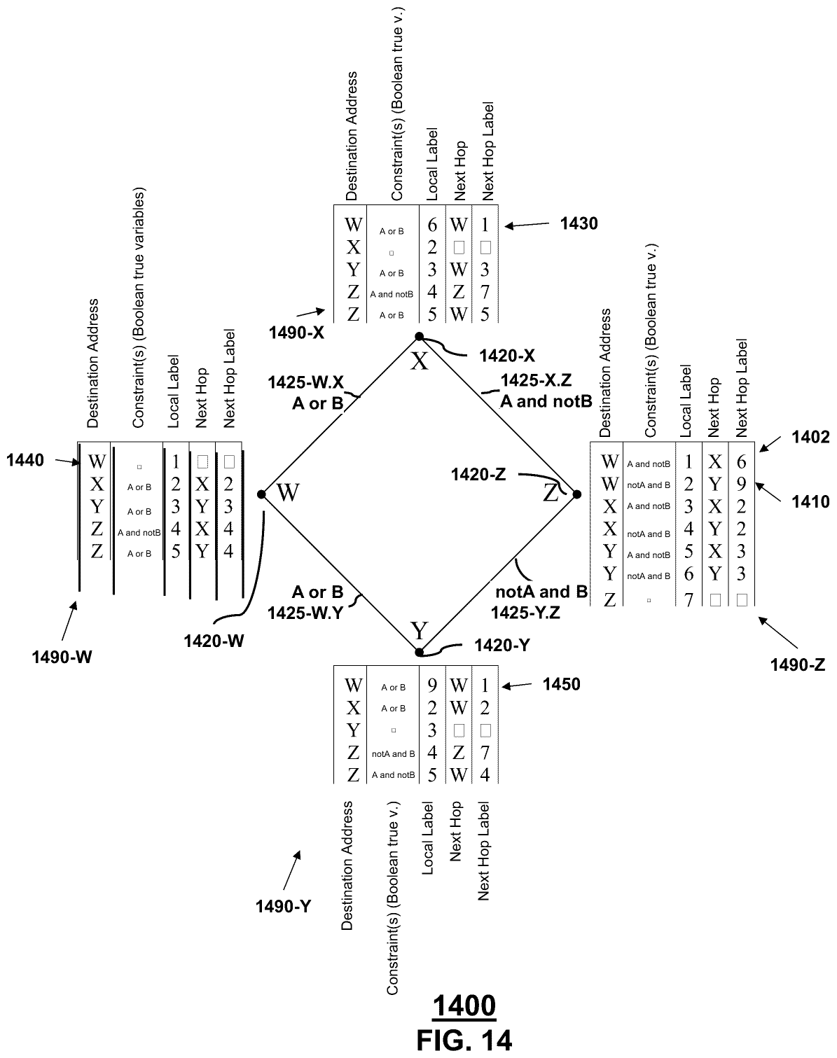

After multiple routes may be computed, the computed routes may be used for routing flows. For a given flow associated with at least one policy constraint that may be specified by a Boolean expression, a route may be selected from the set of multiple computed routes such that the selected route may satisfy the policy constraint(s) for the flow. The packets of the flow may be forwarded in accordance with the selected route. Performing traffic classification at each hop in the network may be prohibitively expensive. To avoid this, certain routing algorithms may use label-swap forwarding so that only a first router that handles a packet may need to perform a traffic classification before forwarding it. Accordingly, the forwarding state of a router may be enhanced to include local and next hop forwarding label information, in addition to the destination and next hop information that may exist in traditional forwarding tables, as may be shown in the tables of FIGS. 11 and 14. Traffic classifiers may be placed at the edge of an internet, where “edge” may be defined to be any point from which traffic can be injected into the internet. FIG. 3 illustrates schematically aspects of an illustrative packet processing process 300 (e.g., a process of routing and classification of traffic flows) by a router device 320 that may be coupled to any suitable internet subnet 302 (e.g., as a communication from another node or host or the like). Packet processing process 300 may include router device 320 checking at operation 304 if a packet 303 communicated from subnet 302 has an assigned path. If it is determined at operation 304 that packet 303 does not have an assigned path, then router device 320 may select a path at any suitable path selection operation(s) 306 (e.g., by applying a traffic classifier) or router device 320 may select a path at any suitable path selection operation(s) 306 for any suitable outbound traffic 318 (e.g., if the packet to be processed is sourced at router device 320 (e.g., when router device 320 may be the source node)). As shown, operation(s) 306 may be configured to receive and/or access and/or be informed by and/or otherwise utilize any suitable data for selecting a path, including, but not limited to, one or more routing tables 314 from any suitable routing process operation(s) 312, any suitable flow constraint(s) 316 that may be identified for the packet's flow, and/or the like. Path selection operation(s) 306 may be operative to identify a local label 305 for packet 303 associated with the selected path. Then, after any suitable path selection at operation(s) 306 or if it is determined at operation 304 that the packet does have an assigned path (e.g., when router device 320 may be an intermediate node between a source node and a destination node where device 320 may receive packet 303′ with a next hop label 307), any suitable destination independent forwarding operation(s) 308 may be applied to the packet (e.g., to a packet 303″ (e.g., packet 303 with local label 305) as may be provided by operation 306 or to a received packet 303′ with label 307). As shown, operation(s) 308 may be configured to receive and/or access and/or be informed by and/or otherwise utilize any suitable data for destination independent forwarding, including, but not limited to, one or more forwarding tables 322 from any suitable routing process operation(s) 312, and/or the like, for potentially swapping the label of the packet with an appropriately identified next hop label, such as for providing a packet 303′″ (e.g., packet 300 with identified next hop label 309 rather than local label 305 or packet 300′ with identified next hop label 309 rather than received next hop label 307). Packet processing process 300 may then include router device 320 checking at operation 310 if the packet with next hop label is local (e.g., if new label 309 does not exist or if next hop label 307 may identify the current router as the destination). If it is determined at operation 310 that the packet is not local, router device 320 may determine if the packet is to be sent to a direct connected LAN, and, if not, the packet may be forwarded as packet 303′″ (a packet with next hop label 309) back onto subnet 302 (e.g., for communication to a next node), and, if so, new label 309 may be popped off the packet at operation 321 and the packet may be forwarded (e.g., as processed packet 303″″ (e.g., a packet without a next hop label)) back onto subnet 302. However, if it is determined at operation 310 that the packet is local, new label 309 (if any) or old label 307 (if still intact) may be popped off the packet at operation 317 and router device 320 may provide the packet (e.g., as processed packet 303″″ (e.g., a packet without a next hop label)) for inbound traffic 322 (e.g., for further processing at router device 320 (e.g., when router device 320 may be the destination node)).

The operations shown in process 300 of FIG. 3 are only illustrative and that existing operations may be modified or omitted, additional operations may be added, and the order of certain operations may be altered.

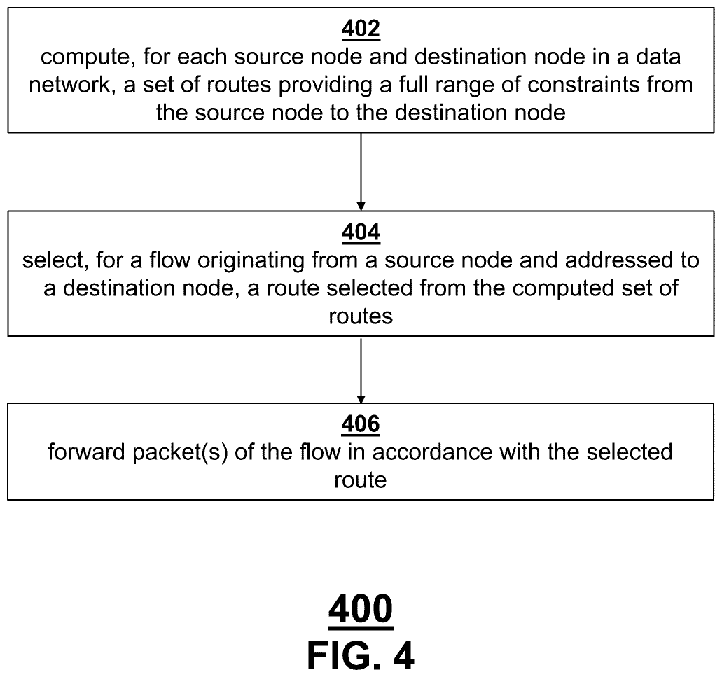

FIG. 4 is a flowchart of an illustrative process 400 for packet routing. At operation 402, any suitable component(s) or equipment of or associated with a data network may compute, for each source node in the data network and for each destination node in the data network, a set of routes or paths that may provide a full and/or desired range of constraints (e.g., performance constraints and/or policy constraints and/or service chaining constraints, etc.) that may be available in the network from the source node to the destination node (e.g., operation 312 of process 300 based on any suitable routing constraints 315). At operation 404, any suitable component(s) or equipment of or associated with the data network may select, for a flow (e.g., a sequence or set or stream of packets that may satisfy or be subject to the same set of constraints) that may be originating from a source node and that may be addressed to a destination node, a route selected from the computed set of routes (e.g., the set of routes computed at operation 402 for the source node and the destination node of the flow) (e.g., selection operation(s) 306 of process 300). The selected path may be used for forwarding all packets of the flow according to the configured flow constraints of the flow. This path selection may be implemented, for example, using an oracle that may always assign a flow to a path that both satisfies the flow's QoS requirements and has adequate available bandwidth for the flow. For example, this path selection may be carried out at the source node of the flow using any suitable information available to that source node (e.g., one or more routing tables 314 from any suitable routing process operation(s) 312, any suitable flow constraint(s) 316, and/or the like). At operation 406, any suitable component(s) or equipment of or associated with a data network may forward the flow (e.g., one, some, or each packet of the flow) in accordance with the route selected at operation 404 (e.g., forwarding operation(s) 308 of process 300).

The operations shown in process 400 of FIG. 4 are only illustrative and that existing operations may be modified or omitted, additional operations may be added, and the order of certain operations may be altered.

Label-swapping may be used in the context of connection-oriented (e.g., virtual circuit) packet forwarding architectures. In such applications, a connection setup phase may establish the labels that routers should use to forward packets carrying such labels, where a label may refer to an active source-destination connection. Another technique that may be used is the technique of threaded indices, in which neighboring routers may share labels corresponding to indexes into their routing tables for routing-table entries for destinations, and such labels may be included in packet headers to allow rapid forwarding-table lookups. Certain forwarding labels that may be used according to one or more processes of this disclosure may be similar in some aspects to threaded indices. For example, a label may be assigned to each routing-table entry, and each routing-table entry may correspond to a policy-based route that may be maintained for a given destination. Consequently, for each destination, a router may exchange one or multiple labels with its neighbors. Each label may be assigned to a destination that may correspond to a set of service classes that may be satisfied by the route identified by the label.

A forwarding architecture that may be used according to one or more processes of this disclosure may be implemented, for example, using a downstream tag allocation method, which may be described in Cisco's Tag Switching Architecture. In downstream tag allocation, routers may allocate tags as a part of a routing computation, where a tag may be assigned to each forwarding table entry. The binding of these tags with routes may then be advertised to adjacent routers that support tag switching. Routers can use the tag information to construct their own Tag Information Base, which may be used for label-swap forwarding.

In addition to or as an alternative to BCMR being implemented with labels, it may be implemented with source routing in general, and segment routing in particular. In some embodiments, selecting the route may include, if a source route is not present in a packet, computing the source route from traffic classification rules that may be specified in terms of contents of the packet, in terms of a user associated with the packet, in terms of a port the packet arrives on, and/or in terms of one or more other environmental factors. If a source route is already present in a packet, the forwarding may include forwarding the packet based on the source route in the packet.

In some embodiments, selecting the route may include, if a segment list is not present in the packet, computing the segment list from traffic classification rules specified in terms of contents of the packet, in terms of a user associated with the packet, in terms of a port the packet arrives on, and/or in terms of one or more other environmental factors. If a segment list is already present in the packet, the forwarding may include forwarding the packet based on the segment list in the packet.

Various Boolean Constrained Multipath Routing (BCMR) algorithms may be provided. Table 1 may define a notation that may be used in one or more of the algorithms, and Table 2 may define the primitive operations for queues, heaps, and balanced trees that may be used in one or more of the algorithms, and may give their time complexity used in their complexity analysis. Algorithm 1 may be a listing of a modified Dijkstra algorithm that may compute a set of shortest routes to each destination that may satisfy all truth assignments for the Boolean algebra available from a path in the network. Algorithm 2 may extend such an algorithm to compute a maximal set of routes for each satisfiable truth assignment in the network.

The SAT(φ) primitive of the traffic algebra may be the satisfiability problem of traditional Boolean algebra. SAT may answer the question “is there an assignment of truth values to the propositional variables in p such that p evaluates to true?”. The SAT(φ) primitive may evaluate to 1 (true) if such a truth assignment exists, and 0 (false) otherwise. Satisfiability may be tested in two situations by one or more of the algorithms described herein. First, when a new route to a destination may be considered for comparison to an existing route for the same destination, they may be only compared if classes of traffic exist that can use either route. Therefore, new routes may be only compared with existing routes when the conjunction of their path predicates is satisfiable. Second, given that classes of traffic exist that can use either path, the algorithm(s) may determine whether all traffic supported by one path could use the other. This may be the case if the path predicate for one path implies (“→”) the other or, more precisely, if the expression (εₓ→ε_{y}) is always true (i.e., is valid). Determining if an expression is valid may be equivalent to determining if the negation of the expression is unsatisfiable. Therefore, the expressions of the form ε₁→ε₂ may be equivalent to ¬SAT(¬(ε₁→ε₂)) (or ¬SAT(ε₁∧¬ε₂)). The satisfiability decision performed by SAT(ε) may be a prototypical NP-complete problem. As may be typical with NP-complete problems, it may have many restricted versions that may be computable in polynomial time.

In the DSMR elements of Algorithm 2, path weights may be composed of multi-component metrics that may capture one, some, or all important performance measures of a link, such as delay, delay variance (“jitter”), available bandwidth, and/or the like. A best set of paths to a destination may be defined using an enhanced version of the path algebra defined by Sobrinho (“IEEE/ACM Transactions on Networking,” 10(4):541-550, August 2002).

Formally, path algebra P=<W, ⊕, ≤, ⊏, 0, ∞> may be defined as a set of weights W, with a binary operator ⊕, and two order relations, ≤ and ⊏, defined on W. There may be two distinguished weights in W, 0 and ∞, that may represent the least and absorptive elements of W, respectively. Operator ⊕ may be the original path composition operator, and relation ≤ may be the original total ordering of Sobrinho, which may be used to order the paths for traversal by a path selection algorithm. Operator ⊕ may be used to compute path weights from link weights. A routing algorithm may use relation ≤ to build a forwarding set, starting with a minimal element, and by a forwarding process to select a minimal element of the forwarding set whose parameters may satisfy a given QoS request. A new relation on routes, ⊏, may be added to the algebra and may be used to define classes of comparable routes and/or select maximal elements of these classes for inclusion in the set of forwarding entries for a given destination. Relation ⊏ may be a partial ordering (e.g., reflexive, anti-symmetric, and transitive) with the following, additional property (Property 1):
Property 1 (ωₓ⊏ω_{y})⇒(ωₓ≥ω_{y}).
An example path algebra based on weights composed of delay and bottleneck bandwidth may be as follows:

$${ω}_{i} ≡ ( {d}_{i} , {b}_{i} ) \\ 0 ≡ ( 0 , ∞ ) \\ ∞ ≡ ( ∞ , 0 ) \\ {ω}_{i} ⊕ {ω}_{j} ≡ ( {d}_{i} + {d}_{j} , Min ( {b}_{i} , {b}_{j} ) ) \\ {ω}_{i} ≼ {ω}_{j} ≡ ( {d}_{i} < {d}_{j} ) ∨ ( ( {d}_{i} = {d}_{j} ) ∧ ( {b}_{i} \geq {b}_{j} ) ) \\ {ω}_{i} ⊑ {ω}_{j} ≡ ( {d}_{j} \leq {d}_{i} ) ∧ ( {b}_{j} \geq {b}_{i} )$$

TABLE 1
Notation.

A(i) ≡ Set of edges adjacent to i in the graph.
ωᵢⱼ ≡ Weight of edge (i, j).
εᵢⱼ ≡ Link predicate of edge (i, j).
P ≡ Queue of permanent routes to all nodes.
Pₙ ≡ Queue of permanent routes to node n.
T ≡ Heap of temporary routes.
Tₙ ≡ Entry in T for node n.
Bₙ ≡ Balanced tree of routes for node n.
Eₙ ≡ Summary of traffic expression for all routes in Pₙ.

TABLE 2
Operations on Data Structures.

| | |
|---|---|
| Queue | |
| Push(r, Q) | Insert record r at tail of queue Q |
| Head(Q) | Return record at head of queue Q |
| Pop(Q) | Delete record at head of queue Q |
| PopTail(Q) | Delete record at tail of queue Q |
| d-Heap | |
| Insert(r, H) | Insert record r in heap H |
| IncreaseKey(r, rₕ) | Replace record rₕ in heap with record r having greater key value |
| DecreaseKey(r, rₕ) | Replace record rₕ in heap with record r having lesser key value |
| Min(H) | Return record in heap H with smallest key value |
| DeleteMin(H) | Delete record in heap H with smallest key value |
| Delete(rₕ) | Delete record rₕ from heap |
| Balanced Tree | |
| Insert(r, B) | Insert record r in tree B |
| Min(B) | Return record in tree B with smallest key value |
| DeleteMin(B) | Delete record in tree B with smallest key value |

Algorithm 1: Modified Dijkstra SPF algorithm for BCMR.
algorithm BCMR

```
begin
Push(<s,s,0,1>, Ps);
for each {(s, j) ∈ A(s)}
  Insert(<j,s,ωₛⱼ,εₛⱼ>, T);
while(|T|>0)
  begin
  <i,pᵢ,ωᵢ,εᵢ> ← Min(T);
  DeleteMin(Bᵢ);
  if(|Bᵢ| = 0)
    then DeleteMin(T)
    else IncreaseKey(Min(Bᵢ), Tᵢ);
  if (¬(εᵢ → Eᵢ))
    then begin
      Push(<i,pᵢ,ωᵢ,εᵢ>, Pᵢ);
      Eᵢ ← Ei∨εi;
      for each {(i,j) ∈ A(i) | SAT(εᵢ ∧εᵢⱼ) ∧ ¬((εᵢ ∧εᵢⱼ) → Eⱼ)}
        begin
        ωⱼ ← ωᵢ + ωᵢⱼ;εⱼ ← εᵢ ∧εᵢⱼ;
        if (Tⱼ = Ø)
          then Insert(<j,i,ωⱼ,εⱼ>, T)
        else if (ωⱼ < Tⱼ.ω)
          then DecreaseKey(<j,i,ωⱼ,εⱼ>, T);
        Insert(<j,i,ωⱼ,εⱼ>, Bⱼ);
        end
      end
  end
end
```

Algorithm 2: Modified Dijkstra SPF
algorithm for combined DSMR & BCMR.
algorithm Combined DSMR & BCMR

```
begin
Push(<s,s,0,1>, Pₛ);
for each {(s, j) ∈ A(s)}
  Insert(<j,s,ωₛⱼ,εₛⱼ>, T);
while(|T|>0)
  begin
  <i,pᵢ,ωᵢ,εᵢ > ← Min(T);
  DeleteMin(Bᵢ);
  if(|Bᵢ| = 0)
    then DeleteMin(T)
    else IncreaseKey(Min(Bᵢ), Tᵢ);
  εₜₘₚ ← εᵢ; ptr ← Tail(Pᵢ);
  while ((εₜₘₚ /= 0) ∧ (ptr /= Ø))
    if (ωi ⊆ ptr.ω)
      εₜₘₚ ← εₜₘₚ ∧ ¬ptr.ε; ptr ← ptr.next;
  if(εₜₘₚ ≠ 0)
    then begin
      Push(<i,pᵢ,ωᵢ,εᵢ>, Pᵢ);
      for each{(i,j) ∈ A(i) | SAT(εₜₘₚ ∧εᵢⱼ)}
        begin
        ωⱼ ← ωᵢ ⊕ ωᵢⱼ;εⱼ ← εₜₘₚ∧εᵢⱼ;
        if (Tⱼ = Ø)
          then Insert(<j,i,ωⱼ,εⱼ>, T)
        else if (ωⱼ < Tⱼ.ω)
          then DecreaseKey(<j,i,ωⱼ,εⱼ>, T);
        Insert(<j,i,ωⱼ,εⱼ>, Bⱼ);
        end
      end
  end
end
```

Dijkstra may not be needed but is just an example of a method that could be used to reach all nodes, where other examples may include, but are not limited to, Bellman Ford and any other shortest path routing algorithms, where, although need not be limited to shortest path first specifically, but those may work.

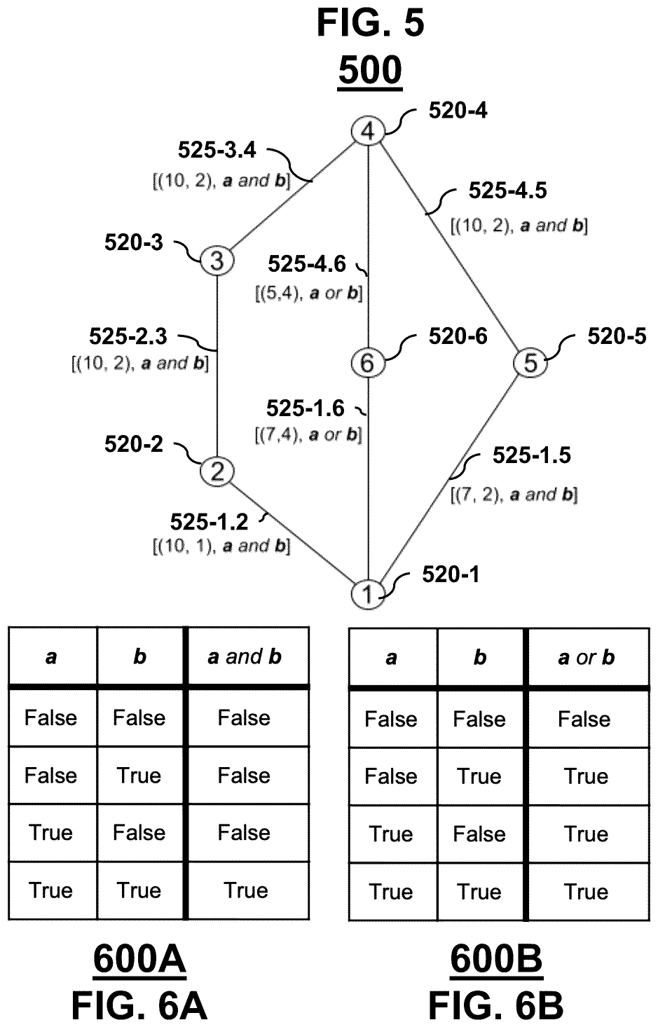

FIG. 5 shows at least a portion of a network 500 that may include any suitable number of nodes or router devices 520 (e.g., node 520-1, node 520-2, node 520-3, node 520-4, node 520-5, and node 520-6), where different nodes may be communicatively coupled to one another (e.g., using communication components of the nodes) over different communication links 525 (e.g., link 525-1.2 between nodes 520-1 and 520-2, link 525-1.5 between nodes 520-1 and 520-5, link 525-1.6 between nodes 520-1 and 520-6, link 525-2.3 between nodes 520-2 and 520-3, link 525-3.4 between nodes 520-3 and 520-4, link 525-4.5 between nodes 520-4 and 520-5, and link 525-4.6 between nodes 520-4 and 520-6), and where each link may be associated with specific example constraints (e.g., performance constraints and/or policy constraints and/or service chaining constraints, etc.). For example, as shown, certain (e.g., two) constraints or measures (e.g., performance constraints or performance measures, etc.) of a link may be provided as a link weight (e.g., as “bandwidth, delay” link weight(s)), and each link may be provided with at least one Boolean constraint (e.g., as a policy constraint, etc.) that may be defined by any suitable Boolean expression that may be composed of any suitable Boolean variable(s) (e.g., Boolean variable “a” and Boolean variable “b”, although any additional or alternative Boolean variable(s) and/or Boolean constraints may be associated with one, some, or each link), which may be used to express a constraint of flows using the network. As just some specific examples of constraints with a “bandwidth, delay” link weight constraint and a “Boolean expression (a, b)” Boolean constraint, link 525-1.2 may include constraints [(10, 1), a and b], link 525-1.5 may include constraints [(7, 2), a and b], link 525-1.6 may include constraints [(7, 4), a or b], link 525-2.3 may include constraints [(10, 2), a and b], link 525-3.4 may include constraints [(10, 2), a and b], link 525-4.5 may include constraints [(10, 2), a and b], and link 525-4.6 may include constraints [(5, 4), a or b]. In this portion of network 500, a number of hops between two particular nodes 520 may vary amongst different paths of one or more links 525, and each link may or may not satisfy a particular Boolean test. Routing based on just one Boolean test per device may not be suitable for all application types.

As shown in FIG. 5, various paths may exist between nodes 520-1 and 520-4, including a first path (1, 2, 3, 4) that may include links 525-1.2, 525-2.3, and 525-3.4, each of which may have a Boolean constraint defined by a Boolean expression “a and b”, a second path (1, 5, 4) that may include links 525-1.5 and 525-4.5, each of which may have a Boolean constraint defined by a Boolean expression “a and b”, and a third path (1, 6, 4) that may include links 525-1.6 and 525-4.6, each of which may have a Boolean constraint defined by a Boolean expression “a or b”. Although not shown, it is to be understood that another path may exist where different links of the path may have different Boolean constraints (e.g., a path (1, 6, 3, 4) where a link from node 520-6 to node 520-3 (not shown) may have a Boolean constraint defined by a Boolean expression “a and b”, and such a path may be computed for a routing table at node 520-1 if the path is computed to be a best set of paths for a particular non-dominated path). A truth table 600A of FIG. 6A identifies the possible combinations of Boolean variable values for the Boolean variables a and b and associated Boolean expression results (e.g., functional values) for the Boolean expression “a and b” (e.g., of the Boolean constraint of links 525-1.2, 525-2.3, 525-3.4, 525-1.5, and 525-4.5), while a truth table 600B of FIG. 6B identifies the possible combinations of Boolean variable values for the Boolean variables a and b and associated Boolean expression results (e.g., functional values) for the Boolean expression “a or b” (e.g., of the Boolean constraint of links 525-1.6 and 525-4.6).

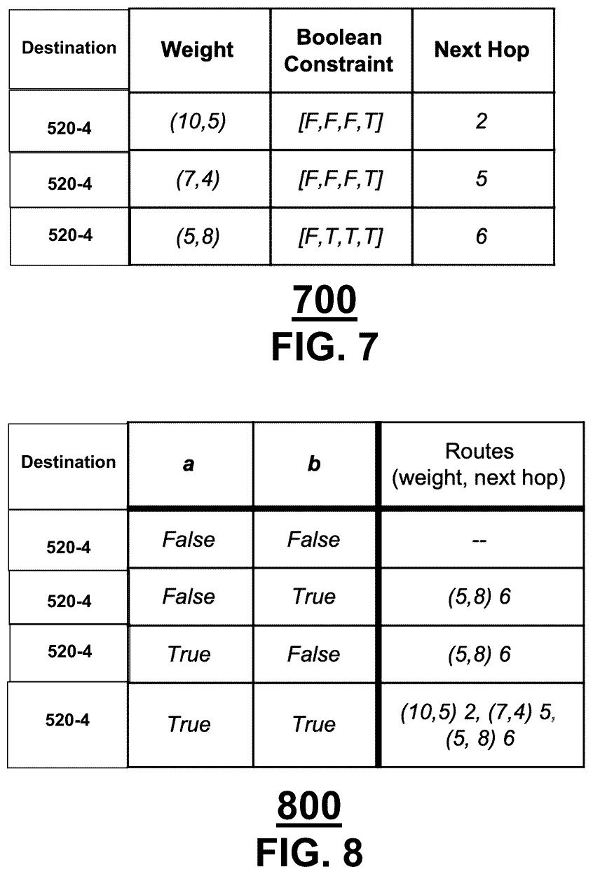

Given such first path (1, 2, 3, 4), second path (1, 5, 4), and third path (1, 6, 4), a combined DSMR and BCMR routing algorithm (e.g., Algorithm 2) may be configured to compute a data structure 700 of FIG. 7 that may be indicative of at least a portion of a routing table (e.g., routing table 314 of FIG. 3) for node 520-1, which may indicate a routing table entry row for each of the three paths from that node 520-1 to destination node 520-4 with weight constraint, Boolean constraint, and next hop for the applicable path (e.g., where the weights may be (bandwidth, delay) and the path algebra may be Shortest-Widest). A data structure 800 of FIG. 8 may be indicative of the truth assignments to Boolean variables in the Boolean constraints of the different paths (e.g., data structure 800 may show for each of the possible truth assignments of the Boolean variable values for the Boolean variables a and b, the different routes available between node 520-1 and node 520-4 (e.g., weights and next hop)). For example, in data structure 700, the list in the Boolean Constraint column may be a shorthand version of truth tables 600A and 600B. Specifically, “F” and “T” may respectively represent False and True, and each entry in the list may represent the corresponding entry in the associated truth table (e.g., the first entry in the list may be the Boolean variable value for a=False and b=False, the second entry is for a=False and b=True, etc.). These entries may be interpreted in terms of a (e.g., logically) distinct table for each truth assignment to the variables used in the constraints. This interpretation can be visualized by the table of data structure 800.

As an example, a flow with the constraint “a and b”, and thus the truth table result column [F, F, F, T], can use routes for any of the satisfying truth assignments of a and b. Entries in the Routes column may be in the format “(bandwidth, delay) next hop”. Translating this to usable routes, this flow can use any of the available paths. Concretely, the entry for [a=F, b=F] is empty (“--”), the entry for [a=F, b=T] is “(5,8) 6”, the entry for [a=T, b=F] is “(5,8) 6”, and the entry for [a=T, b=T] is “(10,5) 2, (7,4) 5, (5,8) 6” for the following list of usable routes: first path (1, 2, 3, 4)=(10,5) 2, second path (1, 5, 4)=(7,4) 5, and third path (1, 6, 4)=(5,8) 6.

However, given there are 2ⁿ rows in such a truth assignment table (e.g., 2 routing tables to search for a given flow constraint), where n is the number of constraint variables, this approach to forwarding table lookups may be prohibitively expensive. Therefore, an alternative solution is suggested by the observation that the set of usable routes for a given flow may be those where the performance constraint is satisfied, and both the routing table constraint and the flow constraint evaluate to True. This may be exactly the set of routing table entries where the performance constraint is satisfied (e.g., if RT_{pc} is the routing table performance constraint and F_{pc} is the flow performance constraint, the entries where “F_{pc}⊏RT_{pc}”), and the conjunction of the routing table constraint and the flow constraint is satisfiable, therefore, if RT_{bc} is the routing table constraint (e.g., “Boolean Constraint” in the routing table above) and F_{bc} is the flow performance constraint (e.g., the truth table [T, T, F, T] representing the constraint “not a and b” above), then the set of usable routes may be those where SAT(“RT_{bc} and F_{bc}”) is True (e.g., where SATO is the standard Boolean Satisfiability function).

This may be described in the following pseudo-code, where Rd may be the set of routes computed for destination d containing routes of the form <dest, next hop, forwarding information, performance constraint, Boolean constraint>, where forwarding information may be the information used to forward the traffic, such as label swap information:

algorithm ForwardingSet(R_{d}, F_{pc}, F_{bc})

```
begin
FS ← { }; // The computed forwarding set.
for each {<d, nh, fi, pc, bc> ∈ R_{d}}
  if (F_{pc} ⊆ RT_{pc} and SAT(RT_{bc} and F_{bc}))
    then Append (<d, nh, fi>, FS)
return (FS)
end
```

This algorithm may provide an efficient, single pass solution for identifying candidate paths for the flow. The returned set of routes may be those that satisfy the constraints, where one of these can be selected based on other criteria, such as minimal congestion, for use by the given flow.

A communication model of this disclosure may use the “best set of paths” to address performance and policy problems. The best set of paths may be computed from source to destination (e.g., for each router in a network (e.g., subject to partial ordering)). This set of paths may satisfy the full range of performance capabilities and policy constraints available in the network. Traffic then may be forwarded on the least congested path satisfying the performance and policy requirements that apply to the traffic. Simulations show that this communication model may increase network capacity 10-fold. Benefits of this architecture may include, but are not limited to, a default-closed network model and support for zero-trust networking, network segmentation, tiered service levels, and/or the like.

Such a communication model may work with existing Internet infrastructure and can be implemented at layer 2 (e.g., as a software-defined networking (“SDN”) module) or layer 3 (e.g., as enhancements to distributed routing protocols). Such a communication model may be packaged as an enhanced networking solution that may be targeted for different environments, such as organizational, ISP, high security (e.g., military) networks, and/or the like.

A 2004 paper titled “Efficient Policy-Based Routing Without Virtual Circuits” by Bradley R. Smith and J J Garcia-Luna-Aceves, which is hereby incorporated by reference herein in its entirety, provides an overview to core results from a 2003 dissertation titled “Efficient-Policy-Based Routing In The Internet” by Bradley R. Smith, which is also hereby incorporated by reference herein in its entirety. These references present general models of using a “best set” of paths and give algorithms for computing the set of paths that may satisfy both performance and policy constraints. Moreover, routing in the context of performance constraints may be combined with selecting the least congested path from a subset of the “best set” that satisfies the performance requirement of a given flow, for example, as may be described in U.S. Pat. No. 9,197,544 by Bradley R. Smith, which is also hereby incorporated by reference herein in its entirety.

Multiprotocol label swapping (“MPLS”) labels may be used for forwarding over multiple paths per destination in an efficient manner (e.g., for an implementation of this communication model (e.g., for a prototype implementation of these algorithms)).

An Internet routing model may be based on a single best path between source and destination. This model may be limited in its ability to support diverse performance and policy requirements. These limitations may be mitigated through the development of the MPLS technology. MPLS may enhance the Internet forwarding architecture by replacing the use of destination addresses for forwarding traffic, to the use of local (e.g., to the network device) labels. Among a number of benefits, this additional layer of abstraction may allow for efficient forwarding of traffic over multiple paths from source to destination.

To exploit the efficient capabilities of an MPLS data plane, a number of signaling protocols may distribute MPLS label information and/or compute multiple paths with the goals of, for example, improving network resource utilization and/or providing paths that may be a better match to a given network application's requirements, including the Label Distribution Protocol (“LDP”), the Resource Reservation Protocol (“RSVP”), and Segment Routing (“SR”). While these protocols may be an improvement over traditional single-path forwarding, they each may have some limitations.

An LDP operating model may be that of implementing label-swapped paths (“LSPs”) that may reflect those computing by the existing routing protocol. This may limit the multipath capabilities to multiple equal cost paths that may be already supported in existing routing protocols. This capability may be called equal cost multipath (“ECMP”). A benefit provided by LDP may be the aggregation of forwarding state into a smaller number of forwarding entries by the aggregation of large blocks of routes that may follow the same path using a single LSP.

In contrast, an RSVP operating model may be that of computing paths that may satisfy a given set of requirements. These requirements may be defined in terms of bandwidth, a single traffic-engineering metric, and an Administrative Group (or link color). RSVP may compute paths separately from the active routing protocol (e.g., Intermediate System to Intermediate System (“IS-IS”) or Open Shortest Path First (“OSPF”)), but may be based on the topology discovered by that protocol (e.g., augmented with the traffic engineering (“TE”) Metric (e.g., link metric for TE) and Administrative Group attributes). Given this enhanced topology, RSVP may run a separate Constrained Shortest Path First (“CSPF”) routing computation to find a path that may satisfy the additional constraints. It may then signal the network nodes along that path to install the MPLS state to implement the LSP, and then typically may monitor the underlying routing protocol (e.g., based on a configurable timer) to detect topology changes that may require updates to the LSP. RSVP may take advantage of the multipath capability of MPLS. However, due to delay and overhead for setting up and maintaining an RSVP-managed LSP, these paths may be typically setup on a semi-static basis for a small set of predictable network loads. RSVP may not be an efficient solution for ensuring all network flows use paths tailored to their needs.

Segment Routing has been developed (see, e.g., C. Filsfils, S. Previdi, L. Ginsberg, B. Decraene, S. Litkowski, R. Shakir, “Segment Routing Architecture,” RFC 8402, July 2018). In essence, SR may be a form of loose source routing where either an MPLS label stack or an SR Extension header, which may contain a list of IPv6 “segment” endpoints (e.g., similar to the IPv6 Routing Extension header), may be used to specify segments of a desired path. These paths may be computed using essentially the same CSPF routing algorithm that may be used in RSVP to find paths that meet traffic engineering constraints (see, e.g., Juniper Networks, “Enabling Distributed CSPF for Segment Routing LSPs”). Segment Routing may improve on LDP and RSVP in certain ways. Compared with LDP, SR may provide enhanced traffic engineering support and more general multipath routing. Compared with both LDP and RSVP, SR may be integrated with IS-IS and OSPF routing protocols (see, e.g., D. Singh, “Yet Another Blog About Segment Routing, Part 3: SR-TE”), and SR may not require extensive network state (e.g., the segment routes may be carried in the packets), though scalability of carrying routes in the packets may impose limits in how far SR paths can diverge from shortest paths computed in the network. Lastly, compared with RSVP, SR may inherit the limited expressiveness of CSPF described above.

In contrast to LDP, RSVP, and SR, a communication model of this disclosure may provide a new routing model that may be based on the best set of paths between source and destination. In this model, routes may be pre-computed (e.g., computed on a topology-driven basis) that may provide the full range of performance and/or may support the full range of policies available in a network. At the detection of a new flow in the network, a forwarding computation may be performed that may select the path of those already computed for the given destination that may best satisfy the requirements of the new flow. State may then be added to the ingress network node that may implement the forwarding decision, and subsequent traffic may then be forwarded using the MPLS mechanism(s). That state may be removed when the end of the flow is detected (e.g., either by lack of activity or by any suitable protocol-specific mechanism).

As detailed in the Tables 3 and 4 below, a new communication model of this disclosure may have a number of benefits over others.

TABLE 3

| | | | | Multipath |
|---|---|---|---|---|
| Technology | How built | How updated | TE support | support |
| LDP/MPLS | Topology-driven | Slaved to routing | None | ECMP |
| | | protocol | | |
| RSVP/MPLS | Manually | Timer-based | Traditional | ECMP |
| | | synchronization | (metric, | |
| | | with routing | Admin Group) | |
| | | protocol | | |
| Segment | Topology-driven | Integrated in | Enhanced | Satisfies |
| Routing | | routing protocol | (performance | “dominant set” |
| | | | & Boolean | of performance |
| | | | constraints) | and Boolean |
| | | | | constraints |
| New Model | Topology-driven | Integrated in | Enhanced | Satisfies |
| | | routing protocol | (performance | “dominant set” |
| | | | & Boolean | of performance |
| | | | constraints) | and Boolean |
| | | | | constraints |

TABLE 4

| Solution | Overhead | Routing Model | QoS | Admin. Policy |
|---|---|---|---|---|
| Overprovision | 2-3x needed | Best path | None | None |
| | capacity | | | |
| Diffserv | Overprovision, | Best path | Limited | None |
| | traffic | | support with | |
| | classification, | | PHBs | |
| | PHB in routers | | | |
| RSVP | Per-flow route | On-demand | CSPF | CSPF link |
| | computation and | | bandwidth, | color |
| | path signaling, | | hop count, TE | |
| | MPLS | | metric | |
| PBR/VRF | Per VRF routing | Multiple best | None | Packet header |
| | process and | path VRFs | | fields |
| | forwarding table, | | | (route_map) |
| | route_map | | | |
| | processing | | | |
| Segment | Per-flow route | On-demand | CSPF | CSPF link |
| Routing | computation. | | bandwidth, | color |
| | SR route packet | | hop count, TE | |
| | header space. | | metric | |
| New Model | Traffic | Best set of paths | Network | Any visible or |
| | classification, | | admin defined | otherwise |
| | routing | | performance | accessible |
| | complexity, per | | metrics (or | true/false state |
| | traffic class | | otherwise). | |
| | MPLS | | | |

In summary, this new communication routing model may provide various new features, including, but not limited to, a model that may combine benefits of LDP, RSVP, and SR (e.g., a model that may be topology-driven (e.g., like LDP, SR), a model that may support TE (e.g., like RSVP, SR), a model that may provide aggregation of forwarding state (e.g., like LDP, SR), a model that may have the ability to implement enhanced versions of ECMP (e.g., hop-by-hop may be done by LDP vs. only at ingress by RSVP, SR); a model that may be integrated with a routing mechanism, so lost coordination may not be possible (e.g., like SR), and/or the like), a model that may implement an enhanced version of TE based on finding the best set of paths given performance and Boolean constraints, and/or the like.

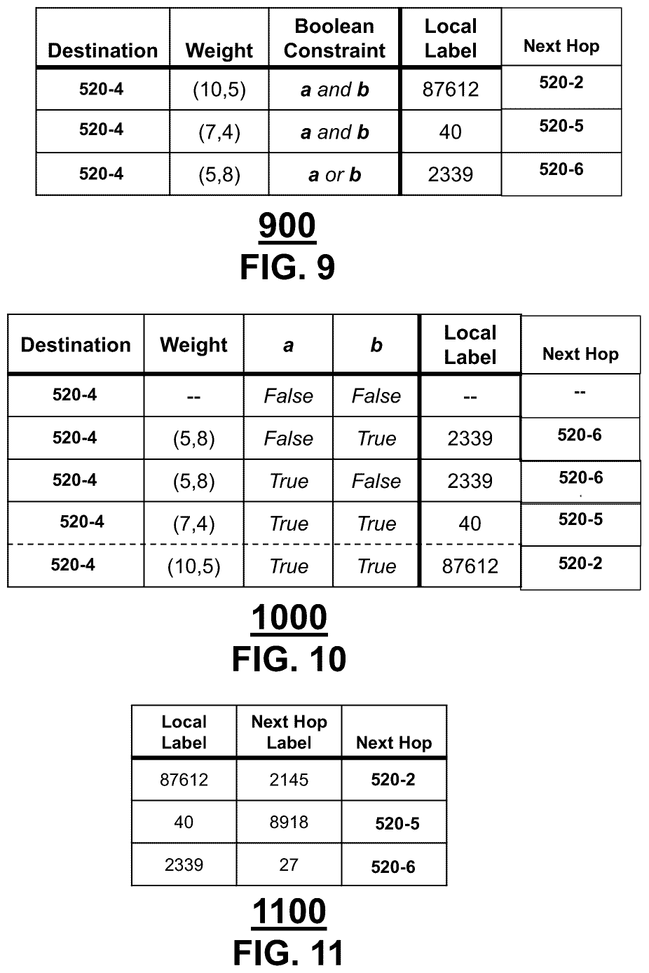

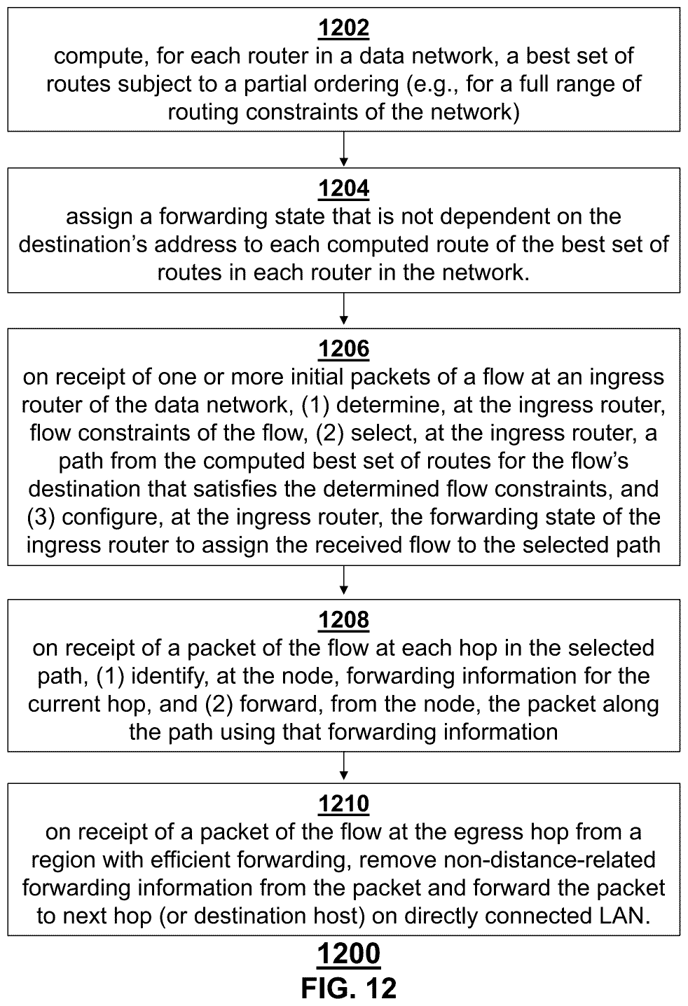

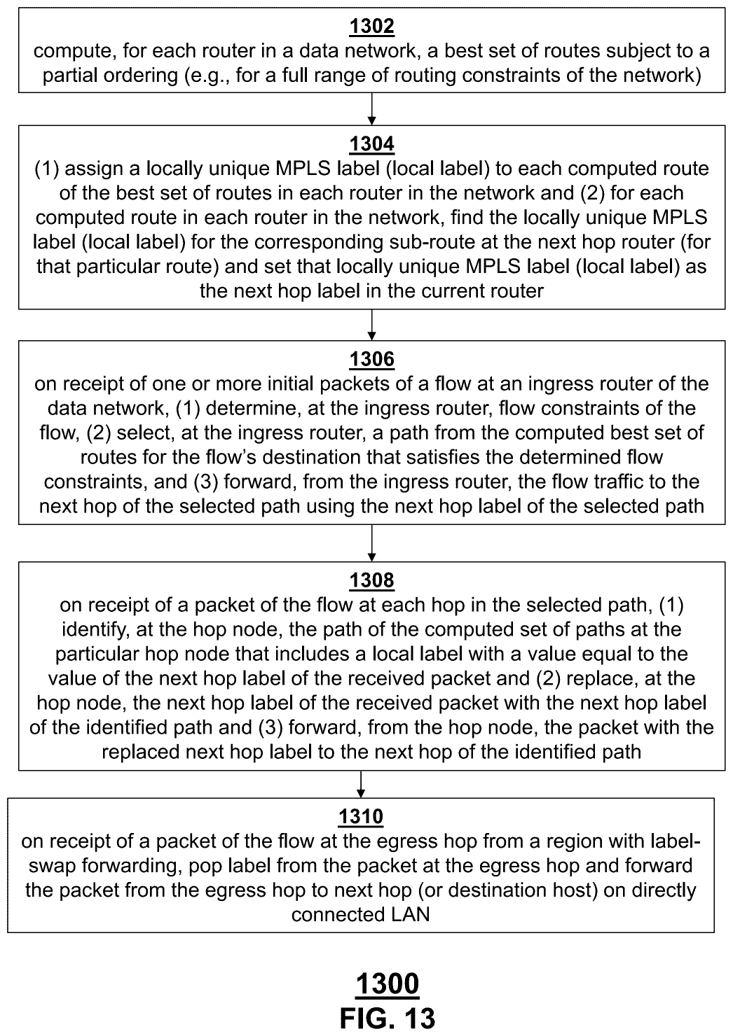

Referring back to network 500 of FIG. 5, given first path (1, 2, 3, 4), second path (1, 5, 4), and third path (1, 6, 4) availability between node 520-1 and node 520-4, a combined DSMR and BCMR routing algorithm (e.g., Algorithm 2) may be configured to compute an improved data structure 900 of FIG. 9 that may be indicative of at least a portion of an improved routing table (e.g., routing table 314 of FIG. 3) of this new communication routing model for node 520-1, which may indicate a routing table entry row for each of the three paths from that node 520-1 to destination node 520-4 with weight constraint(s), Boolean constraint(s), a next hop, and a local label (e.g., a next hop may be determined in any suitable manner (e.g., as described with respect to operation 1202 of FIG. 12 and/or operation 1302 of FIG. 13) and a local label may be determined in any suitable manner (e.g., as described with respect to operation 1204 of FIG. 12 and/or operation 1304 of FIG. 13)). A data structure 1000 of FIG. 10 may be indicative of at least a portion of an improved conceptual routing table of this new communication routing model, where the truth assignments to Boolean variables in the Boolean constraints of the different paths may be provided (e.g., data structure 1000 may show, for each of the possible truth assignments of the Boolean variable values for the Boolean variables a and b, the different route(s) that may be available between node 520-1 and node 520-4 (e.g., with weight constraint(s) and local label and next hop)). It should be noted that while there are rows in data structure 1000 for next hops 520-5 and 520-2 when the truth assignments are True, there is no row in data structure 1000 for next hop 520-6 when the truth assignments are True because the bandwidth/delay weight constraint (5,8) for next hop 520-6 is dominated by the bandwidth/delay weight constraint (7,4) for next hop 520-5 and the bandwidth/delay weight constraint (10,5) for next hop 520-2. A data structure 1100 of FIG. 11 may be indicative of at least a portion of an improved destination independent multipath forwarding table of this new communication routing model for node 520-1, which may indicate a forwarding table entry row for each unique local label in the routing table that row may include that associated local label (e.g., as provided by the routing table of FIG. 9 and/or of FIG. 10) along with an associated next hop label (e.g., a next hop label may be determined in any suitable manner (e.g., as described with respect to operation 1206 of FIG. 12 and/or operation 1306 of FIG. 13)) and data indicative of the next hop (e.g., node identifier). A forwarding table of a node may be a byproduct of a much larger routing table of the node (e.g., a routing table may have more fields than the forwarding table (e.g., constraints, destination, etc.), but both tables may have the same number of rows). For example, every row of a routing table may be associated with a unique local label, where a local label may be a unique path identifier for the node the routing table is local to, while every row of a forwarding table may be associated with such a respective unique local label, while a forwarding table may include two or more rows with the same next hop label. While a local label and a next hop for a particular remote node in such routing and forwarding tables at a current node may describe a path between those nodes, such that the number of rows in a routing table and in the forwarding table at a node may be the same, the number of fields in a forwarding table may be drastically reduced from the number of fields in a routing table at a particular node, as the forwarding table may only include local label and next hop label and next hop identifier fields, whereas the routing table may include more fields (e.g., constraint(s), destination, etc.). A forwarding table may be constructed for a router before a particular flow of packets is received at the router (e.g., up front forward table construction), or a forwarding table may be at least partially constructed in response to a particular flow of packets being received (e.g., on demand forward table construction).

FIG. 12 is a flowchart of an illustrative process 1200 for packet routing according to a new routing model, where packets may be forwarded over different paths of a best set of paths using forwarding state that may not be based on destination address information (e.g., efficient forwarding over best set of paths). At operation 1202, any suitable component(s) or equipment of or associated with a data network may compute, for each router in the data network, a best set of routes or paths (e.g., between each source/destination node pair) subject to a partial ordering, such as for a full range of routing constraints of the network (e.g., routing constraints 315 may be used to compute a routing table 314 (e.g., a routing table of FIG. 9) for each router device of the network). At operation 1204, any suitable component(s) or equipment of or associated with a data network may assign forwarding state that is not dependent on the destination's address to each computed route of the best set of routes in each router in the network (e.g., a forwarding table 322 (e.g., a destination independent forwarding table of FIG. 11) may be assigned or otherwise provided for each router device of the network). At operation 1206, any suitable component(s) or equipment of or associated with a particular router of the network, on receipt of one or more initial packets of a flow at the particular router as an ingress router of the network (e.g., packet(s) 303 at router 320), may (1) determine, at the ingress router, flow constraints of the flow (e.g., from configured information (e.g., flow constraints 316 (e.g., and current values thereof))), which may include collecting data from any suitable remote source(s) (e.g., any suitable data 99 from any suitable data device 118), (2) select, at the ingress router, a path from the computed best set of routes for the flow's destination that satisfies the determined flow constraints (e.g., path selection 306 using a routing table 314 of the router (e.g., a routing table computed at operation 1202) and any suitable flow constraints 316 (e.g., to identify a local label 305 for the flow at that router)), and (3) configure, at the ingress router, the forwarding state of the ingress router to assign the received flow to the selected path (e.g., to assign the identified local label 305 of the routing table to the flow at that router). At operation 1208, any suitable component(s) or equipment of or associated with a particular router of the network, on receipt of a packet of the flow at each hop node of the selected path (e.g., a packet with forwarding information or local label 305 (e.g., as may have been assigned at operation 1206/306 by the source node) as received at the source node of the selected path (e.g., at operation 308 after operation 306) or a packet with forwarding information or next hop label 307 as received at any intermediate hop node of the selected path (e.g., at operation 308 after operation 304 rather than after operation 306) may (1) identify, at the node, any suitable forwarding information (or forwarding identifier or next hop label) of the received packet (e.g., identify an associated next hop label 307 and next hop node using local label 305 with packet 303 at operation 308 for the current hop (e.g., in conjunction with a forwarding table for the node (e.g., a forwarding table (e.g., forwarding table 322) computed at operation 1204))), and (2) forward, from the node to the next hop node of the identified next hop node, the packet along the path using that forwarding information (e.g., destination independent forwarding 308 swapping in the identified next hop label 307 for the local label 305)). At operation 1210, any suitable component(s) or equipment of or associated with a particular router of the network, on receipt of a packet of the flow at the particular router as the egress hop router from a region with efficient forwarding, may remove non-distance-related forwarding information from the packet and forward it to the next hop (or destination host) on a directly connected LAN. As just one example, when a routing table of FIG. 9 and a forwarding table of FIG. 11 may be computed by process 1200 and a flow is received at source node 520-1 for routing to destination node 520-4, where flow constraints of the flow are indicative of Boolean values True, True for Boolean variables a,b such that the paths of the 4^{th} and 5^{th} rows of the table of FIG. 10 (e.g., the 2^{nd} and 1^{st} rows of the table of FIG. 9) may be identified as satisfying paths for the flow with respect to the Boolean constraints, the weight constraint (7,4) of the path of the 4^{th} row and the weight constraint (10,5) of the path of the 5^{th} row may be analyzed with any other suitable available data to select one of those two paths for use (e.g., at operation 1206). One of multiple allowable paths may be chosen based on a local load-balancing algorithm or the like. Therefore, “best set of paths” routing may be paired with non-destination based forwarding technologies (e.g., MPLS, Segment Routing, Source Routing, etc.). Therefore, labels may be determined by best set of paths (e.g., taking into account all constraints of the links). However, once one of those Boolean constraint satisfying paths may be selected for the flow, then the ingress router (e.g., node 520-1) may configure the forwarding state of the router for that flow to assign the flow to the selected path (e.g., use the next hop or local label of that selected path (e.g., of the routing table) to identify the associated next hop label (e.g., of the forwarding table) in order to communicate the packet with the identified next hop label from the ingress router to the next hop).

Therefore, a new routing model may be provided that may be based on a best set of routes between source and destination, where routes may be pre-computed (e.g., computed on a topology-driven basis (e.g., at operation 1202)) that may provide the full range of performance and/or may support the full range of policies available in a network, while a forwarding state that is not dependent on the destination may be assigned to each computed route (e.g., at operation 1204 (e.g., the forwarding table (e.g., as configured at the router per flow) need not identify a destination node of the entire path)). At the detection of a new flow in the network, a forwarding computation may be performed that may select the path of those already computed for the given destination that may best satisfy the requirements of the new flow and a new state may then be added to the ingress network node that may implement the forwarding decision (e.g., at operation 1206), and subsequent traffic for that flow may then be forwarded using that new state via any suitable mechanisms, such as MPLS mechanism(s), segment routing mechanism(s), source routing mechanism(s), and/or the like (e.g., at operation 1208). That state may be removed when the end of the flow is detected (e.g., either by lack of activity or by any suitable protocol-specific mechanism).

The operations shown in process 1200 of FIG. 12 are only illustrative and that existing operations may be modified or omitted, additional operations may be added, and the order of certain operations may be altered.

FIG. 13 is a flowchart of an illustrative process 1300 for packet routing according to a new routing model, where packets may be forwarded over different paths of a best set of paths (e.g., efficient forwarding traffic over different paths of a best set of paths using label-swap forwarding state (e.g., label switching (e.g., MPLS))). At operation 1302, any suitable component(s) or equipment of or associated with a data network may compute, for each router in the data network, a best set of routes or paths (e.g., between each source/destination node pair) subject to a partial ordering, such as for a full range of routing constraints of the network (e.g., routing constraints 315 may be used to compute a routing table 314 (e.g., a routing table of FIG. 9 or of FIG. 14) for each router device of the network). At operation 1304, any suitable component(s) or equipment of or associated with a data network may (1) assign a locally unique MPLS label (local label) to each computed route of the best set of routes in a routing table at each router in the network (e.g., a routing table 314 (e.g., a routing table of FIG. 9 or of FIG. 14) for each router device of the network)) and, (2) for each computed route in each router in the network, find the locally unique MPLS label (local label) for the corresponding sub-route at the next hop router (for that particular route) and set that locally unique MPLS label (local label) of the next hop router as the next hop label in the current router, such as in a forwarding table at each router in the network (e.g., a forwarding table 322 (e.g., a destination independent forwarding table of FIG. 11 or of FIG. 14)). At operation 1306, any suitable component(s) or equipment of or associated with a particular router of the network, on receipt of one or more initial packets of a flow at the particular router as an ingress router of the network (e.g., packet(s) 303 at router 320), may (1) determine, at the ingress router, flow constraints of the flow (e.g., from configured information (e.g., flow constraints 316 (e.g., and current values thereof))), which may include collecting data from any suitable remote source(s) (e.g., any suitable data 99 from any suitable data device 118), (2) select, at the ingress router, a path from the computed best set of routes for the flow's destination that satisfies the determined flow constraints (e.g., path selection 306 using a routing table 314 of the router (e.g., a routing table computed at operation 1202) and any suitable flow constraints 316 (e.g., to identify a local label 305 for the flow at that router)), and (3) forward, from the ingress router, the flow traffic to the next hop of the selected path using the next hop label of the selected path (e.g., the next hop label of the selected path's row of the forwarding table of the ingress router may be forwarded along with any packets of the flow to the next hop of the selected path's row of the forwarding table of the ingress router). At operation 1308, any suitable component(s) or equipment of or associated with a particular router of the network, on receipt of a packet of the flow at each hop node of the selected path (e.g., a packet with the next hop label of the forwarding table of the node that forwarded the packet to this particular hop node (e.g., the label assigned at the previous router prior to this hop router)), may (1) identify, at the hop node, the path of the computed set of paths at the particular hop node that includes a local label with a value equal to the value of the next hop label of the received packet and (2) replace, at the hop node, the next hop label of the received packet with the next hop label of the identified path and (3) forward, from the hop node, the packet with the replaced next hop label to the next hop of the identified path. At operation 1310, any suitable component(s) or equipment of or associated with a particular router of the network, on receipt of a packet of the flow at the particular router as the egress hop router from a region with label-swap forwarding, may pop (e.g., remove, strip, etc.) the next hop label from the packet at the egress hop and forward the packet from the egress hop to the next hop (or destination host) on a directly connected LAN.

Therefore, a new routing model may be provided that may be based on a best set of routes between source and destination, where routes may be pre-computed (e.g., computed on a topology-driven basis (e.g., at operation 1302)) that may provide the full range of performance and/or may support the full range of policies available in a network, while a forwarding state that is not dependent on the destination may be assigned to each computed route (e.g., at operation 1304 (e.g., the forwarding table (e.g., as configured at the router per flow) need not identify a destination node of the entire path)). At the detection of a new flow in the network, a forwarding computation may be performed that may select the path of those already computed for the given destination that may best satisfy the requirements of the new flow and state may then be added to the ingress network node that may implement the forwarding decision (e.g., at operation 1306), and subsequent traffic may then be forwarded using any suitable mechanisms, such as MPLS mechanism(s) (e.g., next hop labels), and/or the like (e.g., at operation 1308). That state may be removed when the end of the flow is detected (e.g., either by lack of activity or by any suitable protocol-specific mechanism).

The operations shown in process 1300 of FIG. 13 are only illustrative and that existing operations may be modified or omitted, additional operations may be added, and the order of certain operations may be altered.

FIG. 14 shows at least a portion of a network 1400 that may include any suitable number of nodes or router devices 1420 (e.g., node 1420-W, node 1420-X, node 1420-Y, and node 1420-Z), where different nodes may be communicatively coupled to one another (e.g., using communication components of the nodes) over different communication links 1425 (e.g., link 1425-X.Z between nodes 1420-X and 1420-Z, link 1425-W.X between nodes 1420-W and 1420-X, link 1425-W.Y between nodes 1420-W and 1420-Y, and link 1425-Y.Z between nodes 1420-Y and 1420-Z), and where each link may be associated with specific example constraints (e.g., performance constraints and/or policy constraints and/or service chaining constraints, etc.). For example, as shown, certain constraints of a link may be provided with at least one Boolean constraint (e.g., as a policy constraint, etc.) that may be defined by any suitable Boolean expression that may be composed of any suitable Boolean variable(s) (e.g., Boolean variable “A” and Boolean variable “B”, although any additional or alternative Boolean variable(s) and/or Boolean constraints may be associated with one, some, or each link), which may be used to express a constraint of flows using the network. As just some specific examples of constraints with a “Boolean expression (A, B)” Boolean constraint, link 1425-X.Z may include a Boolean constraint with a Boolean expression [A and notB], link 1425-W.X may include a Boolean constraint with a Boolean expression [A or B], link 1425-W.Y may include a Boolean constraint with a Boolean expression [A or B], and link 1425-Y.Z may include a Boolean constraint with a Boolean expression [notA and B]. In this portion of network 1400, hops between two particular nodes 1420 may vary amongst different paths of one or more links 1425, and each link may or may not satisfy a particular Boolean test. Routing based on just one Boolean test per device may not be suitable for all application types.

As shown in FIG. 14, various paths may exist between nodes 1420-Z and 1420-W, including a first path (Z, X, W) that may include links 1425-X.Z and 1425-W.X, and a second path (Z, Y, W) that may include links 1425-Y.Z and 1425-W.Y. Any suitable algorithm(s) may be configured to compute any suitable data structure(s) 1490 for one, some, or each router in the network in any suitable fashion(s) and/or in accordance with any suitable protocol(s) (e.g., centrally, distributed, locally, etc.). For example, as shown in FIG. 14, a data structure 1490-W may be computed for router 1420-W, a data structure 1490-X may be computed for router 1420-X, a data structure 1490-Y may be computed for router 1420-Y, and a data structure 1490-Z may be computed for router 1420-Z, where each one of such structures 1490 may be illustrated as a combination of a routing table and a forwarding state (e.g., local swap) table, which may be referred to herein as a merged communication table. As shown, the data structure of each particular node's merged communication table may include one or more rows of data, where the data of each row may be associated with a particular path between the particular node and a destination node. For example, the data of each row may be associated with a particular route of the best set of routes (e.g., as may be computed at operation 1202 and/or operation 1302), where the data of a first column (“Destination Address” column) of the merged communication table of each particular node may be indicative of a destination address or destination node for each computed path between the particular node and that destination node (e.g., for each merged table row) (e.g., as may be computed at operation 1202 and/or operation 1302), where the data of a fourth column (“Next Hop” column) of the merged communication table of each particular node may be indicative of a next hop address or next hop node that follows the particular node along each computed path between the particular node and a destination node (e.g., of each merged table row) (e.g., as may be computed at operation 1202 and/or operation 1302), where the data of a second column (“Constraint(s)” column) of the merged communication table of each particular node may be indicative of one, some, or each constraint associated with each link extending between the particular node and a next hop node (e.g., of each merged table row) (e.g., as may be computed at operation 1202 and/or operation 1302), where the data of a third column (“Local Label”) of the merged communication table of each particular node may be indicative of a label that may be locally unique to the particular node for a particular computed path (e.g., of a merged table row) (e.g., as may be computed at operation 1204 and/or operation 1304), and where the data of a fifth column (“Next Hop Label”) of the merged communication table of each particular node may be indicative of a label that may be provided by the next hop node that follows the particular node along each computed path between the particular node and a destination node (e.g., of each merged table row) (e.g., as may be computed at operation 1204 and/or operation 1304).

As one particular example, when operation 1302 of process 1300 may compute at least one route of a best set of routes from source node 1420-Z to destination node 1420-W, at least the first route (Z, X, W) including links 1425-X.Z and 1425-W.X may be identified, in which case operation 1302 may populate the merged communication tables of nodes 1420-W, 1420-X, and 1420-Z of first route (Z, X, W) as follows: (1) a first row 1402 of data structure 1490-Z of node 1420-Z associated with first route (Z, X, W) may have (1a) its portion of the Destination Address column populated by data indicative of destination node W of first route (Z, X, W), (1b) its portion of the Next Hop column populated by data indicative of next hop node X of first route (Z, X, W), and (1c) its portion of the Constraint(s) column populated by data indicative of any or all constraints associated with link 1425-X.Z extending between particular node Z and next hop node X of first route (Z, X, W) (e.g., Boolean constraint expression “A and notB”); (2) a first row 1430 of data structure 1490-X of node 1420-X associated with first route (Z, X, W) may have (2a) its portion of the Destination Address column populated by data indicative of destination node W of first route (Z, X, W), (2b) its portion of the Next Hop column populated by data indicative of next hop node W of first route (Z, X, W), and (2c) its portion of the Constraint(s) column populated by data indicative of any or all constraints associated with link 1425-W.X extending between particular node X and next hop node W of first route (Z, X, W) (e.g., Boolean constraint expression “A or B”); and (3) a first row 1440 of data structure 1490-W of node 1420-W associated with first route (Z, X, W) may have (3a) its portion of the Destination Address column populated by data indicative of destination node W of first route (Z, X, W), (3b) its portion of the Next Hop column populated by data indicative of null data (e.g., as there is no next hop node after destination node W of first route (Z, X, W)), and (3c) its portion of the Constraint(s) column populated by data indicative of null data (e.g., as there may be no link extending between particular node W and a non-existent next hop node of first route (Z, X, W)). Then, continuing with this example, a first portion of operation 1304 of process 1300 may continue to populate the merged communication table of nodes 1420-W, 1420-X, and 1420-Z of first route (Z, X, W) as follows: (1) first row 1402 of data structure 1490-Z of node 1420-Z associated with first route (Z, X, W) may have its portion of the Local Label column populated by data indicative of a label that may be locally unique to particular node 1420-Z (e.g., “1” as shown in FIG. 14, but may be any suitable unique random number that may be robust enough to be unique to the particular router node (e.g., to data structure 1490-Z)); (2) first row 1430 of data structure 1490-X of node 1420-X associated with first route (Z, X, W) may have its portion of the Local Label column populated by data indicative of a label that may be locally unique to particular node 1420-X (e.g., “6” as shown in FIG. 14, but may be any suitable unique random number that may be robust enough to be unique to the particular router node (e.g., to data structure 1490-X)); and (3) first row 1440 of data structure 1490-W of node 1420-W associated with first route (Z, X, W) may have its portion of the Local Label column populated by data indicative of a label that may be locally unique to particular node 1420-W (e.g., “1” as shown in FIG. 14, but may be any suitable unique random number that may be robust enough to be unique to the particular router node (e.g., to data structure 1490-W)). Each local label and each next hop label may be significantly longer than the labels shown in FIG. 14 (see, e.g., the labels of FIGS. 9-11). Then, continuing further with this example, a second portion of operation 1304 of process 1300 may continue to populate the merged communication table of nodes 1420-W, 1420-X, and 1420-Z of first route (Z, X, W) as follows: (1) first row 1402 of data structure 1490-Z of node 1420-Z associated with first route (Z, X, W) may have its portion of the Next Hop Label column populated by data indicative of a label that may be locally unique to next hop node X from particular node Z of first route (Z, X, W) and that may be associated with first route (Z, X, W) at that next hop node X (e.g., “6” as shown in FIG. 14, which is the local label of first row 1430 of data structure 1490-X of next hop node 1420-X associated with first route (Z, X, W) (e.g., as may have been defined in the first portion of operation 1304)); (2) first row 1430 of data structure 1490-X of node 1420-X associated with first route (Z, X, W) may have its portion of the Next Hop Label column populated by data indicative of a label that may be locally unique to next hop node W from particular node X of first route (Z, X, W) and that may be associated with first route (Z, X, W) at that next hop node W (e.g., “1” as shown in FIG. 14, which is the local label of first row 1440 of data structure 1490-W of next hop node 1420-W associated with first route (Z, X, W) (e.g., as may have been defined in the first portion of operation 1304)); and (3) first row 1440 of data structure 1490-W of node 1420-W associated with first route (Z, X, W) may have its portion of the Next Hop Label column populated by data indicative of null data (e.g., as there is no next hop node after destination node W of first route (Z, X, W)). The next hop label data may be populated using any suitable technique(s), including LDP (e.g., a node may request from its neighbors), centralize, and/or the like.

As one other particular example, when operation 1302 of process 1300 may compute at least one other route of a best set of routes from source node 1420-Z to destination node 1420-W, at least the second route (Z, Y, W) including links 1425-Y.Z and 1425-W.Y may be identified, in which case operation 1302 may (further) populate the merged communication tables of nodes 1420-W, 1420-X, and 1420-Z of second route (Z, Y, W) as follows: (1) a second row 1410 of data structure 1490-Z of node 1420-Z associated with second route (Z, Y, W) may have (1a) its portion of the Destination Address column populated by data indicative of destination node W of second route (Z, Y, W), (1b) its portion of the Next Hop column populated by data indicative of next hop node Y of second route (Z, Y, W), and (1c) its portion of the Constraint(s) column populated by data indicative of any or all constraints associated with link 1425-Y.Z extending between particular node Z and next hop node Y of second route (Z, Y, W) (e.g., Boolean constraint expression “notA and B”); and (2) a first row 1450 of data structure 1490-Y of node 1420-Y associated with second route (Z, Y, W) may have (2a) its portion of the Destination Address column populated by data indicative of destination node W of second route (Z, Y, W), (2b) its portion of the Next Hop column populated by data indicative of next hop node W of second route (Z, Y, W), and (2c) its portion of the Constraint(s) column populated by data indicative of any or all constraints associated with link 1425-W.Y extending between particular node Y and next hop node W of second route (Z, Y, W) (e.g., Boolean constraint expression “A or B”), while it may be determined that a new row of data need not be added to data structure 1490-W of node 1420-W beyond row 1440 as that row may already be associated with second route (Z, Y, W) and may have its portion of the Destination Address column populated by data indicative of destination node W of second route (Z, Y, W), its portion of the Next Hop column populated by data indicative of null data (e.g., as there is no next hop node after destination node W of second route (Z, Y, W)), and its portion of the Constraint(s) column populated by data indicative of null data (e.g., as there may be no link extending between particular node W and a non-existent next hop node of second route (Z, Y, W)). Then, continuing with this example, a first portion of operation 1304 of process 1300 may continue to populate the merged communication table of nodes 1420-W, 1420-X, and 1420-Z of second route (Z, Y, W) as follows: (1) second row 1410 of data structure 1490-Z of node 1420-Z associated with second route (Z, Y, W) may have its portion of the Local Label column populated by data indicative of a label that may be locally unique to particular node 1420-Z (e.g., “2” as shown in FIG. 14, but may be any suitable unique random number that may be robust enough to be unique to the particular router node (e.g., to data structure 1490-Z)); and (2) first row 1450 of data structure 1490-Y of node 1420-Y associated with second route (Z, Y, W) may have its portion of the Local Label column populated by data indicative of a label that may be locally unique to particular node 1420-Y (e.g., “9” as shown in FIG. 14, but may be any suitable unique random number that may be robust enough to be unique to the particular router node (e.g., to data structure 1490-Y)); while first row 1440 of data structure 1490-W of node 1420-W may be associated with second route (Z, Y, W) as its portion of the Local Label column may already be populated by data indicative of a label that may be locally unique to particular node 1420-W (e.g., “1” as shown in FIG. 14, but may be any suitable unique random number that may be robust enough to be unique to the particular router node (e.g., to data structure 1490-W) for any path with a destination of node W). Then, continuing further with this example, a second portion of operation 1304 of process 1300 may continue to populate the merged communication table of nodes 1420-W, 1420-X, and 1420-Z of second route (Z, Y, W) as follows: (1) second row 1410 of data structure 1490-Z of node 1420-Z associated with second route (Z, Y, W) may have its portion of the Next Hop Label column populated by data indicative of a label that may be locally unique to next hop node Y from particular node Z of second route (Z, Y, W) and that may be associated with second route (Z, Y, W) at that next hop node Y (e.g., “9” as shown in FIG. 14, which is the local label of first row 1450 of data structure 1490-Y of next hop node 1420-Y associated with second route (Z, Y, W) (e.g., as may have been defined in the first portion of operation 1304)); and (2) first row 1450 of data structure 1490-Y of node 1420-Y associated with second route (Z, Y, W) may have its portion of the Next Hop Label column populated by data indicative of a label that may be locally unique to next hop node W for any route for which node W is the destination (e.g., second route (Z, Y, W)) and that may be associated with second route (Z, Y, W) at that next hop node W (e.g., “1” as shown in FIG. 14, which is the local label of first row 1440 of data structure 1490-W of next hop node 1420-W associated with second route (Z, Y, W) (e.g., as may have been defined in the first portion of operation 1304)), while first row 1440 of data structure 1490-W of node 1420-W associated with second route (Z, Y, W) may have its portion of the Next Hop Label column populated by data indicative of null data (e.g., as there is no next hop node after destination node W of second route (Z, Y, W)).

Once data structures 1490 have been populated for defining a merged communication table for various nodes of a network (e.g., at operations 1302 and 1304 of process 1300), one or more initial packets of a flow (e.g., packets without an assigned path (e.g., without any forwarding label(s)) may be received at a particular router as an ingress router of the network for that flow (e.g., packet(s) 303 at router 320), and operation 1306 may (1) determine, at the ingress router (e.g., node 1420-Z or router 320), flow constraints of the flow (e.g., flow constraints 316), which may include collecting data from any suitable remote source(s) (e.g., any suitable data 99 from any suitable data device 118)), (2) select, at the ingress router (e.g., node 1420-Z or router 320), a path from the computed best set of routes for the flow's destination that satisfies the determined flow constraints (e.g., path selection 306/1306 using a routing table of the router (e.g., routing table 314 of router 320 computed at routing process 312 and/or a routing table portion of data structure 1490-Z of node 1420-Z computed at operation 1302) and any suitable flow constraints 316, which may identify a local label for the flow at that router (e.g., local label 305 for providing packet 303″ (e.g., packet 303 with local label 305)). For example, if the flow received at source node 1420-Z is indicative of data to be communicated from source node 1420-Z to destination node 1420-W and current Boolean constraint variable values are determined to be A=True and B=False (e.g., by analyzing any determined flow constraints of the flow in light of the routing table of data structure 1490-Z of node Z), then it may be determined that only first route (Z, X, W) of the routing table satisfies the determined flow constraints (e.g., the constraint “A and notB” of first row 1402 of data structure 1490-Z for destination W is satisfied when A=True and B=False) but that second route (Z, Y, W) of the routing table does not satisfy the determined flow constraints (e.g., the constraint “notA and B” of second row 1410 of data structure 1490-Z for destination W is not satisfied when A=True and B=False), and that first route (Z, X, W) may be selected (e.g., at path selection 306 and/or operation 1306) such that the local label “1” of the routing table for that selected path may be chosen and used to configure the forwarding state of node 1420-Z for the flow (e.g., that local label may be passed as local label 305 with packet 303 as packet 303″ from path selection 306 to destination independent forwarding 308). Next, that selected local label may be used to carry out destination independent forwarding of the packet to a next hop in the selected path (e.g., destination independent forwarding 308 may receive packet 303″ and use local label 305 of the node to identify a next hop label for the next hop node in the path (e.g., using forwarding table 322 of router 320 computed at routing process 312 and/or a forwarding table portion of data structure 1490-Z of node 1420-Z computed at operation 1304)). For example, node 1490-Z may utilize local label “1” to identify next hop label “6” in the forwarding table of node 1490-Z and may swap local label “1” out for next hop label “6” for communication with packet 303 to the next hop (e.g., destination independent forwarding 308 may receive packet 303″ with local label 305 of value “1” and swap it out with next hop label 309 of value “6” for defining packet 303′″ (e.g., packet 303 with next hop label “6”), which may be forwarded on from node 1420-Z to next hop node 1420-X (e.g., after negative determinations at operations 310 and 319 with respect to the packet)).

Continuing with this example, node 1420-X may receive such a packet 303′″ (e.g., packet 303′ with next hop label “6”) as incoming data and may identify, at node 1420-X, the path of the computed set of paths at the particular hop node that includes a local label with a value equal to the value of the next hop label of the received packet and (2) replace, at the hop node, the next hop label of the received packet with the next hop label of the identified path and (3) forward, from the hop node, the packet with the replaced next hop label to the next hop of the identified path (e.g., at operation 1308). For example, as shown in FIG. 3, a packet with a next hop label, identified as packet 303′ (a packet with next hop label 307), may be received at a router node 320 and operation 304 may determine that the received packet 303′ may include an assigned path (e.g., the received data includes a hop label (e.g., label 307)) and then will provide that received packet 303′ to destination independent forwarding 308, which may use the label 307 of the received packet 303′ to identify a new label (e.g., new next hop label 309) and destination for the packet using the forwarding table of the router. For example, at operation 1406, when node 1420-X may receive a packet with next hop label “6” (e.g., as described above from node 1420-Z), node 1420-X may use the forwarding table portion of data structure 1490-X to identify the path (e.g., row of the forwarding table) that includes a local label with a value equal to the value of the next hop label “6” of the received packet (e.g., to identify row 1430 of the forwarding table portion of data structure 1490-X as including a local label “6” that matches the value of next hop label “6” of the received packet), and then node 1420-X may replace the next hop label of the received packet with the next hop label of the identified path (e.g., replace next hop label “6” of the received packet with next hop label “1” of the identified row 1430 (e.g., at operation 308 by replacing label 307 with label 309)), and then node 1420-X may forward the packet with the replaced next hop label to the next hop of the identified path (e.g., forward the received packet, but now with next hop label “1” rather than next hop label “6”, to next hop node 1420-W of the identified row 1430 (e.g., by forwarding packet 303′″ with the replaced next hop label 309 to the next hop)).

Continuing with this example, node 1420-W may receive such a packet 303′″ (e.g., packet 303′ with next hop label “1”) as incoming data and may identify, at node 1420-W, the path of the computed set of paths at the particular hop node that includes a local label with a value equal to the value of the next hop label of the received packet and (2) determine that the particular hop node is the destination node of the identified path (e.g., that node 1420-W is the egress hop of the identified path of the received packet) and (3) pop the next hop label from the received packet at the egress hop and forward the packet from the egress hop to next hop (or destination host) on directly connected LAN (e.g., at operation 1310). For example, as shown in FIG. 3, a packet with a next hop label, identified as packet 303′ (a packet with next hop label 307), may be received at a router node 320 and operation 304 may determine that the received packet 303′ may include an assigned path (e.g., the received data includes a hop label (e.g., label 307)) and then will provide that received packet 303′ to destination independent forwarding 308, which may use the label 307 of the received packet 303′ to identify that router node 320 is the egress hop for the received packet using the forwarding table of the router and then pop out the label (e.g., pop out label 307 at operation 317 or operation 321) and provide as a packet 303″″ with no next hop label to a next hop (or destination host) on directly connected LAN (e.g., dependent upon determinations at operation 310 and/or operation 319). For example, at operation 1410, when node 1420-W may receive a packet with next hop label “1” (e.g., as described above from node 1420-X), node 1420-W may use the forwarding table portion of data structure 1490-W to identify the path (e.g., row of the forwarding table) that includes a local label with a value equal to the value of the next hop label “1” of the received packet (e.g., to identify row 1440 of the forwarding table portion of data structure 1490-W as including a local label “1” that matches the value of next hop label “1” of the received packet), and then node 1420-W may determine that there is no next hop label identified by the forwarding table portion of data structure 1490-W for the identified path, such that node 1420-W may determine that it is the egress router for the packet's flow and then pop (e.g., remove) the next hop label “1” from the received packet and then handle the packet accordingly (e.g., forward the packet from the egress hop to a next hop (or destination host) on directly connected LAN (e.g., at operation 1310)).

As another example, once data structures 1490 have been populated for defining a merged communication table for various nodes of a network (e.g., at operations 1302 and 1304 of process 1300), a flow may be received at source node 1420-Z that is indicative of data to be communicated from source node 1420-Z to destination node 1420-W and current Boolean constraint variable values are determined to be A=False and B=True (e.g., by analyzing any determined flow constraints of the flow in light of the routing table of data structure 1490-Z of node Z), and then it may be determined that only second route (Z, Y, W) of the routing table satisfies the determined flow constraints (e.g., the constraint “notA and B” of second row 1410 of data structure 1490-Z for destination W is satisfied when A=False and B=True) but that first route (Z, X, W) of the routing table does not satisfy the determined flow constraints (e.g., the constraint “A and notB” of first row 1402 of data structure 1490-Z for destination W is not satisfied when A=False and B=True), and that second route (Z, Y, W) may be selected (e.g., at path selection 306 and/or operation 1306) such that the local label “2” of the routing table for that selected path may be chosen and used to configure the forwarding state of node 1420-Z for the flow (e.g., that local label may be passed as local label 305 with packet 303 as packet 303″ from path selection 306 to destination independent forwarding 308). Next, that selected local label may be used to carry out destination independent forwarding of the packet to a next hop in the selected path (e.g., destination independent forwarding 308 may receive packet 303″ and use local label 305 of the node to identify a next hop label for the next hop node in the path (e.g., using forwarding table 322 of router 320 computed at routing process 312 and/or a forwarding table portion of data structure 1490-Z of node 1420-Z computed at operation 1304)). For example, node 1490-Z may utilize local label “2” to identify next hop label “9” in the forwarding table of node 1490-Z and may swap local label “2” out for next hop label “9” for communication with packet 303 to the next hop (e.g., destination independent forwarding 308 may receive packet 303″ with local label 305 of value “2” and swap it out with next hop label 309 of value “9” for defining packet 303′″ (e.g., packet 303 with next hop label “9”), which may be forwarded on from node 1420-Z to next hop node 1420-Y (e.g., after negative determinations at operations 310 and 319 with respect to the packet)).

Continuing with this example, node 1420-Y may receive such a packet 303′″ (e.g., packet 303′ with next hop label “9”) as incoming data and may identify, at node 1420-Y, the path of the computed set of paths at the particular hop node that includes a local label with a value equal to the value of the next hop label of the received packet and (2) replace, at the hop node, the next hop label of the received packet with the next hop label of the identified path and (3) forward, from the hop node, the packet with the replaced next hop label to the next hop of the identified path (e.g., at operation 1308). For example, as shown in FIG. 3, a packet with a next hop label, identified as packet 303′ (a packet with next hop label 307), may be received at a router node 320 and operation 304 may determine that the received packet 303′ may include an assigned path (e.g., the received data includes a hop label (e.g., label 307)) and then will provide that received packet 303′ to destination independent forwarding 308, which may use the label 307 of the received packet 303′ to identify a new label (e.g., new next hop label 309) and destination for the packet using the forwarding table of the router. For example, at operation 1406, when node 1420-Y may receive a packet with next hop label “9” (e.g., as described above from node 1420-Z), node 1420-Y may use the forwarding table portion of data structure 1490-Y to identify the path (e.g., row of the forwarding table) that includes a local label with a value equal to the value of the next hop label “9” of the received packet (e.g., to identify row 1450 of the forwarding table portion of data structure 1490-Y as including a local label “9” that matches the value of next hop label “9” of the received packet), and then node 1420-Y may replace the next hop label of the received packet with the next hop label of the identified path (e.g., replace next hop label “9” of the received packet with next hop label “1” of the identified row 1450 (e.g., at operation 308 by replacing label 307 with label 309)), and then node 1420-Y may forward the packet with the replaced next hop label to the next hop of the identified path (e.g., forward the received packet, but now with next hop label “1” rather than next hop label “9”, to next hop node 1420-W of the identified row 1450 (e.g., by forwarding packet 303′″ with the replaced next hop label 309 to the next hop)).

Continuing with this example, node 1420-W may receive such a packet 303′″ (e.g., packet 303′ with next hop label “1”) as incoming data and may identify, at node 1420-W, the path of the computed set of paths at the particular hop node that includes a local label with a value equal to the value of the next hop label of the received packet and (2) determine that the particular hop node is the destination node of the identified path (e.g., that node 1420-W is the egress hop of the identified path of the received packet) and (3) pop the next hop label from the received packet at the egress hop and forward the packet from the egress hop to next hop (or destination host) on directly connected LAN (e.g., at operation 1310). For example, as shown in FIG. 3, a packet with a next hop label, identified as packet 303′ (a packet with next hop label 307), may be received at a router node 320 and operation 304 may determine that the received packet 303′ may include an assigned path (e.g., the received data includes a hop label (e.g., label 307)) and then will provide that received packet 303′ to destination independent forwarding 308, which may use the label 307 of the received packet 303′ to identify that router node 320 is the egress hop for the received packet using the forwarding table of the router and then pop out the label (e.g., pop out label 307 at operation 317 or operation 321) and provide as a packet 303″″ with no next hop label to a next hop (or destination host) on directly connected LAN (e.g., dependent upon determinations at operation 310 and/or operation 319). For example, at operation 1410, when node 1420-W may receive a packet with next hop label “1” (e.g., as described above from node 1420-Y), node 1420-W may use the forwarding table portion of data structure 1490-W to identify the path (e.g., row of the forwarding table) that includes a local label with a value equal to the value of the next hop label “1” of the received packet (e.g., to identify row 1440 of the forwarding table portion of data structure 1490-W as including a local label “1” that matches the value of next hop label “1” of the received packet), and then node 1420-W may determine that there is no next hop label identified by the forwarding table portion of data structure 1490-W for the identified path, such that node 1420-W may determine that it is the egress router for the packet's flow and then pop (e.g., remove) the next hop label “1” from the received packet and then handle the packet accordingly (e.g., forward the packet from the egress hop to a next hop (or destination host) on directly connected LAN (e.g., at operation 1310)).

Therefore, FIGS. 3, 13, and 14 may illustrate an example of forwarding using label swap forwarding state, whereby traffic can be forwarded over multiple paths from the same source, and to the same destination through the use of forwarding state that may not be based on destination address information (e.g., due to a forwarding table (e.g., as used at each iteration of operation 1308 for a particular flow with respect to each packet and each hop node) may not include data specific to a destination node of the flow but may only include data indicative of a local label, a next hop label, and a next hop node). A benefit may be that this may support multiple paths (e.g., as destination based forwarding is, often, single path). Another benefit may be that this may be faster or lower power (e.g., fixed length label lookups may be easier than variable length IP address lookups). In some embodiments, forwarding state may be computed while carrying out routing computations (e.g., with source routing), while, in other embodiments, forwarding state may not be computed while carrying out routing computations (e.g., with segment routing). This may or may not be carried out by routing computation. Source routing, MPLS, and segment routing can be done either during or after. A forwarding state may be considered the data described with respect to a particular row of a communication table or a forwarding table (e.g., data for a particular path), such as labels or forwarding identifiers (e.g., forwarding identifiers may be referred to herein as labels and vice versa).

The term “autonomic” has sometimes been defined as “occurring involuntarily; automatic.” In a limited sense, an Internet routing architecture may be characterized as autonomic in that it may control network routing in response to internal stimuli. Specifically, routing may be automatically recomputed and traffic may be re-routed as network topology and link costs change.

As mentioned, a new routing model provided by this disclosure may be based on the best set of paths between any given source and destination in a network. In this new model, routes may be pre-computed (e.g., computed in response to changes in network state) that may provide the full range of performance and that may support the full range of policies available in a network. A notable innovation in this model may be the use of Boolean constraints to define policies to be enforced that may be related to the assignment of traffic to network paths. These constraints may be defined by Boolean expressions that may be composed of Boolean variables that may reflect policy-relevant network state(s).

Routing decisions may be made based on internal network state, such as link costs or the assignment of network links to administrative groups (e.g., to implement policies vs performance goals). The new routing model of this disclosure may additionally or alternatively tie Boolean variables to state that is external to the network. Examples may include, but are not limited to, time of day, threat levels (e.g., military DEFCON levels), network user state (e.g., such as the troops in combat (“TIC”) status used in the military), and/or the like. Inclusion of external state in the routing computation may allow network operators to pre-configure network configuration changes based on the value of these new Boolean constraints, thereby causing the network to respond autonomically to changes in network state.

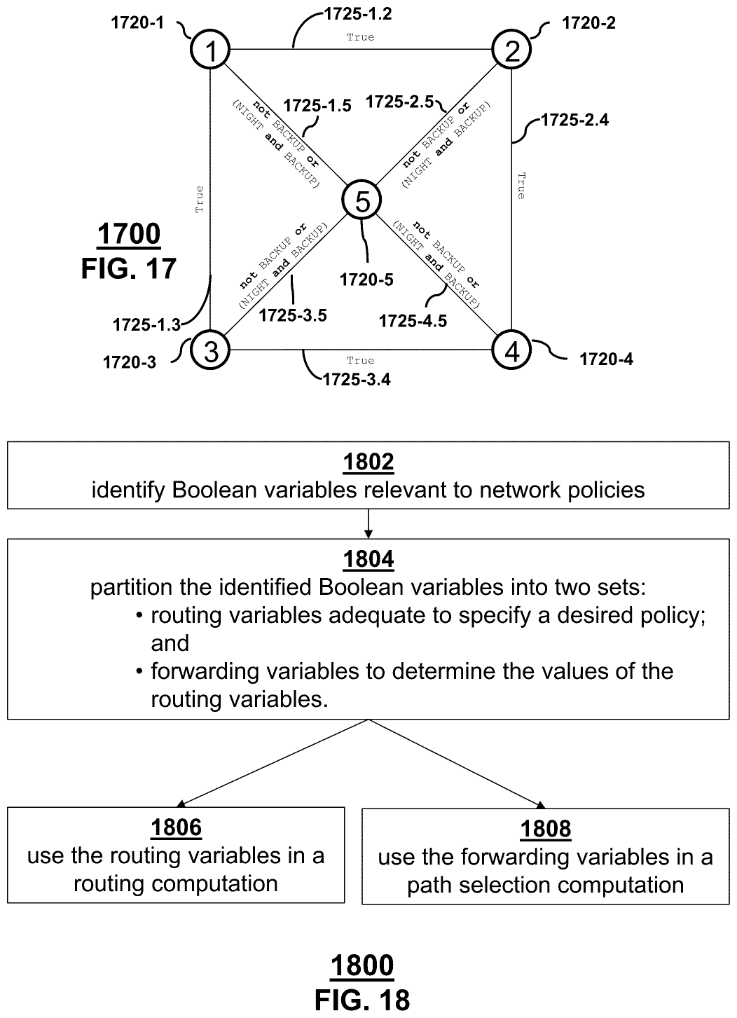

As an example, a policy may exist of not allowing backup of computer storage across an organization's core networks during the day (e.g., due to the load it would put on daytime production traffic). By defining two Boolean variables, DAYTIME and BACKUP, the DAYTIME variable may be set by the routing infrastructure based on the time of day (e.g., this variable may be True from 8 am-8 pm and False from 8 pm-8 am), and the BACKUP variable may be defined to True for backup traffic between systems and the backup server. Given these variables, the following constraint may be defined for the core network links: (1) “(not DAYTIME) or (DAYTIME and not BACKUP)”; or the similar (2) “(not BACKUP) or (NIGHT and BACKUP)” (e.g., as described with respect to FIG. 17 (e.g., with variables NIGHT and BACKUP (e.g., where the NIGHT variable may be True from 8 pm-8 am) for certain core links of a network). This policy may allow any traffic to use the core links between 8 pm and 8 am, but may not allow backup traffic over those links during the day.

This powerful and novel capability has many potential applications. The new routing model of this disclosure may be extended to (explicitly) include Boolean variables whose true/false values may reflect any policy-relevant state, where examples may include, but are not limited to, threat levels (e.g., DEFCON), time-of-day related state (e.g., night vs day, any partitioning of the day (e.g., to be used in scheduling traffic), daylight savings time, specific time zones, etc.), geographical location, jurisdictions (e.g., European Union vs. United States vs. other legal jurisdictions that might have relevance to the handling of network resources, etc.), network access control-related state, user identity, group membership, host configuration (e.g., operating system version, application software inventory and versions, patch levels for the operating system and applications, etc.), meta information about the network (e.g., router/switch fanout, path redundancy between specific locations, etc.), threat feeds (e.g., Spamhaus, the BZAR feed of Mitre Attack events, etc.), weather feeds, jurisdictions, facilities characteristics, global or current events (e.g., Super Bowl Sunday, Thanksgiving, Inauguration Day, whether or not a specific country has been designated a national threat by a government agency, etc.), and/or the like.

The autonomic nature of this may come from the fact that the true/false value of many of these Boolean variables can be determined without human intervention. Variables related to time, geographic location, and/or the like can be determined from a system clock and GPS, respectively. Network access control information can be obtained from network access control systems (e.g., open source osquery or Cisco's commercial identity services engine (“ISE”)), and threat feed sources as mentioned above, while network meta information (e.g., as described above) may be uniquely available from the routing/switching infrastructure of a network.

With a configuration based on the value of Boolean variables such as these or others, changes in variable value can be handled by the routing/switching systems itself without any human involvement or, in other words in an “involuntary or unconscious” (e.g., autonomic) manner.

This capability may have profound implications for the ability of networks to be able to respond in real-time to attacks or other environmental changes; something simply not possible with current network technology.

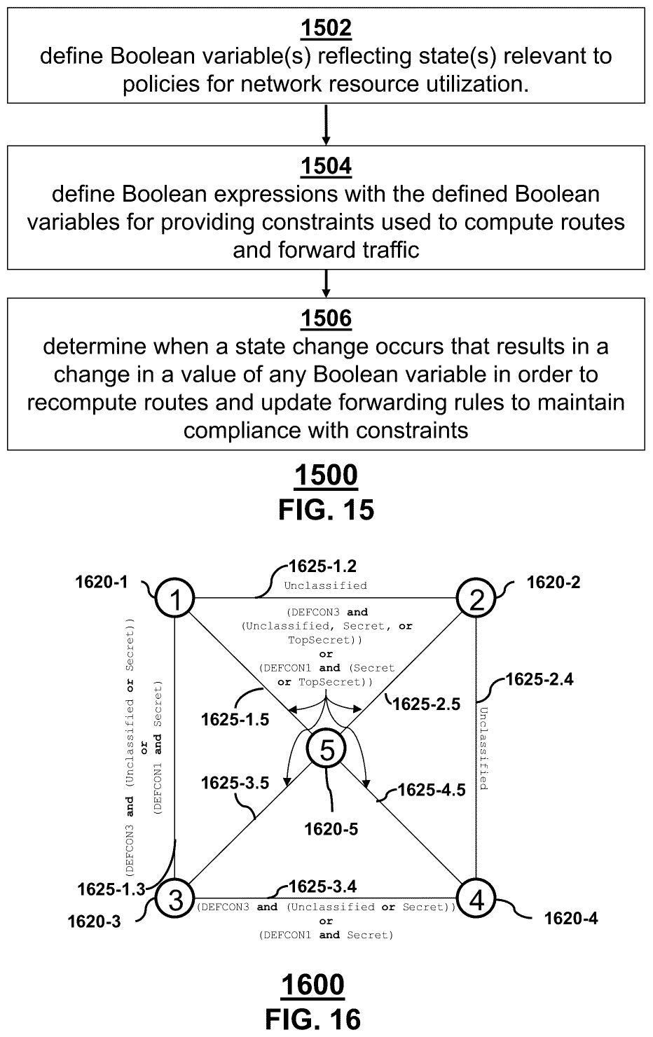

FIG. 15 is a flowchart of an illustrative process 1500 for autonomic network routing. At operation 1502, one or more Boolean variables (e.g., a set of Boolean variables) may be defined or otherwise identified that may reflect one or more states relevant to any suitable policies that may be required or available for resource utilization for a network. These variables may reflect the true/false values of any suitable any policy-relevant state including, but not limited to, threat levels (e.g., military DEFCON levels), time of day, geographic location, political or legal jurisdictions, authenticated user information (e.g., group membership information), host configuration information (e.g., operating system and application software versions and patch levels, etc.), threat feeds (e.g., Spamhaus or the BZAR feed of Mitre Attack events), “meta” information about the network (e.g., router/switch fanout, path redundancy between specific locations, etc.), and/or the like. At operation 1504, these variables may be used to define Boolean expressions that may be used to define constraints (e.g., policy constraints) for use in routing and/or forwarding of a network routing model (e.g., to implement any desired resource utilization policies through determining whether or not an expression is associated with a link and satisfied with respect to a flow to be communicated (e.g., the Boolean constraints described above (e.g., with respect to FIGS. 5-14))). At operation 1506, state changes in the values of these variables may be monitored and detected (e.g., change in time period, geographic location, threat levels, availability of new vulnerabilities, whether or not a specific country has been designated a national threat by a government agency, etc.), such as through detection of any new data (e.g., through any suitable push/pull technique for data 99 from any suitable remote data device(s) 118) and, on a detected change, recompute routing and forwarding functions (e.g., update forwarding rules), such as by re-running process 1200 or 1300, to maintain compliance with any constraints (e.g., desired policies).

The operations shown in process 1500 of FIG. 15 are only illustrative and that existing operations may be modified or omitted, additional operations may be added, and the order of certain operations may be altered.

FIG. 16 shows at least a portion of a network 1600 that may include any suitable number of nodes or router devices 1620, such as node 1620-1, node 1620-2, node 1620-3, node 1620-4, and node 1620-5. Different nodes may be communicatively coupled to one another (e.g., using communication components of the nodes) over different communication links 1625, which may differ in any suitable manner, such as by security strength, whereby links 1625 may include strongly secured link 1625-1.5 between nodes 1620-1 and 1620-5, strongly secured link 1625-2.5 between nodes 1620-2 and 1620-5, strongly secured link 1625-3.5 between nodes 1620-3 and 1620-5, strongly secured link 1625-4.5 between nodes 1620-4 and 1620-5, medium secured link 1625-1.3 between nodes 1620-1 and 1620-3, medium secured link 1625-3.4 between nodes 1620-3 and 1620-4, unsecured link 1625-1.2 between nodes 1620-1 and 1620-2, and unsecured link 1625-2.4 between nodes 1620-2 and 1620-4. One, some, or each link or one, some, or each type of link (e.g., strongly secured, medium secured, unsecured, etc.) may be associated with one or more constraints (e.g., performance constraints and/or policy constraints and/or service chaining constraints, etc.). For example, as shown, each link may be provided with at least one Boolean constraint (e.g., as a policy constraint, etc.) that may be defined by any suitable Boolean expression that may be composed of any suitable Boolean variable(s) (e.g., traffic level Boolean variables “Unclassified”, “Secret”, and “TopSecret”, and threat level variables “DEFCON3” and “DEFCON1”, although any additional or alternative Boolean variable(s) and/or Boolean constraints may be associated with one, some, or each link), which may be used to express a constraint of flows using the network. As just some specific examples, each one of strongly secured links 1625-1.5, 1625-2.5, 1625-3.5, and 1625-4.5 may include a Boolean constraint with a Boolean expression [(DEFCON3 and (Unclassified or Secret or TopSecret)) or (DEFCON1 and (Secret or TopSecret))], each one of medium secured links 1625-1.3 and 1625-3.4 may include a Boolean constraint with a Boolean expression [(DEFCON3 and (Unclassified or Secret)) or (DEFCON1 and Secret)], while each one of unsecured links 1625-1.2 and 1625-2.4 may include a Boolean constraint with a Boolean expression [Unclassified] (e.g., the expression may be satisfied as long as the traffic level Boolean variable “Unclassified” is True). Therefore, because different links of different security strength may be labeled with Boolean constraints reflecting military-style MLS, augmented with DEFCON variables, certain policies may be implemented, such as, (1) at DEFCON3 (e.g., a low threat level), traditional MLS may be implemented where strongly secured links may allow all traffic levels (Unclassified, Secret, TopSecret), where medium secured links may allow Unclassified and Secret traffic, and where unsecured links may allow only Unclassified traffic, and (2) at DEFCON1 (e.g., a higher threat level), Unsecured traffic may be dropped from the secured (e.g., high and medium) links (e.g., to conserve resources for handling the threat, and to protect sensitive traffic). With this configuration, changes in the DEFCON status can be communicated to the network (e.g., via a web site (e.g., as data 99 from any suitable data device 118)), and network resource management may be changed to enforce the new constraints (e.g., at operation 1506 of process 1500).

FIG. 17 shows at least a portion of a network 1700 that may include any suitable number of nodes or router devices 1720, such as node 1720-1, node 1720-2, node 1720-3, node 1720-4, and node 1720-5. Different nodes may be communicatively coupled to one another (e.g., using communication components of the nodes) over different communication links 1725, which may differ in any suitable manner, such as by core or non-core links (e.g., whether or not the link is with a core network (e.g., as may be represented by node 1720-5)), whereby links 1725 may include core link 1725-1.5 between nodes 1720-1 and 1720-5, core link 1725-2.5 between nodes 1720-2 and 1720-5, core link 1725-3.5 between nodes 1720-3 and 1720-5, core link 1725-4.5 between nodes 1720-4 and 1720-5, non-core link 1725-1.3 between nodes 1720-1 and 1720-3, non-core link 1725-3.4 between nodes 1720-3 and 1720-4, non-core link 1725-1.2 between nodes 1720-1 and 1720-2, and non-core link 1725-2.4 between nodes 1720-2 and 1720-4. One, some, or each link or one, some, or each type of link (e.g., core, non-core, etc.) may be associated with one or more constraints (e.g., performance constraints and/or policy constraints and/or service chaining constraints, etc.). For example, as shown, each link may be provided with at least one Boolean constraint (e.g., as a policy constraint, etc.) that may be defined by any suitable Boolean expression that may be composed of any suitable Boolean variable(s) (e.g., “BACKUP” and “NIGHT”, although any additional or alternative Boolean variable(s) and/or Boolean constraints may be associated with one, some, or each link), which may be used to express a constraint of flows using the network. The value of the BACKUP variable may be determined to be True or False based on whether or not the flow is backup traffic between systems and a backup server, while the value of the NIGHT variable may be determined to be True or False based on whether or not the time of day is currently between 8 pm and 8 am, although the variable values may be defined to be determined in any other suitable ways. As just some specific examples, each one of core links 1725-1.5, 1725-2.5, 1725-3.5, and 1725-4.5 may include a Boolean constraint with a Boolean expression [notBACKUP or (NIGHT and BACKUP)], which may indicate that non-backup traffic can use these links any time but backup traffic can only use them at night, while each one of non-core links 1725-1.2, 1725-1.3, 1725-2.4, and 1725-3.4 may include a Boolean constraint with a do not care or blank or True Boolean expression [True] (e.g., the expression may be satisfied no matter the value of the NIGHT variable and no matter the value of the BACKUP variable (e.g., expression [notBACKUP or BACKUP or notNIGHT or NIGHT])), which may satisfy all traffic constraints. Therefore, in this scenario, non-backup traffic can use the core links at any time, but backup traffic can only the core links at night, while all traffic can use the non-core links at any time. An interesting aspect of this scenario may be that one, some, or each router/switch device of the network may be configured to detect policy change on its own by noticing time changes from day to night or vice versa. In some embodiments, the specific times for this change (e.g., 8 pm, 8 am, etc.) may be configured by a network administration.

Boolean constraints may be configured for more efficient processing for multipath routing and an expanded definition of what can be covered by the Boolean constraints may be enabled by this disclosure.

In Boolean-constrained multipath routing (“BCMR”), policies for use of network resources may be specified using Boolean constraints. These Boolean constraints may be used to determine the allowability of a requested communication relative to the policies defined by the constraints (e.g., the communication constraints). Towards this end, the communication constraints may be used in computations that may be utilized to find a path for a given communication request, and may include, but are not limited to, a routing computation that may find (1) a set of paths between a given source and destination that may be allowable relative to a set of constraints applicable to that path (e.g., operations 1202, 1302, etc.) and (2) a specific set of constraints that may apply to each such path (e.g., for a particular flow), a forwarding computation that may select a path to use for a given communication request (e.g., for a particular flow) (e.g., operations 1206, 1306, etc.). In some embodiments, there may be multiple paths for a given request that may satisfy the communication constraints, so this computation may include selecting one among potentially multiple constraint-satisfying paths.

Propositions (e.g., primitive propositions) of these Boolean constraints may be defined in terms of “any globally significant attributes of the ingress router's state that can be expressed as a true/false statement”. An example of such variables may be those “describing attributes of the traffic being forwarded.” For example, a value of 6 in a protocol field of an IP header may be represented as the Boolean variable “IPProto(TCP)”, the value 53 in a destination port field of a UDP header may be represented as the Boolean variable “UDPDestPort(DOMAIN)”, and/or the like. These kind of variables can be used to specify routing constraints.

An SDN implementation of BCMR for a routing model of this disclosure may include a significantly enhanced model of constraints to address performance problems with a “global” constraint model. This enhanced constraint model for BCMR, and the enhanced model for specifying and processing these constraints, may be new and may provide many benefits (e.g., efficiency and effectiveness).

In an enhanced constraint model, propositions (e.g., primitive propositions) may be defined to include any policy-relevant state, and may belong to one of two classes, such as bound and inferred.

Bound variables may include, but are not limited to, threat levels (e.g., DEFCON1 through DEFCON5 and/or the like, where such primitives may describe the level of attack the network is under, where such variables may reflect a state that may be set by a network administration function (e.g., manually or automated), and can be used to automatically reconfigure network policies in response to threats or attacks (e.g., dedicate more resources to countermeasure traffic and less to low priority or potentially attack traffic), time of day (e.g., ToD6 pm-8 am, ToD8 am-6 pm, and/or the like, where such primitives may be computed by the routing and forwarding functions, as needed, and can be used to define time-of-day related policies (e.g., allowing backup traffic to use network core topology at night, but not during the day, etc.)), network access control information (e.g., NAC-User-JohnDoe, NAC-Loc-HQ, NAC-Dev-Tablet-iOS-9.1, and/or the like, where such primitives may be determined by network access control systems (e.g., Cisco's Identity Services Engine), and can be used to determine attributes such as user, location, and device status for use in policy decisions), traffic attributes (e.g., content classification (e.g., for HIPPA, PHI, or MilitaryOrders), location information (e.g., LOC-EngineeringBldg, LOC-China, LOC-Dorm, LOC-CombatHQ, etc.), application information (e.g., APP-FinancialSystem, APP-StudentSystem, APP-BattleCommand, APP-SEIM, etc.), and user state information (e.g., STATUS-TiC reflecting the “Troops in Combat” state that may be used in military operations, and STATUS-InClass for traffic from a student currently in class), and/or the like.

Inferred variables may be those whose value may be determined by the bound variables through the evaluation of a full set of communication constraints. Inferred variables may include, but are not limited to, GenomeResearch (e.g., which may be defined as true for all traffic for a given application run by authorized users of that application (and false otherwise)), TopSecret (e.g., which may be defined as true for all traffic for a command and control application between the battlefield and headquarters), BOTNet, and/or the like.

In an enhanced model that may be configured for specifying and processing communication constraints, the constraints, specified as Boolean expressions of these primitive propositions, may be divided into two classes: global vs. link, and routing vs. forwarding. Global constraints may be evaluated as a part of either the routing or forwarding computations. Link constraints may be evaluated in the routing computation whenever a path may be extended by a link (and so may be inherently routing constraints). Routing constraints may be evaluated as part of the routing computation. In general, routing constraints may be expressed in terms of a small subset of the primitive propositions (e.g., to minimize the cost of the routing computation), and may not involve bound variables (e.g., variables whose true/false value has been set), though these may be more like guidelines than actual rules. The downside of using bound variables in the routing constraints may be the need to recompute paths when truth values change (and the costly reconfiguration of forwarding state in the network), and/or using only unbound variables for routing may leave the burden of responding to truth assignment changes to the forwarding computation (e.g., thereby minimizing the need for costly forwarding state reconfiguration). Forwarding constraints may be evaluated as part of the forwarding computation and may include all bound variables.

The following may be various examples of constraints: (1) “GenomeResearch a GenomeFaculty and APP-GeneSeq and LOC-HPC and LOC-GenomeDB”, which may be expressing a policy described above (e.g., true for all traffic for a genome sequencing app run by authorized users of that application, and false otherwise); (2) “TopSecret APP-BattleCommand and LOC-CombatHQ and LOC-BattleField”, which may be expressing a policy described above (e.g., true for all traffic for a command and control application between the battlefield and headquarters, and false otherwise); (3) “BOTNet APP-BOT-C&C and LOC-BOT-Controller”, which may be expressing a policy described above (e.g., true for all BOT C&C traffic to/from a known BOT C&C server, and false otherwise); and (4) an application of the routing constraint guidelines described above may have these three expressions used as forwarding constraints, and may limit reference to these constraints as routing link constraints of GenomeResearch, TopSecret, and BOTNet in the form of either the positive (e.g., “GenomeResearch”) or negative (e.g., “not GenomeResearch”) forms.

Therefore, an enhanced constraint model for BCMR, and an enhanced model for specifying and processing these constraints, may provide enhancements over previous models, by, for example (1) expanding the definition of primitive propositions to represent any policy-relevant state (e.g., this may go far beyond a definition of “any globally significant attribute of the ingress router's state that can be expressed as a true/false statement,” and may allow for any information that can be communicated to the routing infrastructure (e.g., SDN controller or distributed routing computation, etc.) to be used in defining policies), (2) expanding the model for specifying and processing communication constraints to include partitioning the constraint evaluation into forwarding and routing components (e.g., this may dramatically improve the efficiency of constraint processing (e.g., evaluating constraints, and updating forwarding state, etc.) over other global constraint models), and/or the like.

Boolean constraints may be distinguished into routing and forwarding constraints. Partitioning the variables in this manner may allow for optimization of the routing and forwarding processes (e.g., of processes 1200 and/or 1300). For example, in some embodiments, a routing function may compute paths and install non-traffic-specific forwarding state in the router/switches. On receipt of a new flow in the network, the state required for the flow may be determined (e.g., involving an ingress path assignment flow table entry). This allocation of functions may allow the cost of the routing function to be reduced (e.g., in terms of the number of variables used and/or the frequency of route computations), and/or may leave the forwarding function to involve the computation of only one flow table entry. The routing process may involve computing paths that enforce policies, and/or may download precomputed forwarding state to the routers/switches. Including Boolean variables reflecting, for example, traffic attributes may require this recomputation and download process per traffic flow.

FIG. 18 is a flowchart of an illustrative process 1800 for processing Boolean constraints for use in multipath routing. At operation 1802, Boolean variables relevant to network policies may be identified (e.g., a set of Boolean variables may be identified that reflect state relevant to policies that may be required for resource utilization for a network). At operation 1804, the identified Boolean variables may be partitioned into two sets: routing variables that may be adequate to specify a desired policy and forwarding variables that may be needed to determine the values of the routing variables (e.g., the routing set of variables may be adequate to specify a desired policy in a routing computation while controlling the cost of the routing computation (e.g., limit the number of variables, select variables with lower change rates, etc.), where the routing set of variables may be relatively small in number to control the cost of the computation and/or relatively static to control the rate of routing computations, while the forwarding set of variables (e.g., the remaining variables) may be used in a forwarding process). At operation 1806, the routing variables (e.g., routing constraints 315) may be used in a routing computation (e.g., of process 1200, process 1300, etc.), while, at operation 1808, the forwarding variables (e.g., flow constraints 316) may be used in a path selection computation of the same process (e.g., of process 1200, process 1300, etc.). In some embodiments, the routing function may compute paths and/or install non-traffic-specific forwarding state in the router/switches. On receipt of a new flow in the network, the state required for the flow (e.g., involving an ingress path assignment flow table entry) may be determined. This allocation of functions may allow the cost of the routing function to be minimized (e.g., in terms of the number of variables used and/or the frequency of route computations), and/or may leave the forwarding function to involve the computation of only one flow table entry.

One implementation of the policies described in this scenario may involve the DEFCON and MLS Boolean variables of network 1600 of FIG. 16, and some set of additional variables to be used to determine the DEFCON variable values (e.g., DEFCON1, DEFCON3, etc.) and/or the MLS variable values (e.g., Unclassified, Secret, TopSecret, etc.). These additional variables may involve network address and/or port (e.g., physical and/or protocol ports) information for use in identifying MLS unclassified, secret, and top secret traffic. These values may also be determined from network access control information describing user/group information and/or workstation identification. Using the address/port solution, MLS classifications could be identified based on the source and destination hosts for specific traffic flows. For example, Boolean variables of the form IPv4xSRCAxUNCLASSIFIED, IPv4xSRCAxSECRET, IPv4xSRCAxTOPSECRET may be used to identify traffic with a source host that may be classified at the appropriate MLS sensitivity level. A similar set of variables may be set for destination addresses (e.g., replacing “SRCA” with “DSTA”). Definitions may be provided specifying what host addresses map to the different levels, and then Boolean constraints could be defined to equate a specific Boolean variable to each MLS level (e.g., the constraint: “UNCLASSIFIED if (IPv4xSRCAxUNCLASSIFIED or IPv4xDSTAxUNCLASSIFIED)” may define the UNCLASSIFIED variable to be equivalent to the statement that traffic is being transmitted to/from a host classified at that level). With this setup, the routing variables may be defined to be DEFCON1, DEFCON3, UNCLASSIFIED, SECRET, TOPSECRET, where values of the latter three variables may be determined as described above, and the DEFCON variables may be directly set via a web interface to the system (e.g., via any suitable data 99 from any suitable data device(s) 118)). This may leave the address variables to be classified as forwarding variables, including IPv4xSRCAxUNCLASSIFIED, IPv4xDSTAxUNCLASSIFIED, IPv4xSRCAxSECRET, IPv4xDSTAxSECRET, IPv4xSRCAxTOPSECRET, and IPv4xDSTAxTOPSECRET. It is to be understood that the set of forwarding variables may include some or all of the routing variables beyond whatever variable(s) may be unique to the forwarding variable set, as the split may be for limiting the amount of variables defining the routing variable set for limiting what the routing computation may have to process.

The operations shown in process 1800 of FIG. 18 are only illustrative and that existing operations may be modified or omitted, additional operations may be added, and the order of certain operations may be altered.

One or more application programming interfaces (“APIs”) may be used in some embodiments (e.g., with respect to device 118, one or more of devices 100-116, or any other suitable module or any other suitable portion of such device(s) or process(es) of FIGS. 1-18 and 21-44). An API may be an interface implemented by a program code component or hardware component (hereinafter “API-implementing component”) that may allow a different program code component or hardware component (hereinafter “API-calling component”) to access and use one or more functions, methods, procedures, data structures, classes, and/or other services provided by the API-implementing component. An API can define one or more parameters that may be passed between the API-calling component and the API-implementing component.

An API may allow a developer of an API-calling component, which may be a third party developer, to leverage specified features provided by an API-implementing component. There may be one API-calling component or there may be more than one such component. An API can be a source code interface that a computer system or program library may provide in order to support requests for services from an application. An operating system (“OS”) can have multiple APIs to allow applications running on the OS to call one or more of those APIs, and a service (e.g., a program library) can have multiple APIs to allow an application that uses the service to call one or more of those APIs. An API can be specified in terms of a programming language that can be interpreted or compiled when an application is built.

In some embodiments, the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (e.g., not exposed) and can provide a subset of the first set of functions and can also provide another set of functions, such as testing or debugging functions that are not in the first set of functions. In other embodiments, the API-implementing component may itself call one or more other components via an underlying API and may thus be both an API-calling component and an API-implementing component.

An API may define the language and parameters that API-calling components may use when accessing and using specified features of the API-implementing component. For example, an API-calling component may access the specified features of the API-implementing component through one or more API calls or invocations (e.g., embodied by function or method calls) exposed by the API and may pass data and control information using parameters via the API calls or invocations. The API-implementing component may return a value through the API in response to an API call from an API-calling component. While the API may define the syntax and result of an API call (e.g., how to invoke the API call and what the API call does), the API may not reveal how the API call accomplishes the function specified by the API call. Various API calls may be transferred via the one or more application programming interfaces between the calling component (e.g., API-calling component) and an API-implementing component. Transferring the API calls may include issuing, initiating, invoking, calling, receiving, returning, and/or responding to the function calls or messages. Thus, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list, or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module. It should be understood that the API-implementing component and the API-calling component may be the same or different type of module from each other. API-implementing components may in some cases be embodied at least in part in firmware, microcode, or other hardware logic. In some embodiments, an API may allow a client program to use the services provided by a Software Development Kit (“SDK”) library. In other embodiments, an application or other client program may use an API provided by an Application Framework. In such embodiments, the application or client program may incorporate calls to functions or methods provided by the SDK and provided by the API or may use data types or objects defined in the SDK and provided by the API. An Application Framework may, in these embodiments, provide a main event loop for a program that responds to various events defined by the Framework. The API may allow the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, and the like, and the API may be implemented in part by firmware, microcode, or other low level logic that may execute in part on the hardware component.

The API-calling component may be a local component (i.e., on the same data processing system as the API-implementing component) or a remote component (i.e., on a different data processing system from the API-implementing component) that may communicate with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that may be exposed to a different API-calling component.

The API may allow multiple API-calling components written in different programming languages to communicate with the API-implementing component, such that the API may include features for translating calls and returns between the API-implementing component and the API-calling component. However, the API may be implemented in terms of a specific programming language. An API-calling component can, in some embodiments, may call APIs from different providers, such as a set of APIs from an OS provider and another set of APIs from a plug-in provider and another set of APIs from another provider (e.g., the provider of a software library) or creator of the another set of APIs.

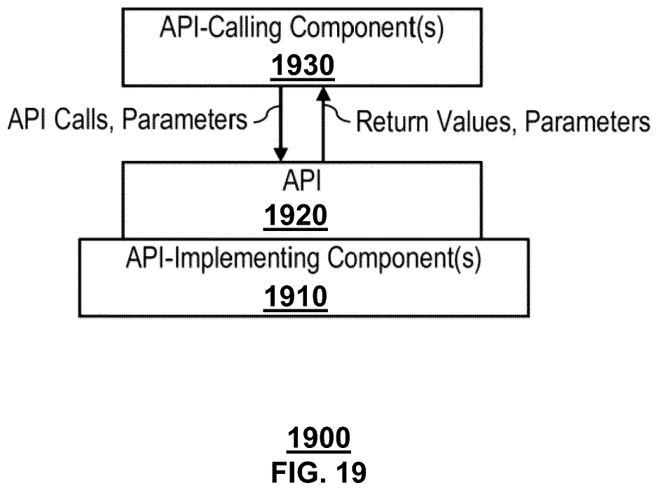

FIG. 19 is a block diagram illustrating an exemplary API architecture 1900, which may be used in some embodiments. As shown in FIG. 19, the API architecture 1900 may include an API-implementing component 1910 (e.g., an operating system, a library, a device driver, an API, an application program, software, or other module) that may implement an API 1920. API 1920 may specify one or more functions, methods, classes, objects, protocols, data structures, formats, and/or other features of API-implementing component 1910 that may be used by an API-calling component 1930. API 1920 can specify at least one calling convention that may specify how a function in API-implementing component 1910 may receive parameters from API-calling component 1930 and how the function may return a result to API-calling component 1930. API-calling component 1930 (e.g., an operating system, a library, a device driver, an API, an application program, software, or other module) may make API calls through API 1920 to access and use the features of API-implementing component 1910 that may be specified by API 1920. API-implementing component 1910 may return a value through API 1920 to API-calling component 1930 in response to an API call.

It is to be appreciated that API-implementing component 1910 may include additional functions, methods, classes, data structures, and/or other features that may not be specified through API 1920 and that may not be available to API-calling component 1930. It is to be understood that API-calling component 1930 may be on the same system as API-implementing component 1910 or may be located remotely and may access API-implementing component 1910 using API 1920 over a network. While FIG. 19 illustrates a single API-calling component 1930 interacting with API 1920, it is to be understood that other API-calling components, which may be written in different languages than, or the same language as, API-calling component 1930, may use API 1920.

API-implementing component 1910, API 1920, and API-calling component 1930 may each be implemented by software, but may also be implemented in hardware, firmware, or any combination of software, hardware, and firmware. They each may also be embodied as machine- or computer-readable code recorded on a machine- or computer-readable medium. The computer-readable medium may be any data storage device that can store data or instructions which can thereafter be read by a computer system. Examples of the computer-readable medium may include, but are not limited to, read-only memory, random-access memory, flash memory, CD-ROMs, DVDs, magnetic tape, and optical data storage devices (e.g., memory 13 of FIG. 1A). The computer-readable medium can also be distributed over network-coupled computer systems so that the computer readable code is stored and executed in a distributed fashion. For example, the computer-readable medium may be communicated from one electronic device to another electronic device using any suitable communications protocol (e.g., the computer-readable medium may be communicated to one electronic device from another electronic device via a communications setup and/or to one electronic device from a remote server of a communications setup of the system). The computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

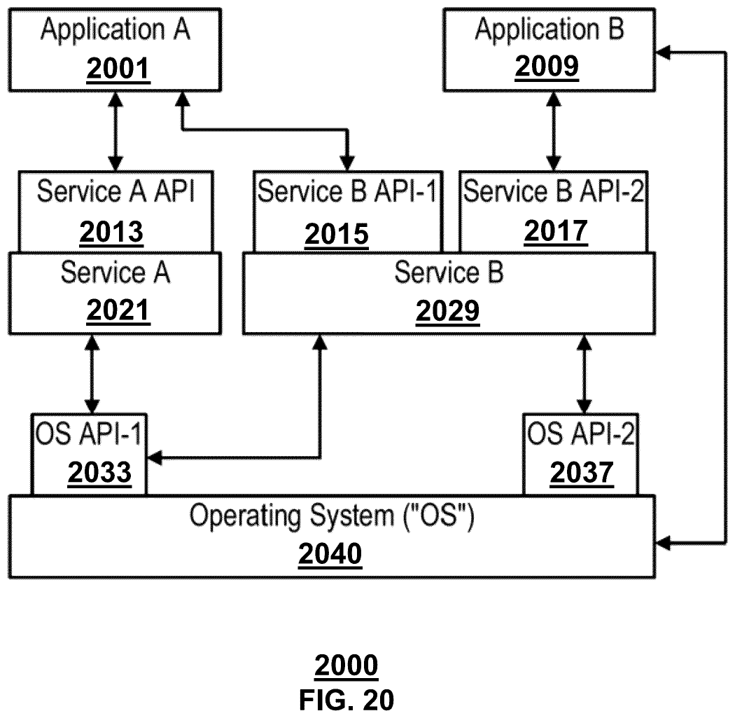

FIG. 20 is a block diagram illustrating an exemplary software stack 2000, which may be used in some embodiments. As shown in FIG. 20, Application A 2001 and Application B 2009 can make calls to Service A 2021 or Service B 2029 using several Service APIs (e.g., Service APIs 2013, 2015, and 2017) and to Operating System (“OS”) 2040 using several OS APIs (e.g., OS APIs 2033 and 2037). Service A 2021 and Service B 2029 can make calls to OS 2040 using several OS APIs (e.g., OS APIs 2033 and 2037).

For example, as shown in FIG. 20, Service B 2029 may include two APIs, one of which (i.e., Service B API-1 2015) may receive calls from and return values to Application A 2001 and the other of which (i.e., Service B API-2 2017) may receive calls from and return values to Application B 2009. Service A 2021, which can be, for example, a software library, may make calls to and receive returned values from OS API-1 2033, and Service B 2029, which can be, for example, a software library, may make calls to and receive returned values from both OS API-1 2033 and OS API-2 2037. Application B 2009 may make calls to and receive returned values from OS API-2 2037.

In some embodiments, a data processing system may be provided to include a processor to execute instructions, and a memory coupled with the processor to store instructions that, when executed by the processor, may cause the processor to perform operations to generate an API that may allow an API-calling component to perform at least some of the operations of one or more of the processes described with respect to one or more of FIGS. 1-18 and 21-44. In some other embodiments, a data processing system may be provided to include a memory to store program code, and a processor to execute the program code to generate an API that may include one or more modules for performing at least some of the operations of one or more of the processes described with respect to one or more of FIGS. 1-18 and 21-44. In yet some other embodiments, a machine-readable storage medium may be provided that provides instructions that, when executed by a processor, cause the processor to generate an API that allows an API-implementing component to perform at least some of the operations of one or more of the processes described with respect to one or more of FIGS. 1-18 and 21-44. In yet some other embodiments, a data processing system may be provided to include an API-implementing component, and an API to interface the API-implementing component with an API-calling component, wherein the API may include one or more modules or means for performing at least some of the operations of one or more of the processes described with respect to one or more of FIGS. 1-18 and 21-44. In yet some other embodiments, a data processing system may be provided to include a processor to execute instructions, and a memory coupled with the processor to store instructions that, when executed by the processor, cause the processor to perform operations to generate an API-implementing component that implements an API, wherein the API exposes one or more functions to an API-calling component, and wherein the API may include one or more functions to perform at least some of the operations of one or more of the processes described with respect to one or more of FIGS. 1-18 and 21-44. In yet some other embodiments, a data processing system may be provided to include a processor to execute instructions, and a memory coupled with the processor to store instructions that, when executed by the processor, cause the processor to interface a component of the data processing system with an API-calling component and to perform at least some of the operations of one or more of the processes described with respect to one or more of FIGS. 1-18 and 21-44. In yet some other embodiments, an apparatus may be provided to include a machine-readable storage medium that provides instructions that, when executed by a machine, cause the machine to allow an API-calling component to perform at least some of the operations of one or more of the processes described with respect to one or more of FIGS. 1-18 and 21-44.

An API endpoint may be a URL that may be configured to act as the point of contact between an API client (e.g., an API-calling component) and an API server (e.g., an API-implementing component). API clients may send requests to API endpoints in order to access the API's functionality and data. An API may have many endpoints that may correspond to its available resources. Requests to API endpoints may include a method or use, which indicates the operation(s) to be performed, as well as any necessary headers, parameters, authentication credentials, and body data. API endpoints may connect API clients and servers and may handle the transfer of data therebetween.

Network slicing may be a key component of various network architectures (e.g., the 5G network architecture) that may enable support for the diverse needs modem network applications may have of network services. A possible solution for implementing network slices, which may be referred to as Segment Routing, has various shortcomings including, for example, the use of a limited abstraction (“colors”) for Traffic Engineering requirements, and the use of least cost path(s) for each color. A solution of this disclosure may use a Boolean algebra and partially ordered metrics to pre-compute a set of paths that satisfies the full range of performance and TE policies available in the network. This approach, in effect, may compute a dominant set of paths (e.g., those where no other path may have better performance) for each truth assignment to the Boolean expressions. New flows may be routed over the least-congested path that satisfies the flow's requirements. This approach may be referred to as Dominant Network Slices. This approach may ensure optimal quality-of-service and policy compliance for network traffic, provide an intuitive model for network configuration, and/or support a programmatic interface for network control (e.g., remote control). Herein, this approach may be reviewed, examples of the approach are given that may illustrate its power, and results of evaluation of functionality and performance of a prototype implementation are presented.

Data communication has been a part of cellular networks since the General Packet Radio Service (“GPRS”) was introduced to the 2G standard in 2000 (see, e.g., S. F. Hassan, A. Orel, and K. Islam, A Network Architect's Guide to 5G, M. Taub, N. Davis, S. Schroeder, S. Schroeder, and B. Reed, Eds. Addison-Wesley Professional, June 2022). The 3G architecture introduced a progression of enhancements to the radio access network (“RAN”) that significantly improved data rates, resulting in a dramatic increase in the subscriber base from 788 million in 2000 to 4 billion in 2008. 4G continued evolution of the RAN, called Long Term Evolution (“LTE”) and, under the title Enhanced Packet Core (“EPC”), re-worked the mobile core architecture to be fully IP based (e.g., circuit-switching was removed from the architecture). The EPC functions were rearchitected to support higher data rates to meet the growing demand for data, improve user experience with more granular support for quality of service (“QoS”), reduce the complexity of the architecture to lower capital and operational costs, and enable smooth transition to the new architecture.

At the dawn of the 5G era, there are a projected 13 billion mobile users worldwide, and the universal adoption of smartphones has fueled continuing demand for higher data speeds, increased coverage, and improved reliability. In a relatively short time, the dramatic success of cellular services and smartphones has transformed mobile data services from a luxury to a necessity.

In addition to increased coverage and bandwidth, new demands are being made of modem mobile communication networks. A new class of real time services has evolved that range from online gaming, with end-to-end latency requirements in the 30-50 millisecond (“ms”) range, to ultra-low latency applications, such as industrial robotics, remote medical procedures, haptic feedback, drone communications, and self-driving vehicle coordination, with requirements (e.g., often in terms of life-safety) of less than 1 ms. Lastly, a new universe of network devices has emerged in the form of embedded sensors and mobile transceivers in everyday devices that communicate over the network, called the Internet of Things (“IoT”). Examples of IoT applications include, but are not limited to, connected homes, health monitoring, supply chain management, vehicular communications, environmental monitoring, and surveillance deployed in consumer, industrial, public works, and military environments.

Network slices are a key enabling technology of the 5G architecture to address many dimensions of these new requirements. A network slice may define a logically partitioned network that may provide dedicated services and network characteristics that might be required by a network application. Similar to a virtual private network (“VPN”) that may provide logical traffic and service separation among applications in a network, a network slice may also offer exclusive use of network resources to ensure the needed characteristics, such as high bandwidth, lower delay, enhanced security (e.g., encryption), and/or the like.

As a part of the 5G architecture, three usage scenarios may be initial targets for network slices (see, e.g., M. Series, “IMT Vision-Framework and overall objectives of the future development of IMT for 2020 and beyond,” Recommendation ITU, vol. 2083, no. 0, 2015). Enhanced Mobile Broadband (“eMBB”) is an evolution of 4G service. Specific goals (e.g., expressed in terms of a “high”, “medium”, and “low” scale) may include, but are not limited to, high data rate, traffic capacity, mobility (e.g., trains, planes, and automobiles), and power efficiency; and medium performance in terms of latency, reliability, and density. Ultra-Reliable and Low-Latency Communication (“URLLC”) may be targeted at real-time use cases, such as industrial robotics, remote medical procedures, haptic feedback, transportation safety, and drone communication. Specific goals may be high performance in terms of mobility and latency, and low data rate, density, and efficiency. Massive Machine-Type Communication (“mMTC”) may be targeted at large deployments of Internet of Things (“IoT”) devices. Performance goals may be high density, medium power efficiency, and low data rate and mobility.

Network slicing, being a new abstraction for networks, may pose real implementation challenges for certain networking technology. Implementing network slices may involve a combination of network technologies including Segment Routing, BGL-LS, and path computation element (“PCE”) controllers (see, e.g., S. F. Hassan, A. Orel, and K. Islam, A Network Architect's Guide to 5G, M. Taub, N. Davis, S. Schroeder, S. Schroeder, and B. Reed, Eds. Addison-Wesley Professional, June 2022). Certain possible requirements to be supported of network slicing can be grouped into two general classes. Quality of Service (“QoS”) requirements may specify the network performance requirements of a network application in terms of bandwidth, latency, reliability, and/or the like, while Traffic Engineering (“TE”) requirements may specify non-performance related characteristics of network links, such as security (e.g., encryption), jurisdictional issues (e.g., restricting private health information to networks within the jurisdiction of a given country), network maintenance status, and/or the like.

Segment routing support for network slices may be based on a Constrained Shortest-Path First (“CSPF”) routing algorithm. For QoS requirements, CSPF may compute a single path or multiple equal cost paths that may minimize a specified, additive metric (e.g., based on delay, hop count, bandwidth, and/or the like). For TE requirements, CSPF may assign “colors” to links and interfaces in the network. The set of colors may be represented, for example, by a 32 bit color bitmap. Each color may represent some attribute of a link (e.g., encryption, jurisdiction, maintenance status, and/or the like). Given a set of constraints (e.g., expressed in terms of link colors to be included and excluded), an SPF routing algorithm may be run on the subset of the topology that may satisfy the constraints using the specified QoS metric. Given the result of this computation, Segment Routing may compute and instantiate a single path or a set of equal cost paths from a given source to each destination for each color that may satisfy its constraints.

CSPF may be limited in two ways. Limiting QoS support to one or many shortest paths in the network may be painfully restrictive. For example, requirements for certain video streaming (e.g., high bandwidth and high delay) and network-based telephony (e.g., low bandwidth and low delay) may be or might almost be in conflict (e.g., a high bandwidth, low delay path may satisfy both, but at a premium price when their individual needs are not that demanding). Similarly, color-based abstraction for certain TE requirements of a network may be limiting. The number of attributes used for defining a policy may be limited to the 32 bits in the color bitmap. The attributes available for defining policies may be all related to properties of links and interfaces on a path. Policies may be statically defined as a part of the network configuration.

A new dominant network slice routing (“DNSR”) architecture may be provided based on partially ordered metrics and a Boolean algebra with Boolean variables representing policy-relevant features of the network and its environment. Using Boolean expressions from this algebra, a network administrator may be enabled to define traffic classes supported in the network and specify the QoS and TE requirements of these classes. Using these constraints, DNSR, in effect, may compute a dominant set of paths (e.g., being those paths where no other path has better performance) for each truth assignment to the variables used in the expressions. New flows may be routed over the least-congested path in this set that may satisfy the flow's requirements.

To validate this architecture, a prototype system product has been developed that implements policy-based (e.g., Layer 2) switching in an SDN-based environment using the OpenFlow protocol, the Ryu opensource controller, and Linux-based Open vSwitch software switches. The prototype may include a web interface that may be configured to allow users to define the supported traffic classes for a network and any TE and QoS requirements for these classes.

The test lab evaluation involved two phases. The first phase evaluated the functionality in three different scenarios illustrating support for QoS, Zero Trust Networking (e.g., in terms of a traditional three tier web application architecture), and network segmentation of a campus network with policies regarding public, application, and security traffic classes. Functionality of the system was verified to forward traffic over paths that met the QoS and TE requirements specified for the traffic.

The second phase involved performance testing in a 4×4 torus topology. TCP and UDP traffic was transmitted between random pairs of nodes in the network, and comparison was made between DNSR (e.g., a Curated Network (“CN”)) and a standard network configuration based on the Rapid Spanning Tree Protocol (“RSTP”). For TCP traffic, the results were that DNSR delivered up to 110% greater throughput than RSTP at 6 times the offered load; similarly for UDP, DNSR delivered roughly equivalent goodput (e.g., good and throughput for application-level throughput of the communication (e.g., the number of useful information bits delivered by the network to a certain destination per unit of time)) with close to no packet loss at up to 6 times the offered load, which was generally compatible with published simulation results (see, e.g., B. R. Smith and L. Thurlow, “Practical multipath load balancing with QoS,” in Proceedings International Conference on Computing, Networking and Communications, December 2013, pp. 937-943).

In certain work (see, e.g., B. R. Smith and L. Thurlow, “Practical multipath load balancing with QoS,” in Proceedings International Conference on Computing, Networking and Communications, December 2013, pp. 937-943; B. R. Smith, “Efficient Policy-Based routing in the internet,” Ph.D. dissertation, University of California, Santa Cruz, August 2003; B. R. Smith and J. J. Garcia-Luna-Aceves, “Best-Effort Quality-of-Service,” in 2008 Proceedings of 17th International Conference on Computer Communications and Networks, August 2008; and B. R. Smith and J. T. Samson, “Herding packets: Properties needed of metrics for loop-free & best forwarding paths,” in 2017 International Conference on Computing, Networking and Communications (ICNC), January 2017, pp. 408-414), a model of routing based on partially ordered metrics and Boolean TE requirements may enhance Internet routing from the use of a single best path to every destination to a best set of paths that may provide the full range of performance and policy available in the network. This model may make more efficient use of network resources, may better meet the needs of network applications, users, and administrators, and/or may provide a more robust default deny security model.

Partially ordered metrics may be used to support the diverse performance requirements of modern network applications. A partial ordering (S,≥) may be a set, S, with a relation ≥ that is reflexive (a≥a), transitive (a≥b, b≥c⇒a≥c), and antisymmetric (a≥b, b≥a⇒a=b). In general, such an ordering may be partial in the sense that not all pairs of elements in S may be related (∃x, y∈S: x [symbol] y, x [symbol] y); (S,≥) is called a poset. The relation x≥y is also described as x dominates y, and the dominating subset of S is the set of elements that are not dominated by any other elements in S.

This poset may be restricted to be a bounded lattice. Informally, a poset may be a lattice iff every pair of elements in Shas both a shared ancestor and a shared descendent, and may be bounded iff it has both a minimum and a maximum element, denoted by 0̅ and 1̅, respectively.

To help visualize lattices, Hasse diagrams may be used. The rules for drawing a Hasse diagram of a lattice may be if x≥y is in the poset, then the point of y in the diagram appears below the point for x (e.g., so lesser, or worse, values are lower in the diagram), and a line may be drawn between y and x if there is no z such that x≥z≥y.

Restricting the metrics poset to be a bounded lattice may reflect the need in routing of both an ∞ and a 0 metric (e.g., corresponding, confusingly enough, to the minimum and maximum lattice elements, respectively). Also note that the ≥ relation may be backwards from the comparison relation used for routing (≤). In lattices, the maximum element may dominate all other values in the lattice. In a lattice for a routing metric, where the shortest path is best, the maximum element is the zero element of the routing metric algebra, and 0≥x for any path weight x.

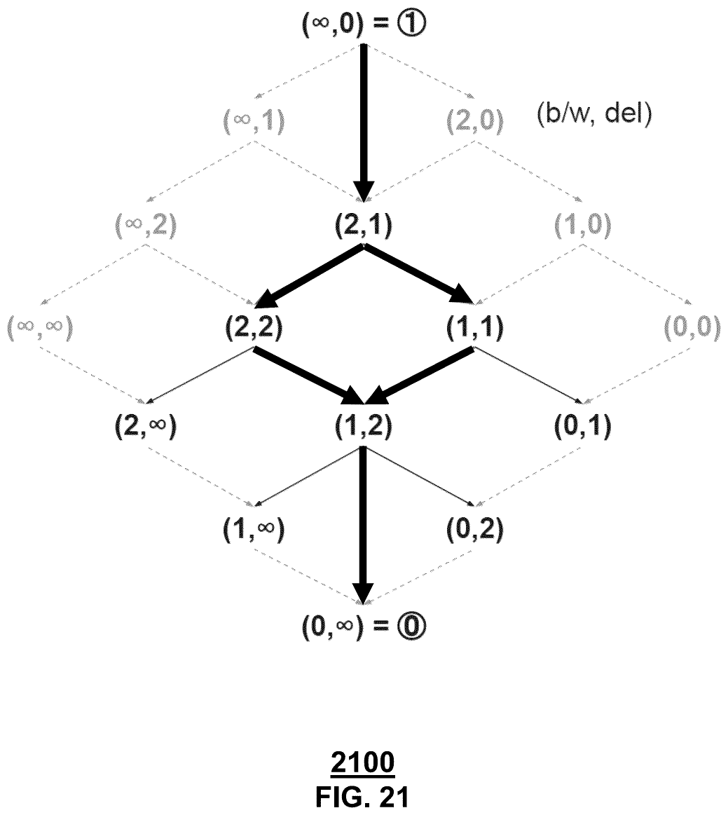

FIG. 21 illustrates the use of a Hasse diagram 2100 for a metrics poset with the example of a partially ordered version of the totally-ordered Shortest-Widest path algebra (e.g., as may be discussed in B. R. Smith and J. T. Samson, “Herding packets: Properties needed of metrics for loop-free & best forwarding paths,” in 2017 International Conference on Computing, Networking and Communications (ICNC), January 2017, pp. 408-414), which may be called Shortest-and-Widest (e.g., a Hasse diagram of shortest-and-widest constraints). Weights in Shortest-and-Widest may be of the form (bandwidth, delay), and (b₁, d₁)≥(b₂, d₂) may be defined as (b₁≥b₂) and (d₁≤d₂), (b₁, d₁)+(b₂, d₂) may be defined as (Min(b₁, b₂), d₁+d₂), 0̅ (i.e., no connectivity) may be denoted by (0,∞), and 1̅ (i.e., self, or perfect) connectivity may be denoted by (∞, 0). Link and path weights are combined using the + operator, resulting in values that are lower in the Hasse diagram.

The thick-connected subgraph of diagram 2100 may be the Hasse diagram for Shortest-and-Widest where the bandwidth and delay values range over the set of values {0, 1, 2, √}. Note that the partial ordered nature of this definition of Shortest-and-Widest may be evident here in that (1, 1) and (2, 2) are not comparable (e.g., (1, 1) has better delay, but (2, 2) has better bandwidth).

FIG. 21 also illustrates an implementation issue with metric partial orders. Specifically, the thin or broken line-connected subset of the lattice may be composed of weights that are false values in the sense that they have (e.g., exactly) one component with value 0 or ∞. These values do not reflect real world paths (e.g., any value with delay of ∞ or bandwidth of 0 is a synonym for (0, ∞), and any value with the reverse, bandwidth of ∞ or delay of 0, is a variant of (∞, 0), but is not really a valid weight). The solution for these false values may be to identify the ones that can result from the summing of valid weights, and have the path algebra implementation translate those values to 0̅ or 1̅, whichever is appropriate. In diagram 2100, this may mean translating (2, ∞), (1, ∞), (0, 1), and (0, 2) to (0, ∞) (i.e., 0̅).

Routing algorithms may implement an efficient search through the paths in a network to find the best paths to all destinations in the network, where “best” may be defined based on the class of routing algorithm. Paths may be typically discovered one hop at a time, starting at the source or destination (e.g., depending on the algorithm) by adding the weights assigned to each link. For partially ordered metrics, the value of these weights may start with the best (e.g., maximum) value (e.g., representing the weight of a self-loop for the starting node) at the top of the Hasse diagrams, such as that in FIG. 21, and progress down the Hasse diagram as the path is built.

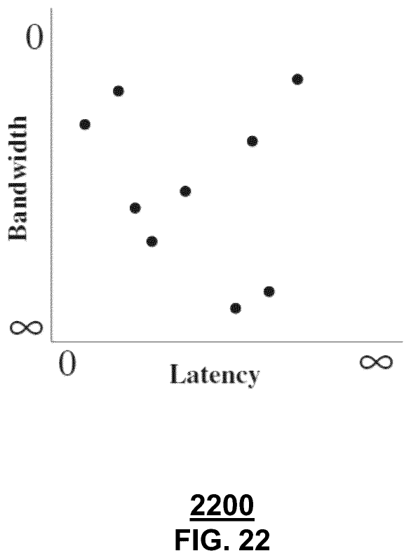

Shortest path routing algorithms may compute routing tables with a single path to each destination. For algorithms that implement routing with partially ordered metrics, best may be defined as the dominant set of routes to each destination, as described herein, and routing tables may contain a non-dominated set of paths for each destination. To illustrate this, FIG. 22 illustrates a graph 2200 that plots the weights of 9 paths between a specific source and destination in an example network where the metrics are composed of bottleneck bandwidth and latency. “Better” values of these metrics are towards the origin of the graph (e.g., a perfect path would have infinite bandwidth and 0 latency).

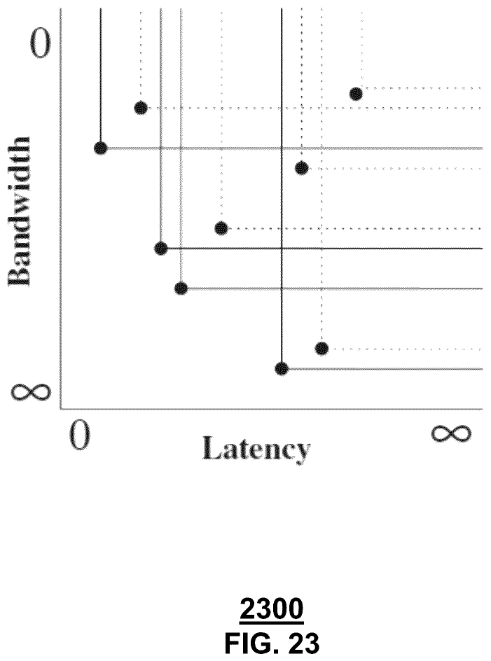

These points can be interpreted as representing a region, up and to the right (e.g., away from the origin) of QoS values that each weight satisfies in the sense that the path represented by the weight would satisfy any QoS requirement in that region of the graph. FIG. 23 illustrates a graph 2300 that depicts the regions satisfied by each path. Note that regions satisfied by some of the paths are fully contained in the regions of other paths. In FIG. 23, these dominated regions are represented with dashed lines.

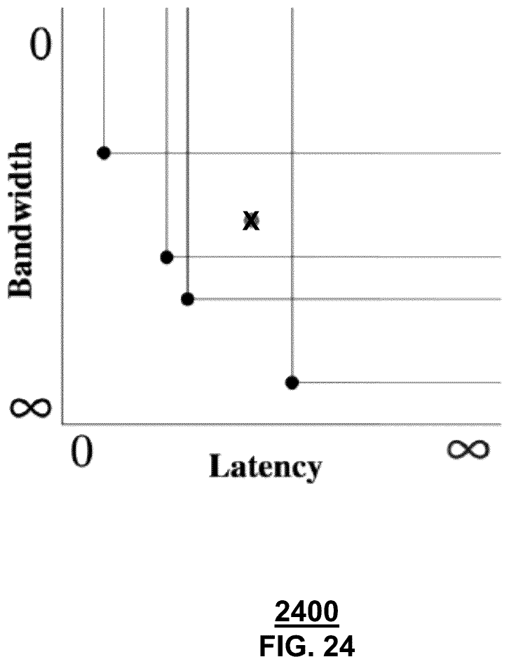

A best set of paths to the destination can be identified as the set of paths that are not dominated by another path. This set of paths may be best in the sense that any QoS requirement that is satisfiable by an existing path between the given source and destination is satisfiable by a path in this set. FIG. 24 illustrates a graph 2400 that shows the dominant paths for the example network, and how a given flow constraint (e.g., the X dot) can be satisfied by more than one performance class (e.g., the middle two performance classes).

For routing algorithms subject to both TE and QoS requirements, best may be defined as the set of non-dominated paths for each truth assignment of the Boolean variables resulting in routing tables containing a set of paths where the path expression for each path has satisfying truth assignments not satisfied by any other path in the set with a dominating metric.

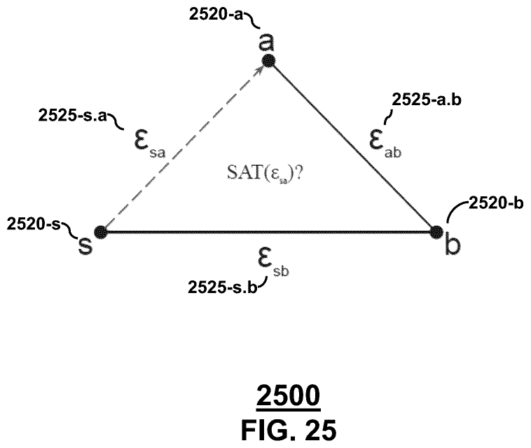

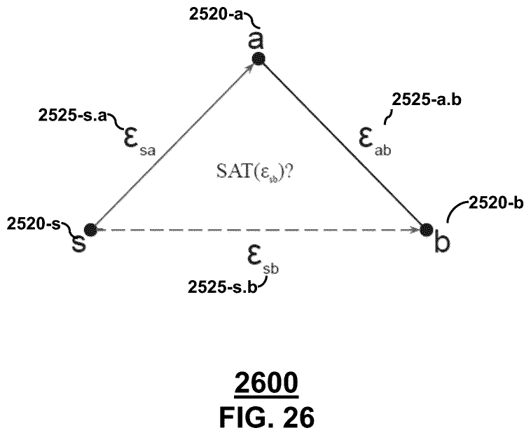

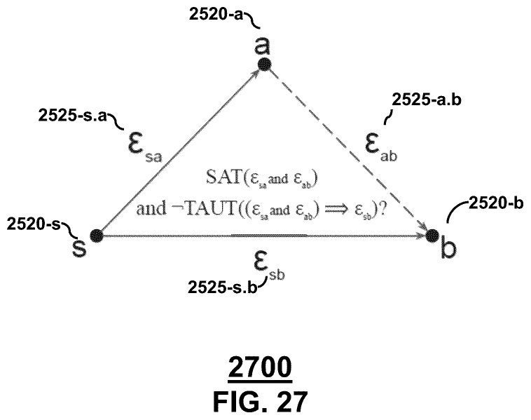

FIGS. 25-27 illustrate the process of building a path one hop at a time in the context of TE requirements. Each link in the network may be labeled with a Boolean expression, e, expressing the TE requirements for traffic allowed on that link. FIG. 25 shows a routing computation 2500 starting at node s (i.e., node 2520-s). The computation first considers (e.g., as may be indicated by the dashed line) the single-hop path from s to a (i.e., from node 2520-s to node 2520-a via link 2525-s.a). To use this path, the path expression εₛₐ must have some satisfying truth assignments, expressed by SAT(εₛₐ), indicating truth assignments for traffic classes allowed on the link. Assuming the test is successful, FIG. 26 shows a computation 2600 where path s-a (i.e., the path from node 2520-s to node 2520-a via link 2525-s.a) may be added to the routing table and the computation may consider the next shortest path in the network, s-b, with path expression es (i.e., the path from node 2520-s to node 2520-b via link 2525-s.b). The same satisfiability test may be used to add path s-b to the routing table, leading to the situation in computation 2700 of FIG. 27, where path s-a-b may be considered (e.g., which may include the path from node 2520-a to node 2520-b via link 2525-a.b).

This situation may differ from previous iterations in that a multihop path may now be considered, and a path has already been discovered for the destination b of the new path, thereby utilizing a more complicated test to confirm that there are new satisfying truth assignments covered by the new path expression εsab to justify adding this longer path to the routing table. FIG. 27 shows how multihop paths may be constructed by and'ing together the link constraints of each hop in the path; so the path expression for s-a-b is εₛₐ and Cab. As previously, the SAT( . . . ) test may confirm there are satisfying truth assignments for εₛₐ and ε_{ab}, and the additional test for tautology (e.g., TAUT( . . . ), indicating all truth assignments are satisfied) may be used to determine if there are any truth assignments that satisfy εₛₐ and ε_{ab} that are not satisfied by ε_{sb}. If so, path s-a-b may be added to the routing table for use by flows that satisfy those newly discovered truth assignments.

The DNSR routing model presented above may enable sophisticated control of network resources. A number of scenarios may be presented to illustrate its capabilities. Each scenario may be defined by the following requirements-related information, including, but not limited to, (1) a set of Boolean variables that may represent policy-relevant attributes of flows and the network environment for use in defining the QoS and TE requirements of the network; (2) link requirements including QoS metrics of each link, and a Boolean expression defining TE requirements for the link; (3) QoS flow requirements specifying a range of path metric values desired for a class of flows, where a flow class may be defined by TE requirements specified using Boolean expressions; (4) TE network requirements, which may be specified by Boolean expressions, that may be used in the routing function, and (e.g., with path and flow requirements) in admission control of new flows into the network; and (5) path requirements that may be computed by the routing function using link and network requirements, resulting in a set of QoS path metrics, and a Boolean path expression defining the TE requirements of the path.

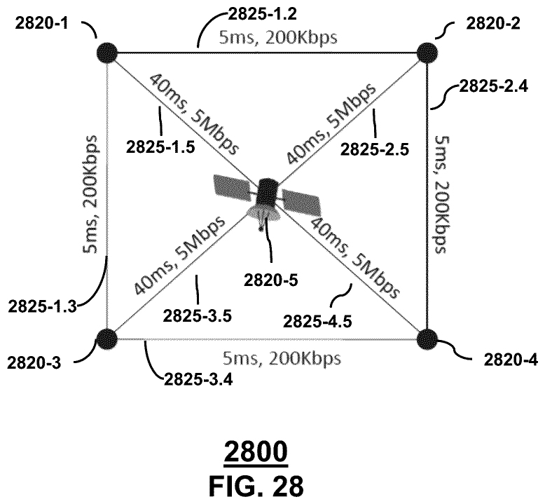

FIG. 28 illustrates at least a portion of a network 2800 that may be configured for support of QoS requirements (e.g., a QoS scenario). As shown, network 2800 may include any suitable number of nodes or router devices 2820, such as node 2820-1, node 2820-2, node 2820-3, node 2820-4, and node 2820-5. Different nodes may be communicatively coupled to one another (e.g., using communication components of the nodes) over different communication links 2825, which may differ in any suitable manner, such as by delay and/or bandwidth, whereby links 2825 may include a first type of link with 40 ms delay and 5 Mbps bandwidth (e.g., link 2825-1.5 between nodes 2820-1 and 2820-5, link 2825-2.5 between nodes 2820-2 and 2820-5, link 2825-3.5 between nodes 2820-3 and 2820-5, and link 2825-4.5 between nodes 2820-4 and 2820-5), a second type of link with 5 ms delay and 200 Kbps bandwidth (e.g., link 2825-1.3 between nodes 2820-1 and 2820-3, link 2825-3.4 between nodes 2820-3 and 2820-4, link 2825-1.2 between nodes 2820-1 and 2820-2, and link 2825-2.4 between nodes 2820-2 and 2820-4), and/or any other suitable type(s) of link(s) with any other suitable delay and/or any other suitable bandwidth. Therefore, network 2800 may include five nodes 2820, where four peripheral nodes 2820-1, 2820-2, 2820-3, and 2820-4 may be coupled by low delay and low bandwidth links, and each of them may be coupled to a central node 2820-5 by high delay and high bandwidth links. This can be thought of as four terrestrial nodes coupled by low bandwidth terrestrial links, and one satellite node with high delay satellite links from each terrestrial node. This network may be used for Voice-over-IP (e.g., internet telephone) traffic requiring low delay (e.g., for comfortable interactive conversation) for low bandwidth voice communication, and video streaming traffic, which may be delay tolerant, but may require relatively high bandwidth. To support these requirements, Boolean variables may be defined for classifying flows (e.g., VoIP and VidStreaming), and path QoS requirements may be specified for the flow (e.g., Delay and B/W) for both VoIP and VidStream traffic. As the applications requirements of the network may be fully expressed by the QoS requirements, there may be no network TE requirements, and the traffic may be forwarded over paths that may satisfy each flow's QoS requirements (e.g., while minimizing congestion).

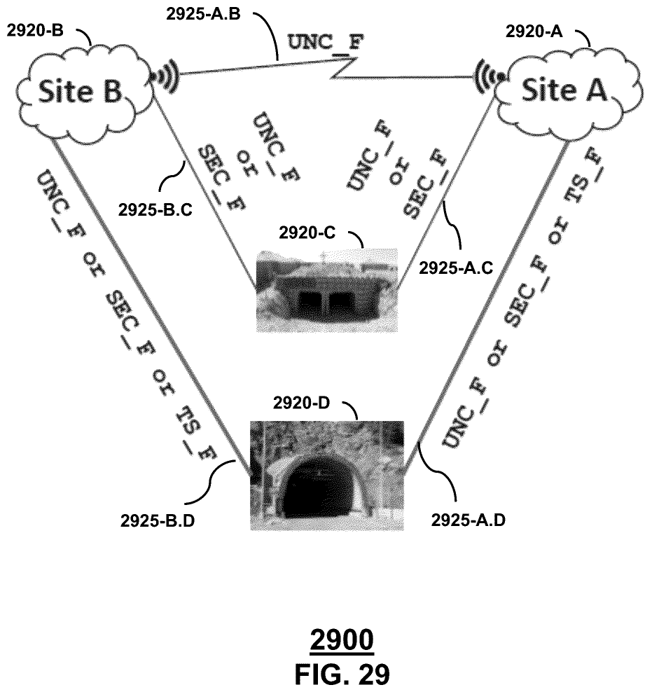

FIG. 29 illustrates at least a portion of a network 2900 that may be configured to provide support for multi-tenant use of networks in the form of the traditional, military-style multilevel security (MLS) model using TE requirements (e.g., an MLS scenario). In this scenario, traffic may be classified at unsecured, secret, or top secret security levels and may be routed over infrastructure that may be certified at the traffic's level or above. The Boolean variables UNC_F, SEC_F, and TS_F may be defined for a flow's security level (e.g., unclassified, secret, and top secret). An unspecified mechanism may be configured to determine the security level for a new flow (e.g., any data point or any suitable combination of data points (e.g., a calculation of the value of a weighted average of the current value of various data points (e.g., user role, content class, etc.) with respect to a threshold value) may be used to define a security level at a moment in time), and the flow may be assigned to the least congested path that may satisfy the MLS routing requirement (e.g., unclassified traffic can be forwarded over paths of any security level, but top secret traffic can only traverse strongly secured paths) as may be specified by the TE Boolean expressions assigned to each link. For example, as shown, network 2900 may include any suitable number of nodes or router devices 2920, such as node 2920-A, node 2920-B, node 2920-C, and node 2920-D. Different nodes may be communicatively coupled to one another (e.g., using communication components of the nodes) over different communication links 2925, which may differ in any suitable manner, such as by TE Boolean expression, whereby links 2925 may include a first type of link with TE Boolean expression “UNC_F” (e.g., link 2925-A.B between nodes 2920-A and 2920-B), a second type of link with TE Boolean expression “UNC_F or SEC_F” (e.g., link 2925-B.C between nodes 2920-B and 2920-C, and link 2925-A.C between nodes 2920-A and 2920-C), a third type of link with TE Boolean expression “UNC_F or SEC_F or TS_F” (e.g., link 2925-B.D between nodes 2920-B and 2920-D, and link 2925-A.D between nodes 2920-A and 2920-D), and/or any other suitable type(s) of link(s) with any other suitable TE Boolean expression(s).

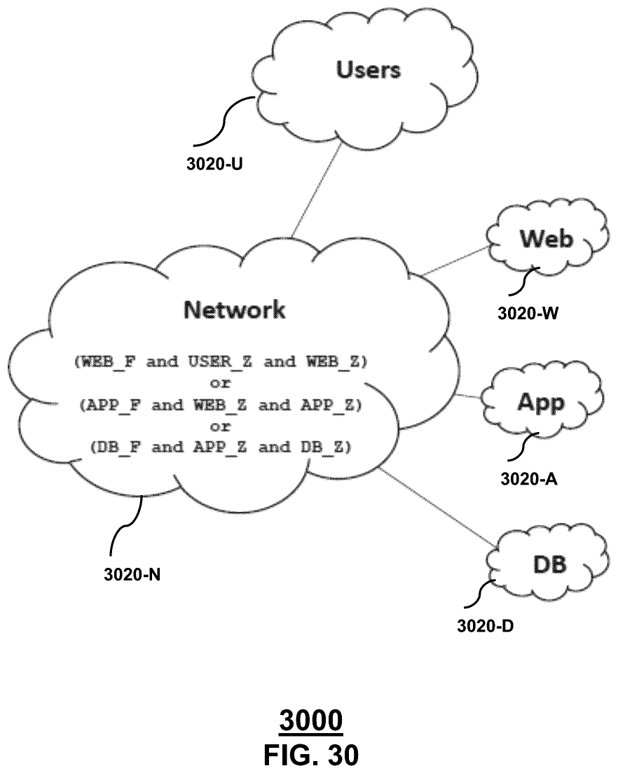

FIG. 30 illustrates a system 3000 that may be configured to provide support for Zero Trust security applied to a three layer web application architecture that may be using TE requirements (e.g., a Zero Trust Networking scenario). In this architecture, applications may be organized into three logical tiers: web (e.g., web tier 3020-W), application (e.g., application tier 3020-A), and data (e.g., data tier 3020-D). Web (or presentation) tier 3020-W may be a user interface to the application (e.g., for any suitable user(s) 3020-U of system 3000) and may be responsible for collecting data from the user and displaying data from the application to the user. Application (or logic) tier 3020-A may be where data collected from the user is processed, sometimes using information from the data tier, and results may be presented to the user or saved in the data tier. The database tier 3020-D may be where information produced by the application is stored and managed. The benefits of this architecture may include faster development, and/or improved scalability, reliability, and/or security. For security purposes, firewalls may be commonly deployed between tiers.

FIG. 30 illustrates a three tier architecture implemented on a single subnet using TE requirements. Boolean variables may be defined for network zones (e.g., USER_Z, WEB_Z, and DB_Z) and flow types (e.g., WEB_F, APP_F, DB_F) of network 3020-N of system 3000. The zone variables may be set based on the IP prefix of servers in each zone, and some application detection technology may be used for setting the flow variables. In some embodiments, the links may have no TE requirements, but a network-wide TE requirement may be specified limiting traffic between zones to the appropriate classes of flows (e.g., WEB_F is only allowed between the USER_Z and WEB_Z zones, etc.). Note that, with this solution, the integrity of the three tier architecture may not depend on the location of servers. Servers from different tiers may be connected to the same layer 2 switch and the integrity of the tiers may still be maintained.

The three previous scenarios may represent static TE requirements in the sense that how a Boolean variable is set may be specified as part of configuring TE requirements for the network. So zones in the Zero Trust scenario may be defined by an IP prefix, and/or the like. The following two scenarios may illustrate an important capability of Boolean expression-based configurations to dynamically define the value of variables based on attributes of the network's state or environment.

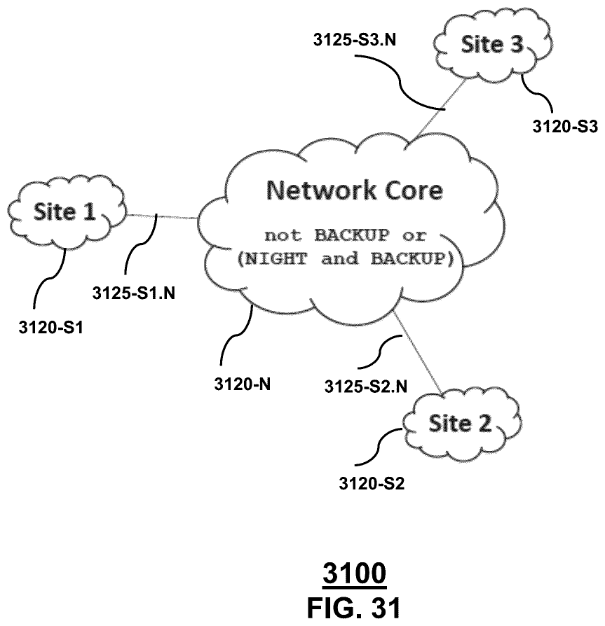

FIG. 31 illustrates a system 3100 of a scenario where backup traffic may only be allowed to flow over a core portion of the network at night (e.g., a Time-of-Day Backup Scenario). For example, during the day, the core portions of an organization's network may be reserved for operational data and backups may only be allowed to traverse peripheral networks (not shown here) or be delayed to run at night. Two Boolean variables may be defined including BACKUP, which may be set to true for flows that carry backup traffic, and NIGHT, which may be set to true when it is currently nighttime. The link expression “(not BACKUP or (NIGHT and BACKUP))” may be defined for all core network links specifying that BACKUP traffic can only traverse core links at night (e.g., link 3125-S1.N between nodes 3120-S1 and 3120-N).

The Boolean variable NIGHT may be a dynamic variable whose value may be determined by the network at the time the flow is processed. While the time period to define as night may be configured statically as part of the network configuration, the value of the variable may be determined dynamically. This capability may introduce a bit of autonomic control into the network configuration and may lead to a more general solution presented next. The primary limitation to the dynamic nature of Boolean variables like NIGHT may be that they support state directly available to the network device implementing the routing function (e.g., a router, switch, or controller). While the state of a Boolean variable like NIGHT may be true when a system clock is between 8 pm and 8 am (e.g., a variable that may be determined by an internal network state), and while the state of another Boolean variable may be determined based on a value of a data packet field or data packet header (e.g., a variable that may be determined by an internal network state (e.g., as the data packet travels through the network)), the state of other Boolean variable types may be specified or at least partially determined or defined or specified by an external source (e.g., a remote source that may be external or otherwise distinct from the network (e.g., a national weather service, a government security service, any suitable internet of things device, etc.)), where the system may be configured to provide any suitable remote source interface that may be utilized for determining the current value or state of specific Boolean variables.

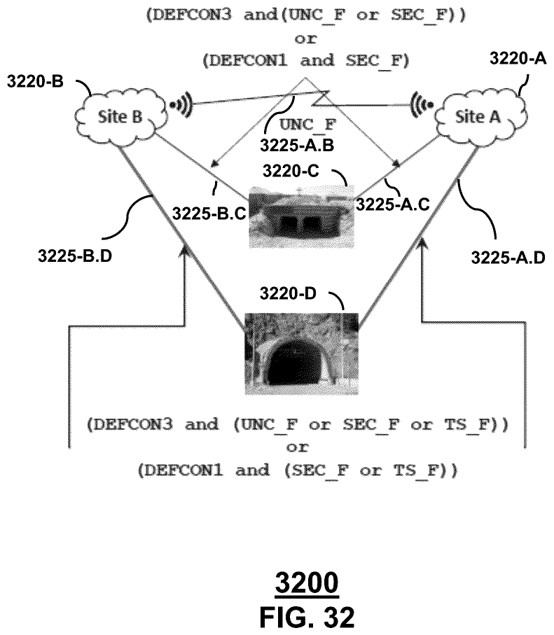

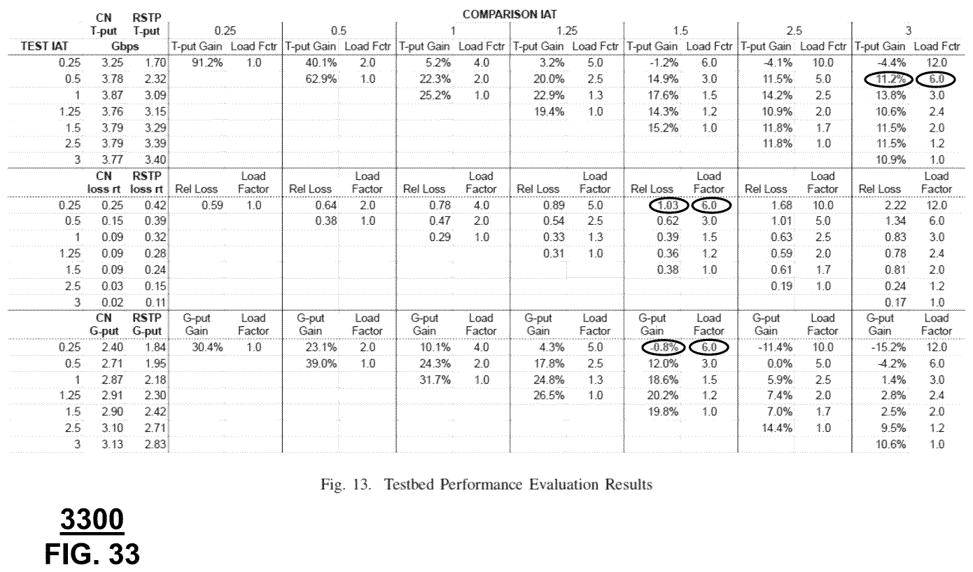

Another example may be system 3200 illustrated in FIG. 32 that may implement functionality that can demonstrate a fully dynamic Boolean variable. System 3200 may be configured to support a DEFCON/MLS scenario (e.g., MLS with DEFCON Threat Levels Scenario) that may build on the MLS scenario (e.g., FIG. 29) by adding Boolean variables (e.g., DEFCON1 and DEFCON3) reflecting the military defense readiness condition (e.g., DEFCON) levels used to characterize the current threat level faced by the US military. For example, as shown, network 3200 may include any suitable number of nodes or router devices 3220, such as node 3220-A, node 3220-B, node 3220-C, and node 3220-D. Different nodes may be communicatively coupled to one another (e.g., using communication components of the nodes) over different communication links 3225, which may differ in any suitable manner, such as by Boolean expression(s), whereby links 3225 may include a first type of link with Boolean expression “UNC_F” (e.g., link 3225-A.B between nodes 3220-A and 3220-B), a second type of link with Boolean expression “(DEFCON3 and (UNC_F or SEC_F)) or (DEFCON1 and SEC_F)” (e.g., link 3225-B.C between nodes 3220-B and 3220-C, and link 3225-A.C between nodes 3220-A and 3220-C), a third type of link with Boolean expression “(DEFCON3 and (UNC_F or SEC_F or TS_F)) or (DEFCON1 and (SEC_F or TS_F))” (e.g., link 3225-B.D between nodes 3220-B and 3220-D, and link 3225-A.D between nodes 3220-A and 3220-D), and/or any other suitable type(s) of link(s) with any other suitable Boolean expression(s). Higher threat levels may be indicated by lower DEFCON numbers (e.g., with DEFCON1 indicating active nuclear war). In this scenario, the MLS link expressions of network 2900 have been modified in network 3200 to integrate DEFCON1 and DEFCON3 threat levels. In the modified expressions, DEFCON3 may enable TE requirements equivalent to the MLS scenario (e.g., flows at a given sensitivity level may be allowed to traverse links at that same level or above), but DEFCON1 may enable TE requirements that drop UNC_F traffic from links rated at SECRET and TOP SECRET levels. The logic being that, in a time of heightened threat, secured network resources should be reserved for important traffic.

The dynamic nature of this scenario may come from the ability to implement programmatic control or remote control of the DEFCON variables. In some embodiments, a platform may be implemented as an SDN controller with a web user interface, with which such programmatic control or remote control may be implemented as a representational state transfer (“REST”) service or any other suitable service for setting the values of Boolean variables, which may support the remote invocation of functions on the Web server using HTTPS messages. Using such programmatic control or remote control mechanisms, Boolean variables can be defined to reflect any state in the network or its environment that has policy significance for the network's configuration. With such variables, the network's configuration can be changed immediately, without the need for reconfiguration of network devices or reprogramming of SDN-based systems.

This capability has profound implications for network management. For example, in some embodiments, a system may be configured such that Boolean variables may be defined to reflect workstation configuration that may be acquired using network access control technology (e.g., operating system version and patch levels) and may be combined with variables that may be defined to represent information from threat feeds reflecting the severity of vulnerabilities discovered in operating system versions and patch levels. TE requirements could be defined that only allowed systems to access sensitive parts of a network if they are at patch levels with no known vulnerabilities, and traffic from vulnerable systems can be routed to sites that facilitate upgrades of vulnerable systems, with new vulnerabilities being configured to be integrated by the system into network behavior as soon as they are discovered.

Network slices built using DNSR may enable new opportunities that have not yet been easily implemented. Cross-layer coordination may be naturally supported. For example, special physical layer network properties, such as jam-resistance and low detectability, may be important for some military applications. With DNSR, these capabilities can be exposed to network-layer routing through the Boolean variable abstraction, and then may be used in defining policies that may require the use of paths with these capabilities for appropriate traffic flows.

Also, as shown with the backup traffic and DEFCON/MLS examples, the Boolean variable abstraction for TE requirements may provide a powerful mechanism for implementing programmatic control or remote control of currently active network policies, enabling autonomic control of network services at time frames far shorter than is possible with humans in the control loop.

A policy-based switching prototype implementation of the architecture has been developed for testing and evaluation and submitted to the CNLABs (see, e.g., CNLABS. [Online]; available: https://cnlabs.in) commercial testing lab for evaluation. In one embodiment, focusing on the performance evaluation, the system was deployed as a 4×4 torus, with two hosts per switch (for a total of 32 hosts), in a VMware-based virtual environment. Each test was configured to involve 10 traffic flows for each host between random nodes in the graph with restrictions on the distribution of hops traversed (e.g., 2 flows traversed 1 hop, 3 flows 2 hops, 4 flows 3 hops, and 1 flow 4 hops). Tests were run for a range of interarrival times between hosts (e.g., 0.25, 0.5, 1, 1.25, 1.5, 2.5, and 3 seconds). TCP performance was characterized by the cumulative throughput of all 320 flows, and UDP by the average loss rate per flow and the cumulative goodput of the flows. The results are presented in table 3300 of FIG. 33. The performance results mentioned herein are circled in table 3300. A developed testbed may be implemented to further explore the dynamics of this architecture (e.g., 20 node clusters configured to assess and test in a virtual machine environment or otherwise).

Partially ordered metrics may be used and TE requirements may be expressed using a Boolean algebra as a powerful abstraction, such as for implementing 5G network slices. Using these abstractions may enhance network routing to compute a best set of routes that may satisfy the full range of QoS metrics and TE requirements supported by a given network environment. As shown by the examples herein, DNSR may provide a number of significant benefits.

Articulating and enforcing the QoS and TE requirements may enhance the Internet's original default-allow security model to default-deny where only requirement-compliant flows may be allowed. Security may be further enhanced by a dramatic reduction in the network's attack surface as it may be limited to network devices whose access may be typically tightly controlled (e.g., compared to the attack surface of all connected devices).

Use of DNSR may optimize the user's experience, ensuring that traffic may be forwarded over paths customized to the application's QoS and TE requirements and may be compliant with network administration's policies. By working with a set of candidate paths, traffic can be forward over the least congested requirement-compliant path, dramatically improving network utilization. Simulations predicted a ten-fold increase with a somewhat “meshy” (e.g., average node degree of four) network topology (see, e.g., B. R. Smith and L. Thurlow, “Practical multipath load balancing with QoS,” in Proceedings International Conference on Computing, Networking and Communications, December 2013, pp. 937-943). These results have been verified by an independent testing lab using an un-tuned prototype implementation.

Network services can be safely reconfigured with programmatic control or remote control of TE Boolean variables as they may not require reconfiguration of network equipment or re-programming or software-defined networking functions. Many functions that may be implemented by expensive devices external to the core network, such as firewalls, load balancers, and zero-trust network equipment (e.g., external devices that may be used for data handling functions), can be replaced by a DNSR software upgrade. Furthermore, implementing these functions using DNSR may result in significantly more robust services as they may be implemented in the network layer where they may have full knowledge of the network's topology.

Importantly for many environments, DNSR may provide a more intuitive, high-level network configuration paradigm based on specifying what the requirements of the network are, and allowing the network to solve the problem of how to enforce the requirements rather than depending on highly trained network engineers. This may enable support of significantly more sophisticated network services by available engineers.

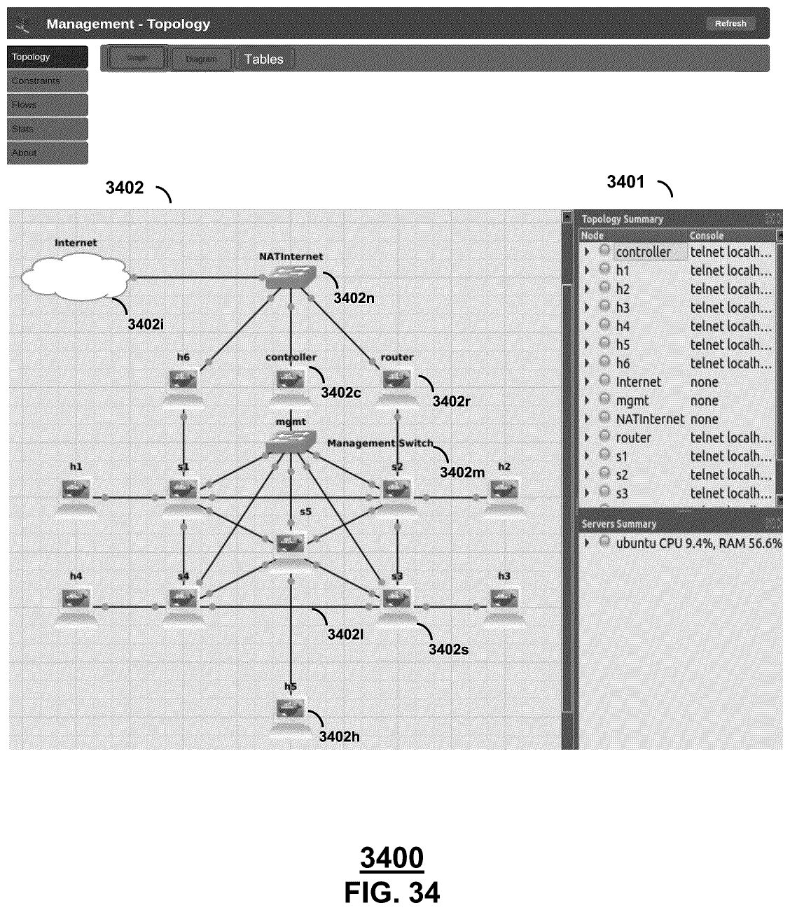

A Networking with Constraints (“NwC”) network configuration and management utility system has been developed, where such a product may be run on any suitable device (e.g., as any suitable application 19 on any suitable device 120) and may be configured to provide any suitable user interface to any suitable user via any suitable user device (e.g., via any suitable I/O component(s) 16 of any suitable device 120). The utility product may implement a model of the NwC system in layer-2, which may allow for fine-grained control of traffic down to the host level. The model may also be implemented in layer-3, which may provide control more at the subnet and VLAN level. In some embodiments, the product may be provided as a prototype that may use Graphical Network Simulator-3 (“GNS3”) as a network simulator. It may include Linux hosts, Open vSwitch devices, a Curated Networks controller and a router using Free Range Routing software, all of which may be implemented in Docker images. For example, GNS3 may be implemented as a client and server pair. The client may implement the GUI for configuring and running GNS3 simulations and the server may implement the simulation. A virtual machine (“VM”) image for the NwC prototype may include both parts (e.g., an Ubuntu Desktop VM). This may enable a full simulation to be run with only the need for the VM software. The prototype may come with a pre-configured GNS3 “project” that may contain a number of hosts and switches, a router and an OpenFlow controller (e.g., which implements the NwC system). It may also include a set of canned scenarios that may give an introduction on how to use the NwC system. For example, when a product project may be launched, the product may be configured to present a VM screen that may include screen 3400 of FIG. 34, which may include a presentation of devices of the project, where the presentation may include all of the nodes in a topology summary 3401 (e.g., on the right side of screen 3400) and all of the handles and nodes of a communication network may be provided in a network topology 3402 in the main window (e.g., on the left side of screen 3400). As shown, an exemplary project may include a five switch topology with one host 3402h per switch 3402s (e.g., switches “s1”-“s5” and hosts “h1”-“h5” (e.g., each s/h combination may be a subnet)), a controller (e.g., “controller”) 3402c running the NwC controller and an additional host 3402h (e.g., host “h6”) that may be accessible from the host Ubuntu VM using, for example, secure shell protocol (“ssh”) h6 (e.g., h6 may be logged into to adjust an openflow subnet, may act like a dual connected host, open web browser, etc.). NATinternet or Network Address Translation (“NAT”) internet 3402n may be any suitable internet switch (e.g., a link layer switch) for coupling the network to Internet 3402i. Management switch (e.g., “mgmt”) 3402m may be any suitable management switch (e.g., a link layer switch) for coupling the controller to at least a portion of the network (e.g., for communication between the controller and switches s1-s5 (e.g., using OpenFlow protocol)). In some embodiments, ssh keys may be configured for all devices (e.g., hosts, switches, and the Ubuntu VM itself) to allow easy movement around the environment. Host h6 may be a host with an extra interface that may be connected to the network of the VMware system and can see internally. This may be a form of a “gateway” node. This node, along with any suitable docker exec commands, may provide a useful way to debug internal connectivity during a topology scenario. The NwC model may be based on an OpenFlow controller (e.g., “controller”) for switches s1-s5, although the NwC model can also be supported in a traditional, distributed routing (e.g., no controller) model as well (e.g., the network may be configured to allow routing computation to be carried out in a distributed fashion at each switch/host subnet, where each subnet may have all appropriate Boolean constraints available to it so there may be no need for a controller for each router to build its own routing table router (e.g., an algorithm of the controller may be broken up into algorithms done individually in each switch/router)). Any suitable link(s) 34021 may be provided for coupling any two or more nodes or otherwise of topology 3402. Controller 3402c of topology 3402 of the NwC system may be similar to controller device 100 of system 1 of FIG. 1, while each one of switches s1-s5 of topology 3402 of the NwC system may be similar to a router device of devices 102-116 of system 1 of FIG. 1 (e.g., remote Boolean variable values may be obtained by the network from internet 3402i via controller 3402c (e.g., via controller device 100 as a type of data 99 from a type of data device 118)). The purpose of the product may be to allow interested parties with network administration experience to experiment with the NwC model. The NwC model may be provided as a production-grade implementation for working in a real-world setting.

The NwC system may be configured to enable a user to rename, add, remove, or otherwise manipulate any suitable switch or host or link or otherwise with respect to a current network topology (e.g., to topology 3402) using any suitable system user interface. For example, beyond just having a new switch connected to the management network may not include it in a running NwC topology. Instead, one or more links from the new switch to one or more existing Open vSwitch devices may be required to add the device and automatically assume all flows are allowed (e.g., to complete the link with the new vSwitch to both the management network (e.g., for communication with the NwC controller(s)) and the MPLS switch environment). Therefore, any switch or host ought to be added to the management network (e.g., GNS3 management network, which may be separate from the NwC host network) and to the MPLS NwC topology.

A fundamental premise of the NwC model is that a limitation of the existing Internet model is that it implements a low level of abstraction that requires a declarative, how to do it approach to configuring a network to meet a user's needs.

Specifically, the current Internet requires a user to specify VLANs/subnets, policy routing, packet queues, queue priorities, and the like. While these abstractions provide a powerful set of primitives for configuring network services, they also require a high level of expertise to implement and maintain. This results in network configurations that are fragile, being easily broken by changes in the network topology. Programmability and virtualization may help to mitigate this problem.

Software defined networking (“SDN”) may enable complex network configurations to be programmed and controlled by policy. These sophisticated configurations can be deployed by less skilled technicians.

Similarly, there has been much progress in the virtualization of network resources over the past few decades. Unfortunately, just like with programmability, virtualization has not changed the fundamental nature of the network as one of the most complicated and fragile layers in the modem technology stack.

A goal of the NwC model is to provide an increase in the level of abstraction, to dramatically increase the robustness of the network, while simultaneously increasing the productivity of engineers.

To accomplish this goal, NwC may implement constraints based on network performance (e.g., delay, bandwidth, reliability) to facilitate policy-based network configuration. Constraints may come in various forms, such as performance constraints and Boolean constraints.

Performance constraints can be defined, for example, for delay and bandwidth based on the protocol (TCP or UDP) and port fields of an IPv4 or IPv6 packet. Performance of a link can be defined in terms of cost (e.g., integer value), bandwidth, and delay. A traffic class may include all traffic with the same attributes (e.g., TCP/UDP, port numbers, Ethernet IPv4/IPv6, OSPF, etc.). A flow may be a stream of packets that belong to a given traffic class. Performance constraints may specify performance requirements of a given traffic class. Traffic that is part of a flow in a specific traffic class may be forwarded along paths that meet the constraints.

Boolean constraints may fall into various categories, such as routing, forwarding, and link constraints. Each set of constraints may be expressed in terms of Boolean variables that may reflect some policy-relevant attribute of the network state or network traffic. Boolean constraints may describe qualitative properties of an object, where relationships between objects may, for example, be generally in terms of membership in some category.

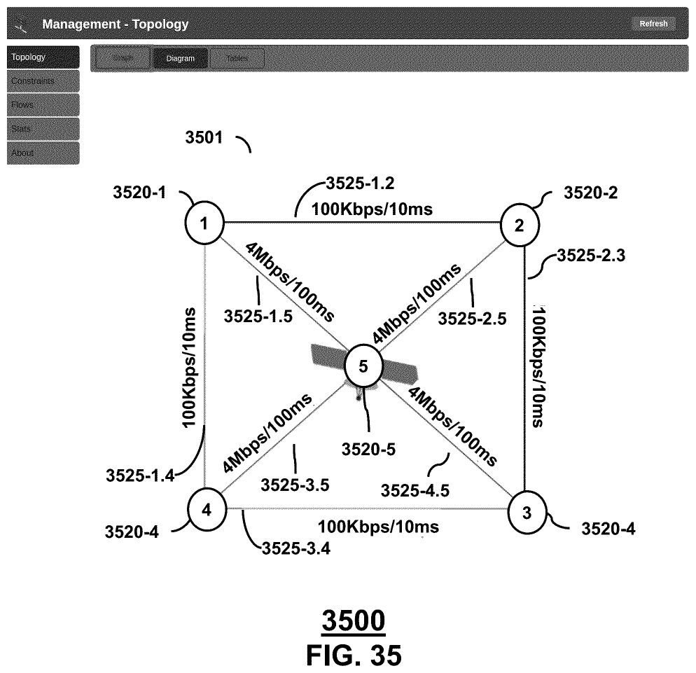

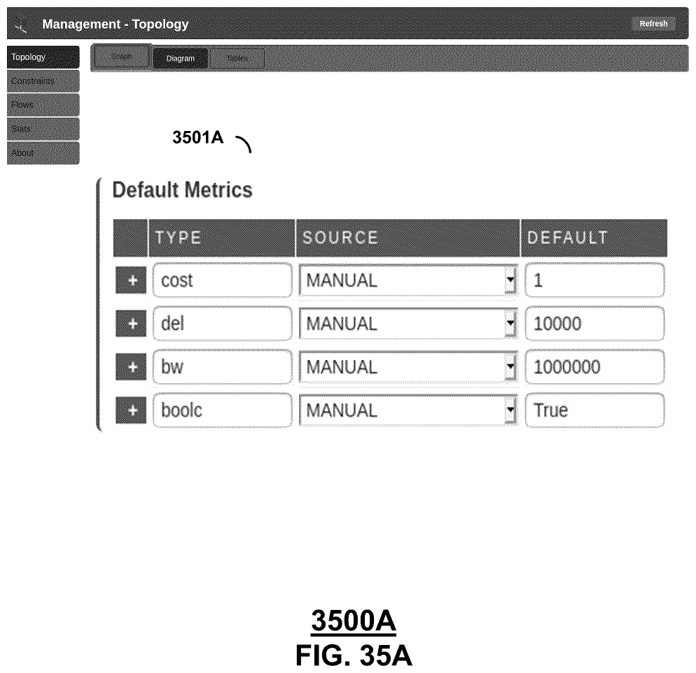

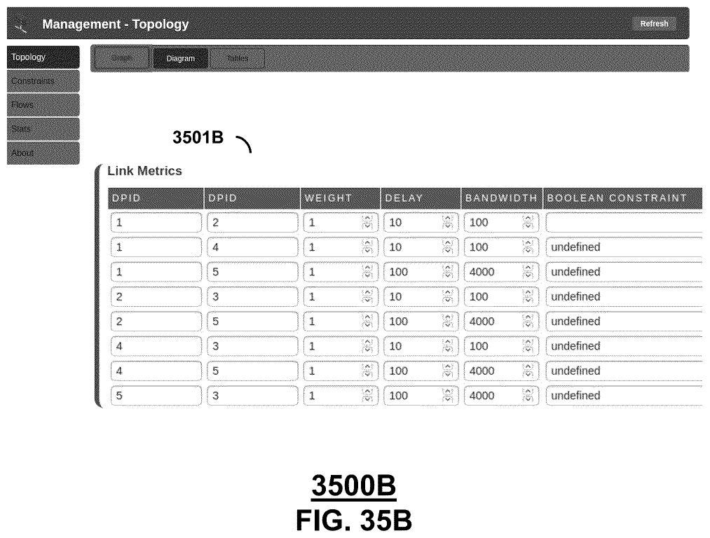

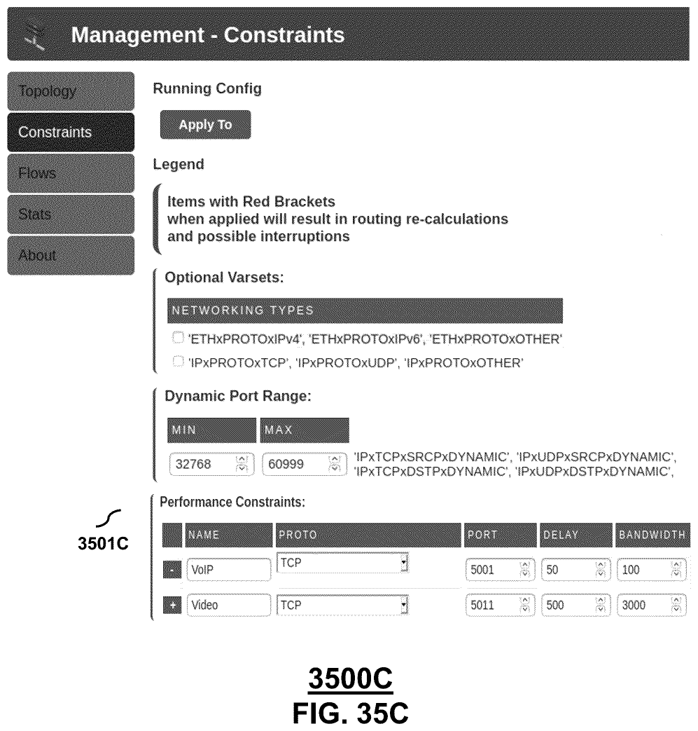

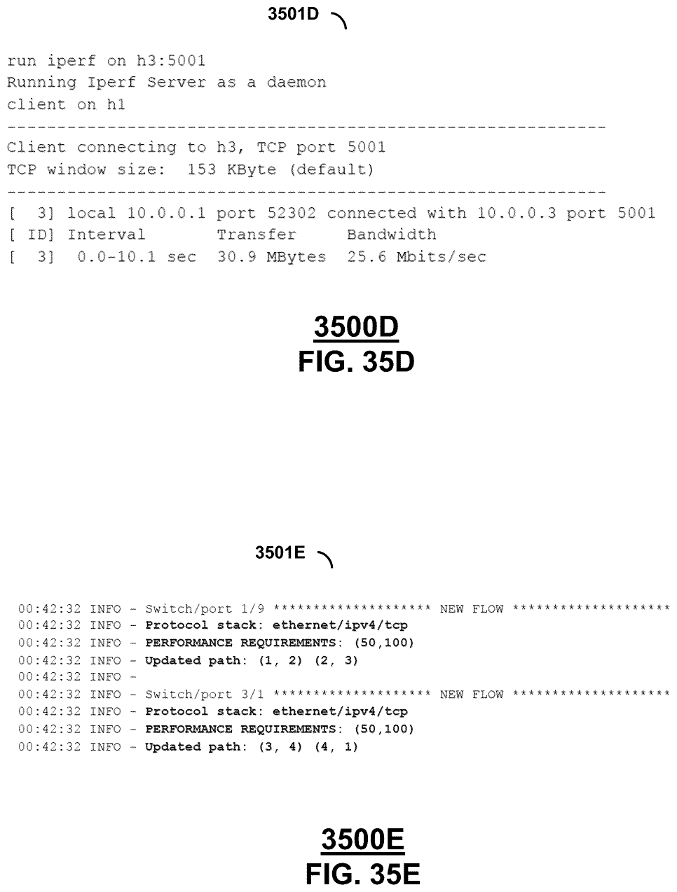

The model may be used to control the quality of service, such as by placing constraints on TCP and/or UDP traffic. The QoS scenario may be indicative of a simple communications infrastructure where the perimeter links may be all terrestrial links providing low delay and bandwidth and the links through the center node may be satellite links with higher bandwidth and delay. The challenge this scenario poses for conventional single-path routing may be how to meet the diverse needs of voice and video traffic. Specifically, interactive voice traffic may have minimal bandwidth requirements but stringent delay requirements. In contrast, video streaming may be delay tolerant, but may have stringent requirements for bandwidth. The Internet may provide one path from any source to destination (or, with Equal Cost Multi-Path routing, multiple paths with the same weight), which may not work in this scenario. The satellite paths may have too much delay for voice traffic, but terrestrial paths may not have enough bandwidth for video traffic. For example, FIG. 35 illustrates at least a portion of a product UI screen 3500 that may include a display of a diagram of a network 3501 that may be configured for support of QoS requirements (e.g., a QoS scenario). As shown, network 3501 may include any suitable number of nodes or router devices 3520, such as node 3520-1 (“node 1”), node 3520-2 (“node 2”), node 3520-3 (“node 3”), node 3520-4 (“node 4”), and node 3520-5 (“node 5”). Different nodes may be communicatively coupled to one another (e.g., using communication components of the nodes) over different communication links 3525, which may differ in any suitable manner, such as by delay and/or bandwidth, whereby links 3525 may include a first type of link with 100 ms delay and 4 Mbps bandwidth (e.g., link 3525-1.5 between nodes 3520-1 and 3520-5, link 3525-2.5 between nodes 3520-2 and 3520-5, link 3525-3.5 between nodes 3520-3 and 3520-5, and link 3525-4.5 between nodes 3520-4 and 3520-5), a second type of link with 10 ms delay and 100 Kbps bandwidth (e.g., link 3525-1.2 between nodes 3520-1 and 3520-2, link 3525-3.4 between nodes 3520-3 and 3520-4, link 3525-2.3 between nodes 3520-2 and 3520-3, and link 3525-1.4 between nodes 3520-1 and 3520-4), and/or any other suitable type(s) of link(s) with any other suitable delay and/or any other suitable bandwidth. Therefore, network 3501 may include five nodes 3520, where four peripheral nodes 3520-1, 3520-2, 3520-3, and 3520-4 may be coupled by low delay and low bandwidth links, and each of them may be coupled to a central node 3520-5 by high delay and high bandwidth links. This can be thought of as four terrestrial nodes coupled by low bandwidth terrestrial links, and one satellite node with high delay satellite links from each terrestrial node. As shown, across a top of the Management page of screen 3500 there may be provided, any suitable tabs for displaying the discovered topology information for the scenario, including, but not limited to, a graph tab that may be selected to present a UI for presenting a graph (e.g., a three dimensional topology of the network (not shown)), a diagram tab that may be selected to present a UI for presenting a basic topology with option to add annotations (e.g., as shown in FIG. 35), and a tables tab that may be selected to present a UI for presenting switches, links and hosts detected by the controller in a topology. Moreover, as shown, a constraints option may be selected to present a UI for setting up Boolean constraints and performance constraints, a flows option may be selected to present a UI for presenting active flow information for each switch, and a stats option may be selected to present a UI for presenting active stats information for each switch. A Default Metrics section 3501A may be presented, such as shown by screen 3500A of FIG. 35A, which may include default values to be used for link metrics. These can be changed to suit a user's needs. A Link Metrics section 3501B may be presented, such as shown by screen 3500B of FIG. 35B, which may provide the user with the option to override the default metrics for any of the links in the topology. These are the link metrics that may be displayed on the Diagram tab of the Topology page. These too can be changed to suit the user's needs. In this example, there are no Boolean constraints used, so they are left as undefined. While this may illustrate how to support manually configured metrics, the product may be configured to provide support for detectable values (e.g., bandwidth, “cost” based on bandwidth such as OSPF link costs, delay, and/or the like). As shown by screen 3500C of FIG. 35C, the product may present with the constraints option a constraints page 3501C that may present programmable Boolean and performance constraints. An Optional Varsets section may present a set of variables that can be added if they are required by defined policies. Boolean variables (e.g., ‘ETHxPROTOxIPv4’) may be displayed on the constraints page for all defined variables to allow copy/paste, which may help with avoiding misspelled variables, which can completely change the behavior of the Boolean constraints. Variables may be enclosed in single quotes when they are used in a constraint. A Performance Constraints section may be used to define constraints to apply to different traffic classes relating to performance. Default settings for a QoS demo may be shown in FIG. 35C. The product may be configured to provide a Controller Admin page that may present one or more menus for configuring and starting/stopping the controller itself, an interface to Web variables used in the constraints, and a log window. In some embodiments, a large main window of the Controller Admin page may be configured to present the latest log entries from any root, Info, and Debug log files kept by the controller. Info and Debug may contain logs from the CN controller. When the controller is not running, the window may show log entries left from a previous run. In some circumstances, a web log window may not keep up with the pace of log messages and some messages may be dropped. If a user would like a full picture of log activity, they can use a Terminal window to ssh into a controller Docker instance (e.g., one may find the controller's IP address using the controller alias from mn-rename with the command controller ifconfig) and watch the desired log file with the command tail-f<log file name> (e.g., by using Ctrl-C to terminate the command). The log files may be provided in a demo in a home directory. As an example, to send IPv4 voice traffic from h1 to h3, a Terminal window may be opened, and the following command (C1) may be entered:
(C1) % iperf-pair h1 h3 5001.

There may also be an ‘iperf-pair6’ function that may be defined for sending IPv6 traffic, and hostnames of the form ‘h1-6’ for IPv6 addresses. Then, the results 3501D of FIG. 35D may appear in a terminal of a screen 3500D, while results 3501E of FIG. 35E may appear in a log window of a screen 3500E. As shown, the output may show that the iperf exchange was able to transfer a little over 30 MB of traffic during the 10 second run, with some details in the log output of the transfer. The first data in the log output may be a summary of the protocols included in the frame received by the controller (e.g., details of this frame can be found in a Debug log), in effect requesting a path for the flow represented by this first frame in the flow. The second entry may show the performance requirements that may apply to the flow and the last entry may show the path chosen by the controller for the flow. The log may contain two entries for the flow: one for the forward (e.g., data bearing traffic) connection from the client to the server, and one for the return (e.g., server to client) connection for the TCP acknowledgements. A similar test can be run for video traffic using the following command (C2):
(C2) % iperf-pair h1 h3 5011.
   It may show traffic traveling from h1 to h3 via s5 (e.g., the satellite).

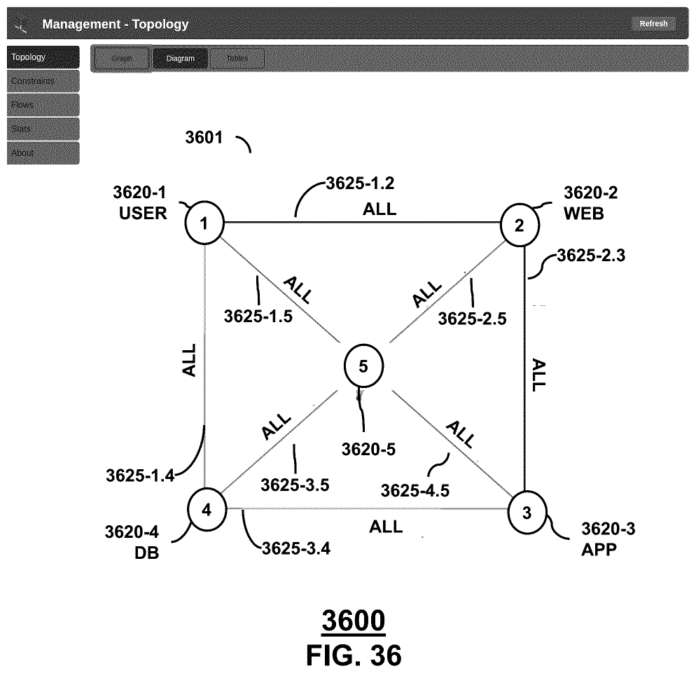

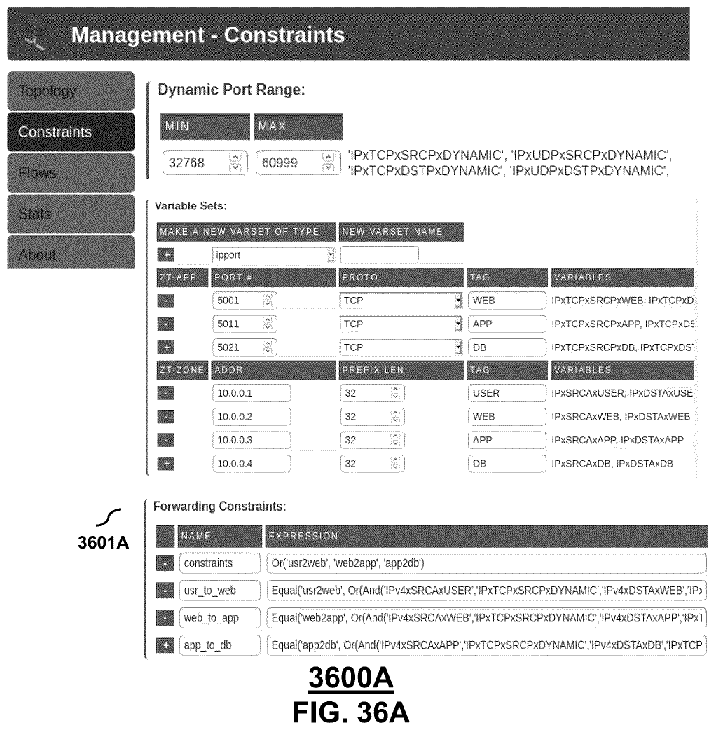

The NwC model may be configured to use Boolean constraints, such as in configuring forwarding traffic to enforce end-to-end constraints. This may be an implementation of a Zero Trust model, such as that developed by Forrester (see, e.g., “No More Chewy Centers: The Zero Trust Model Of Information Security; Vision: The Security Architecture And Operations Playbook” by John Kindervag, Mar. 23, 2016, which may define the Zero Trust model as follows: “Security professionals must stop trusting packets as if they were people. Instead, they must eliminate the idea of a trusted network (usually the internal network) and an untrusted network (external networks). In Zero Trust, all network traffic is untrusted. Thus, security professionals: 1) must verify and secure all resources; 2) limit and strictly enforce access control; and 3) inspect and log all network traffic.”). The NwC model of the product may be configured to enforce access control in terms of users, applications, and/or network zones. As shown in FIG. 36, the Zero Trust model may be applied to a traditional three-tier web architecture where web applications may be partitioned into the presentation, application, and data layers. Communication between the three layers may be strictly controlled. Specifically, users can only talk to the web layer, the web layer can only access the application layer, and the application layer can only access the data layer. For example, FIG. 36 illustrates at least a portion of a product UI screen 3600 that may include a display of a diagram of a network 3601 that may be configured for support of this scenario. As shown, network 3601 may include any suitable number of nodes or router devices 3620, such as node 3620-1 (“USER node 1”), node 3620-2 (“WEB node 2”), node 3620-3 (“APP node 3”), node 3620-4 (“DB node 4”), and node 3520-5 (“node 5”). Different nodes may be communicatively coupled to one another (e.g., using communication components of the nodes) over different communication links 3625, which may or may not differ in any suitable manner, such as link 3625-1.5 between nodes 3620-1 and 3620-5, link 3625-2.5 between nodes 3620-2 and 3620-5, link 3625-3.5 between nodes 3620-3 and 3620-5, link 3625-4.5 between nodes 3620-4 and 3620-5, link 3625-2.3 between nodes 3620-2 and 3620-3, link 3625-3.4 between nodes 3620-3 and 3620-4, link 3625-1.2 between nodes 3620-1 and 3620-2, and link 3625-1.4 between nodes 3620-1 and 3620-4. Current implementations of Zero Trust may use various technologies. For example, Palo Alto Networks may use its firewall technology to enforce access control among network zones. Ilumio may manage host-based firewalls to enforce access control between zones defined in terms of hosts. Curated Networks' approach may be to use NwC to enforce access control in the network. This may eliminate the need for special devices (e.g., firewalls) or host modifications to provide the protection of Zero Trust security. The scenario of FIG. 36 may introduce Boolean variables. These may be defined on a Management Constraints page in a Variable Sets section. In this section, Boolean variables can be defined in terms of IP addresses (e.g., ‘ipv4addr’ or ‘ipv6addr’), IP ports (e.g., ‘ipport’), or “web” variables. ‘ipport’, ‘ipv4addr’, and ‘ipv6addr’ variables may be set by the controller based on the values for the flow being classified. A significance of these variable sets may be that only one variable defined in the set can be True for a given flow. This constraint may be enforced by a ‘OneHot( )’ function over all variables in a variable set. All classes of variables may have a standardized format (e.g., where <TAG> may be a descriptive string specified by the administrator with special values described below for each class). ‘ipport’ variables may have the following forms (F1): IPxTCPxSRCPx<TAG>, IPxTCPxDSTPx<TAG>, IPxUDPxSRCPx<TAG>, IPxUDPxDSTPx<TAG>. In ‘ipport’ variable sets, <TAG> may have two special values: DYNAMIC (e.g., IPxTCPxDSTPxDYNAMIC) and UNASSIGNED (e.g., IPxUDPxSRCPxUNASSIGNED). The DYNAMIC tag may indicate a port number in the Dynamic Port Range typically used for the client side of a TCP or UDP exchange. As shown by screen 3600A of FIG. 36A, the product may present with the constraints option a Dynamic Port Range section 3601A of a Management Constraints page that may show how this range can be configured. As shown, this section may be configured to define the range of port values to be interpreted as ‘DYNAMIC’ (e.g., as described in RFC 6335, where the standard range may be from 49152 to 65535, while a Linux default range may be different from this (e.g., 32768-610000), although even this seems to vary on different systems (e.g., use “cat/proc/sys/net/ipv4/ip_local_port_range” to find the specific range)). To facilitate experimenting with this product, the default values may be set to those in effect in the Linux environment used (e.g., 32768-60999). An UNASSIGNED tag may indicate a port that is not in the dynamic range, but does not have a <TAG> in the constraint configuration (e.g., an assigned port value that does not have any significance for the current policy). ‘ipv4addr’ variables may have the following forms (F2): IPv4xSRCAx<TAG>, IPv4xDSTAx<TAG>, IPv6xSRCAx<TAG>, IPv6xSRCAx<TAG>. The ipv4addr <TAG> may have a special value, UNASSIGNED, indicating an IPv4 address that does not have a <TAG> defined in the constraint configuration. ‘ipv6addr’ variables may have the same format as ‘ipv4addr’ variables, with the ‘4’ replaced by ‘6’. ‘Web’ variables may have the following format (F3): WEBx<SET NAME>x<TAG> (e.g., ‘WEBxTHRTxHI’). Web variables might not be used in this scenario but may be used in other scenarios described herein. As shown in FIG. 36A, Variable Sets section on a Management Constraints page may be where the Boolean variables to be used in the constraints may be defined. For example, traffic may be classified into three types based on the server TCP ports of packets in a flow in the ZT-APP variable set of the configuration file. Specifically, WEB traffic may use port 5001, APP traffic may use port 5011, and DB traffic may use port 5021. In the ZT-ZONE variable set, four zones may be defined using the IP addresses of the host composing each zone: h1, with IP address 10.0.0.1, may be the USER zone; h2, 10.0.0.2, may be the WEB zone; h3, 10.0.0.3, may be the APP zone; and h4, 10.0.0.4, may be the DB zone. As shown in FIG. 36A, a Forwarding Constraints section may be configured to define constraints to be enforced in a per-flow path selection process. The settings for the ZeroTrust scenario may be shown in FIG. 36A, where a first constraint (e.g., labeled ‘constraints’) may indicate that only three types of traffic are allowed: traffic between the user and web layer (e.g., ‘usr2web’), traffic between the web and app layers (e.g., ‘web2app’), or traffic between the app and DB layers (e.g., ‘app2db’). The next three constraints may define those traffic classes. For example, the ‘usr_to_web’ constraint may be defined with the following form (F3): Equal(‘usr2web’, Or (And (‘IPv4xSRCAxUSER’, ‘IPxTCPxSRCPxDYNAMIC’, ‘IPv4xDSTAxWEB’, ‘IPxTCPxDSTPxWEB’), And (‘IPv4xSRCAxWEB’, ‘IPxTCPxSRCPxWEB’, ‘IPv4xDSTAxUSER’, ‘IPxTCPxDSTPxDYNAMIC’))), which may indicate that flows in the user_to_web traffic class may carry web traffic (‘IPxTCPxSRCPxWEB’ or ‘IPxTCPxDSTPxWEB’) with source and destination in the user and web zones (e.g., in either order). It is to be noted that there may be no Routing Constraints in this scenario. This means the traffic can use any path to get from one zone to another. The only constraints may be on the endpoints. One implication of this may be that all these systems may be attached to the same switch and the policy would still be enforced. Systems subject to this policy can be located anywhere in a connected network and these policies will be enforced. This is an important attribute of the NwC mode, whereby policies may not be dependent on topology, as is the basis for current Internet security. The following commands (C3), (C3a), and (C3b) may be entered to exercise the three allowed traffic classes:
(C3) % iperf-pair h1 h2 5001//user to web traffic;
(C3a) % iperf-pair h2 h3 5011//web to app traffic; and
(C3b) % iperf-pair h3 h4 5021//ap to db traffic.
   Varying either the port number of the destination host of either command will fail (e.g., as DESTINATION UNREACHABLE). Also, deleting links in the topology, as long as the network stays fully connected, may not impact policy compliant flows.

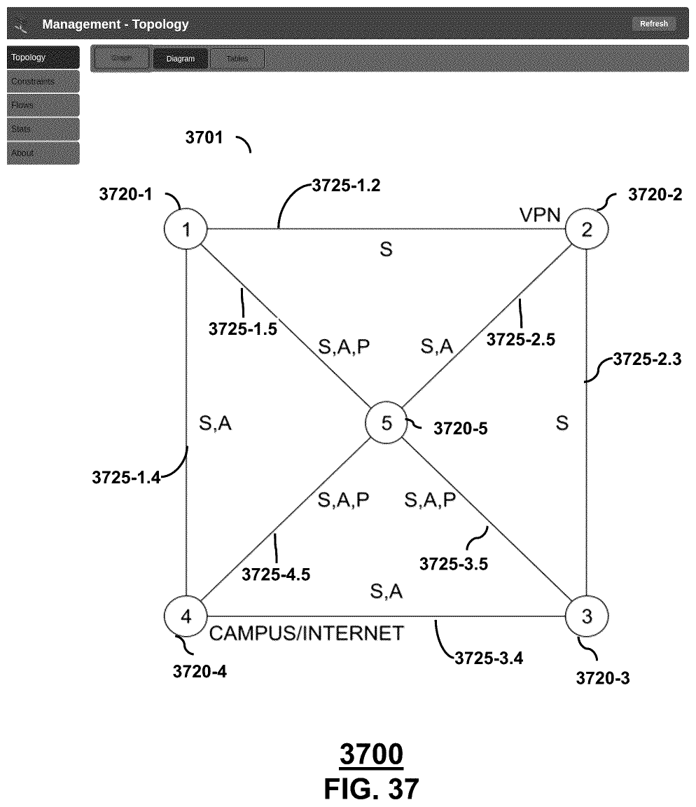

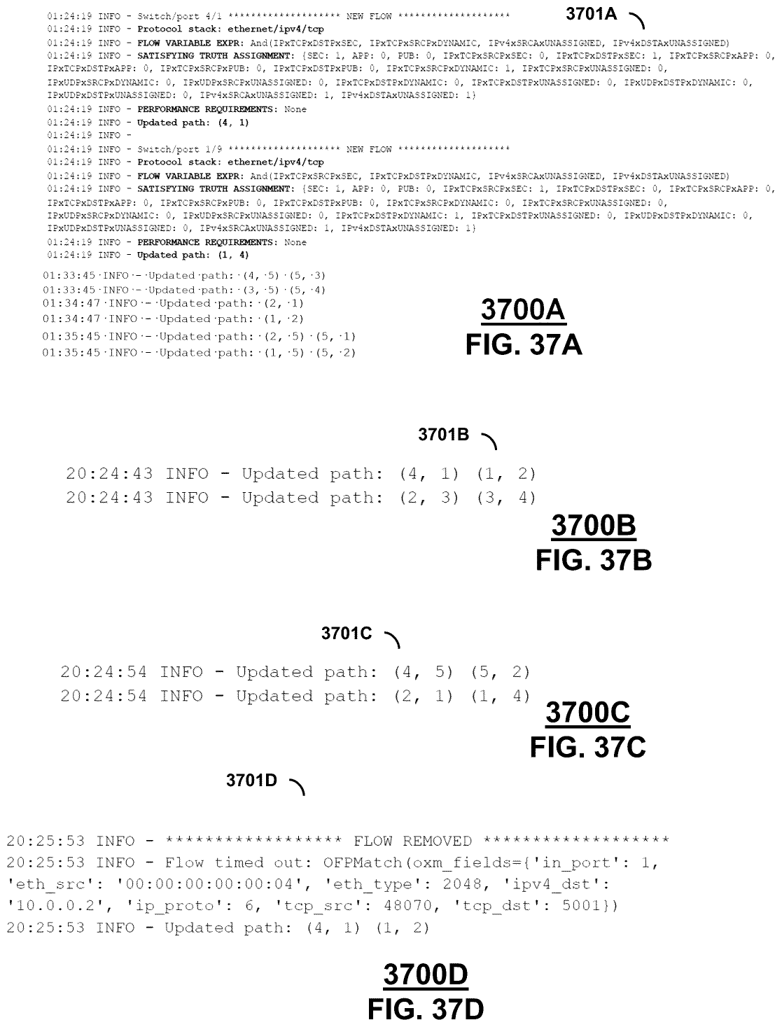

The model may be configured to use Boolean constraints to control routing. The policy model of this scenario (e.g., a Network Segmentation (“NetSeg”) scenario) may involve controlling what portions of the network traffic can traverse based on some attribute of the traffic. In this scenario, traffic may be classified into one of three classes: security (e.g., “S”), application (e.g., “A”), or public (e.g., “P”). For example, FIG. 37 illustrates at least a portion of a product UI screen 3700 that may include a display of a diagram of a network 3701 that may be configured for support of Network Segmentation (e.g., a NetSeg scenario). As shown, network 3701 may include any suitable number of nodes or router devices 3720, such as node 3720-1 (“node 1”), node 3720-2 (“VPN node 2”), node 3720-3 (“node 3”), node 3720-4 (“CAMPUS/INTERNET node 4”), and node 3720-5 (“node 5”). Different nodes may be communicatively coupled to one another (e.g., using communication components of the nodes) over different communication links 3725, which may have any suitable class(es) (e.g., link 3725-1.5 between nodes 3720-1 and 3720-5 with class(es) S, A, and P, link 3725-2.5 between nodes 3720-2 and 3720-5 with class(es) S and A, link 3725-3.5 between nodes 3720-3 and 3720-5 with class(es) S, A, and P, link 3725-4.5 between nodes 3720-4 and 3720-5 with class(es) S, A, and P, link 3725-1.2 between nodes 3720-1 and 3720-2 with class S, link 3725-2.3 between nodes 3720-2 and 3720-3 with class S, link 3725-3.4 between nodes 3720-3 and 3720-4 with class(es) S and A, and link 3725-1.4 between nodes 3720-1 and 3720-4 with class(es) S and A), and/or any other suitable type(s) of link(s) with any other suitable class(es). In this scenario, application infrastructure may be distributed over zones or nodes 1, 5, and 3 portions of the network, VPN traffic may come from zone or node 2, and traffic from the Internet (e.g., campus) may come from zone or node 4. The policy implemented here may have fairly rich connectivity from zone 4 to zones 1, 5 and 3. VPN traffic may be only usable by security and Internet users, and the security users may have access to all portions of the network to facilitate their work keeping the enterprise environment secure. In this scenario, the Topology and Constraints pages may be populated with Boolean constraint information. To exercise a policy from zone 4 to zone 1 for security traffic, the following command (C4) may be entered in the command terminal:
(C4) % iperf-pair h4 h1 5001.
   Then, the results 3701A of FIG. 37A may appear in a log window of a screen 3700A. As shown, for each flow assignment, four pieces of information relating to the path selection decision may be provided in the log: (1) the line starting with “Protocol stack” may provide a summary of the header information for the frame triggering the current path selection computation; (2) the “FLOW VARIABLE EXPR” line may display the Boolean expression calculated by the controller to represent the flow; (3) the “SATISFYING TRUTH ASSIGNMENT” line may display one satisfying truth assignment for the flow's constraint (e.g., which included the routing, forwarding, and link constraints combined with the flow's constraints), where the satisfying truth assignment may often give a hint at why a flow is allowed or not (e.g., of particular note in this example, for this TCP connection, the path [1-4] is used for both outbound and return traffic); and (4) there may be no “PERFORMANCE REQUIREMENTS” for this flow. This output may show that zone 1 can be reached in one hop for SEC traffic. While PUB traffic (iperf-pair h4 h3 5021) may take a two hop path through zone 5 (see, e.g., “Updated path: (4, 5) (5, 3)” and “Updated path: (3, 5) (5, 4)” of results 3700A), VPN traffic from zone 2 may only be usable by SEC or APP traffic (iperf-pair h2 h1 5011 for APP; use 5001 for SEC), with SEC traffic having one hop paths to all application servers (see, e.g., “Updated path: (2, 1)” and “Updated path: (1, 2)” of results 3700A), and APP traffic may use two hop paths for some of the application sites (see, e.g., “Updated path: (2, 5) (5, 1)” and “Updated path: (1, 5) (5, 2)” of results 3700A). PUB traffic (e.g., port 5021) may not access any application environments from zone 2 (e.g., attempts may result in ICMP Destination Unreachable messages). A couple of other aspects of the prototype can be demonstrated in this scenario: load balancing and flow timeouts. The controller may be configured to implement load-balancing in that, when the controller selects a path for a new flow, if there are multiple paths that satisfy the flow's constraints, the controller may be configured to select the path that it has assigned the least amount of traffic to. It may also attempt to cleanup flow table resources by deleting flow table entries that have not been used for a period of time. This NetSeg scenario may be configured to allow these two capabilities to show the manner in which it assigns paths to some flows. Specifically note that ‘security’ traffic may be allowed over three paths from h4 to h2 (i.e., 4-1-2, 4-5-2, and 4-3-2). When multiple flows are sent between these two hosts, the controller may be configured to potentially select different paths for each flow as it endeavors to minimize congestion in the network. To see this, the following command (C5) may be run multiple times in a row:
(C5) % iperf-pair h4 h2 5001.

Depending on the load in the network, subsequent flows may be seen to use paths with different middle nodes. Results 3701B of FIG. 37B may appear in a log window of a screen 3700B for some runs (e.g., notice the flow goes out via node 1 and back via node 3). Results 3701C of FIG. 37C may appear in a log window of a screen 3700C for some runs (e.g., notice the flow goes out via 5 and back via 1). Another symptom of the flow timeout may show log entries, such as results 3701D of FIG. 37D in a log window of a screen 3700D.

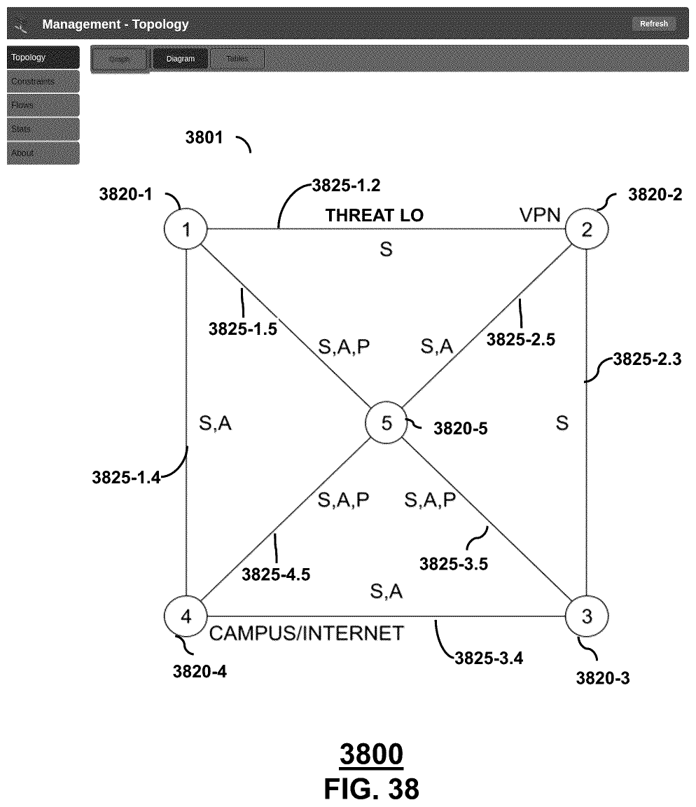

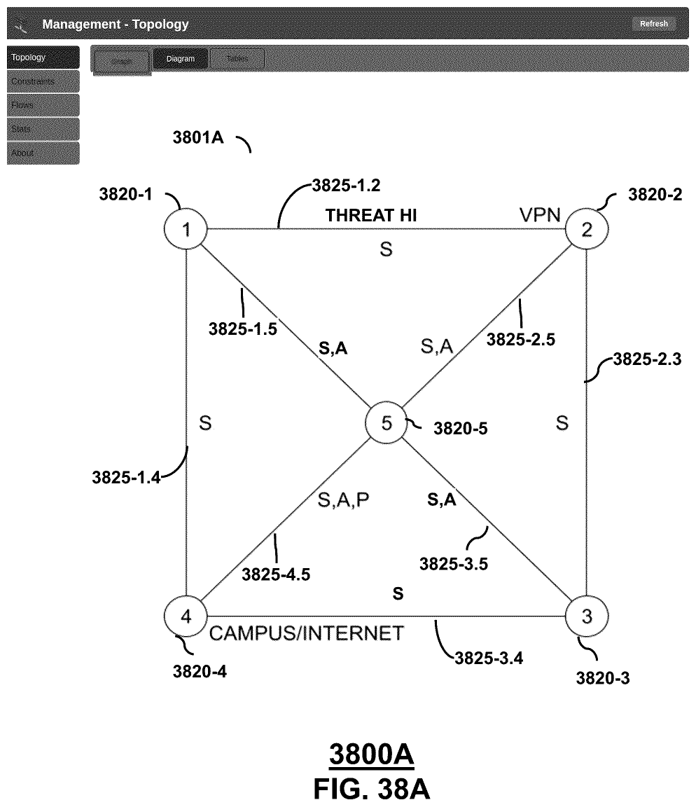

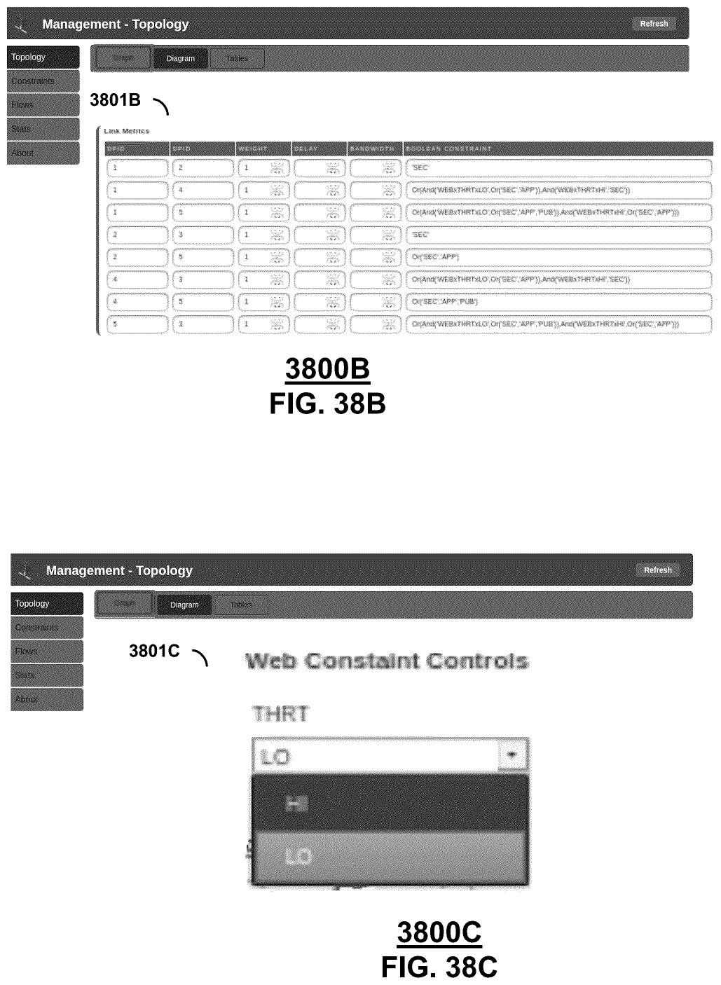

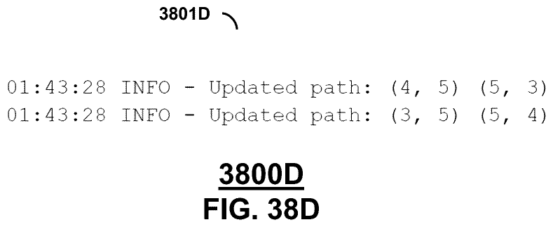

Building on the NetSeg scenario, the model may be configured to use not only Boolean constraints but also web variables to control routing. For example, another scenario (e.g., NetSeg with Threat Levels) may add threat levels using threat level web variables. Two threat levels may be defined (e.g., “HI” and “LO”). Web variables may be defined that reflect these levels (WEBxTHRTxLO and WEBxTHRTxHI). Two subscenarios may differ based on the threat level. In a low threat level subscenario of FIG. 38, the same scenario may be presented as in the NetSeg scenario of FIG. 37. For example, FIG. 38 illustrates at least a portion of a product UI screen 3800 that may include a display of a diagram of a network 3801 that may be configured for support of Network Segmentation low threat level. As shown, network 3801 may include any suitable number of nodes or router devices 3820, such as node 3820-1 (“node 1”), node 3820-2 (“VPN node 2”), node 3820-3 (“node 3”), node 3820-4 (“CAMPUS/INTERNET node 4”), and node 3820-5 (“node 5”). Different nodes may be communicatively coupled to one another (e.g., using communication components of the nodes) over different communication links 3825, which may have any suitable class(es) (e.g., link 3825-1.5 between nodes 3820-1 and 3820-5 with class(es) S, A, and P, link 3825-2.5 between nodes 3820-2 and 3820-5 with class(es) S and A, link 3825-3.5 between nodes 3820-3 and 3820-5 with class(es) S, A, and P, link 3825-4.5 between nodes 3820-4 and 3820-5 with class(es) S, A, and P, link 3825-1.2 between nodes 3820-1 and 3820-2 with class S, link 3825-2.3 between nodes 3820-2 and 3820-3 with class S, link 3825-3.4 between nodes 3820-3 and 3820-4 with class(es) S and A, and link 3825-1.4 between nodes 3820-1 and 3820-4 with class(es) S and A), and/or any other suitable type(s) of link(s) with any other suitable class(es). In this scenario, application infrastructure may be distributed over zones or nodes 1, 5, and 3 portions of the network, VPN traffic may come from zone or node 2, and traffic from the Internet (e.g., campus) may come from zone or node 4. The policy implemented here may have fairly rich connectivity from zone 4 to zones 1, 5 and 3. VPN traffic may be only usable by security and Internet users, and the security users may have access to all portions of the network to facilitate their work keeping the enterprise environment secure. However, in a high threat level scenario of FIG. 38A, access may be removed to allow network resources to be dedicated to responding to the threat. Specifically, Public traffic can now only reach zone 5 and application traffic cannot use the links from zone 4 to zones 1 and 3. That is, as shown by network 3801A of screen 3800A of FIG. 38A, link 3825-1.5 now only supports classes S and A (and not also class P), link 3825-1.4 now only supports class S (and not also class A), and link 3825-3.5 now only supports classes S and A (and not also class P). A Link Metrics section 3801B may be presented, such as shown by screen 3800B of FIG. 38B, which may provide the user with the option to override the default metrics for any of the links in the topology. These are the link metrics that may be displayed on the Diagram tab of the Topology page. These too can be changed to suit the user's needs. As shown, these policies may be implemented as Boolean constraints for links 1-4, 1-5, 3-4, and 3-5. To change the threat level, on the Admin Controller page, a Web Constraint Controls menu 3801C of FIG. 38C may be provided by the product and enable a user to selectively choose between the LO and HI threat levels. The following command (C6) may be entered in the command terminal:
(C6) % iperf-pair h4 h3 5011.
   Changing to HI level may force APP traffic to use a two-hop path (e.g., via zone 6), as may be shown by results 3801D of FIG. 38D that may appear in a log window of a screen 3800D. It is to be noted that at a HI threat level, PUB traffic may only reach h5. Traffic to h1 or h3 may not be allowed (e.g., which may result in an ICMP Destination Unreachable). The Topology page may show how the product may implement the threat levels. Threat levels may be implemented using the Boolean variables WEBxTHRTxHI and WEBxTHRTxLO. For those links where threat levels are enforced, the product may be configured to define a two-part constraint that may be composed of the OR of two AND clauses that may be composed of the threat level at which the clause is enforced and an OR of the MLS levels that are allowed (e.g., at that threat level for that link). The THREAT LO and THREAT HI figures give a visual depiction of the policies defined on the Topology page. For example the following constraint:
   “Or(And(‘WEBxTHRTxLO’, Or(‘SEC’,‘APP’)), And(‘WEBxTHRTxHI’,‘SEC’))” may be assigned to links 1-4 and 4-3 and may be configured to say that at the low threat level either SEC or APP traffic is allowed at these levels, while at the high threat level only SEC traffic is allowed. It is to be noted that web variables can also be accessed via a REST interface, which may in effect provide a user-definable API to the controller.

The following three MLS scenarios (e.g., (1) MLS scenario, (2) MLS with DEFCON scenario, and (3) MLS with DEFCON and QoS scenario) may present a different view of the same capabilities exhibited in the NetSeg scenarios. Specifically, traffic classes may be defined and constraints may be configured that may control what parts of the network traffic from the different classes can traverse. In a sense, NetSeg and MLS may be mirrors of each other. The Security traffic class in NetSeg may be equivalent to the UNCLASSIFIED class in MLS (e.g., both may have access to all portions of the network), and the PUBLIC NetSeg class may be equivalent to the TOP SECRET class in MLS (e.g., both may have the most restricted access of all traffic classes). An additional capability may be illustrated in the last MLS section (e.g., MLS with DEFCON and QoS) for combining performance and Boolean constraints in a single configuration.

The MLS model used may be a simplistic version of the Bell-LePadula access control model. The main point is that traffic may be classified into three levels of security: unclassified (“U”), secret (“S”) and top secret (“T” or “TS”). The three classes may be ordered from U being least sensitive (e.g., think of general web browsing traffic), and with S and TS being progressively more secure classes of traffic. Each security level may have requirements for what kind of infrastructure it may be allowed to traverse. For example, it could be that U can be carried on any network infrastructure, while S can only be carried on reasonably secured infrastructure (e.g., copper or fiber media), and while T can only be carried on highly secured infrastructure (e.g., fiber media in highly secured facilities).

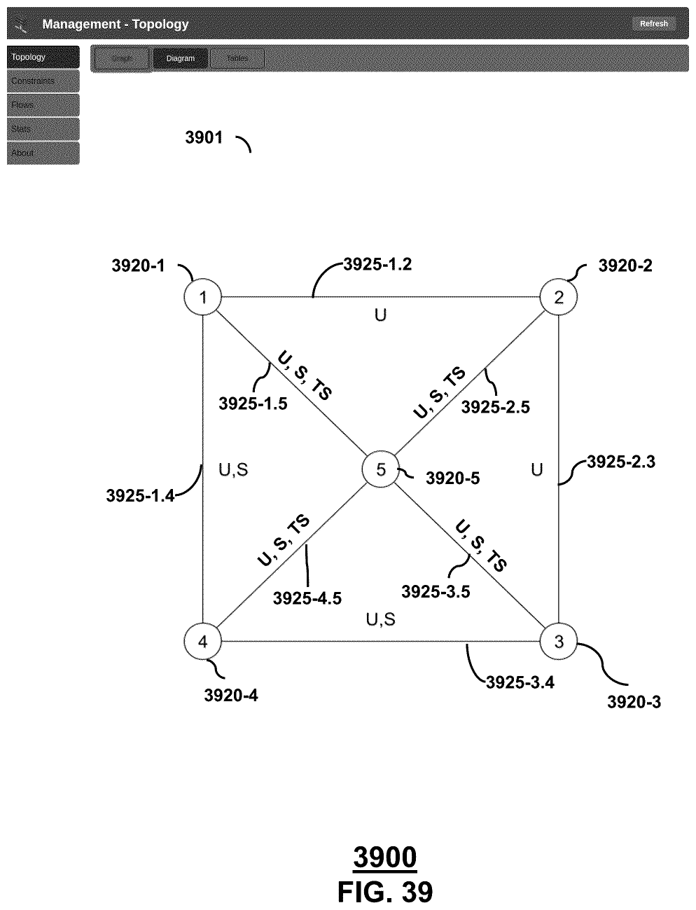

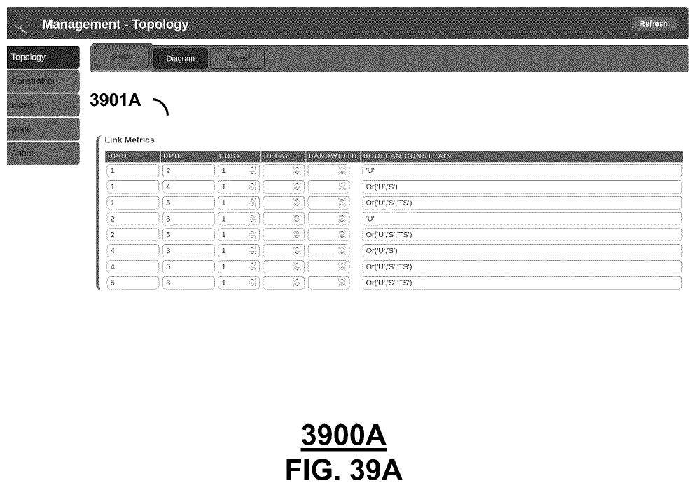

For example, FIG. 39 illustrates at least a portion of a product UI screen 3900 that may include a display of a diagram of a network 3901 that may be configured for support of an MLS scenario. As shown, network 3901 may include any suitable number of nodes or router devices 3920, such as node 3920-1 (“node 1”), node 3920-2 (“node 2”), node 3920-3 (“node 3”), node 3920-4 (“node 4”), and node 3920-5 (“node 5”). Different nodes may be communicatively coupled to one another (e.g., using communication components of the nodes) over different communication links 3925, which may have any suitable class(es) (e.g., link 3925-1.5 between nodes 3920-1 and 3920-5 with class(es) U, S, and TS, link 3925-2.5 between nodes 3920-2 and 3920-5 with class(es) U, S, and TS, link 3925-3.5 between nodes 3920-3 and 3920-5 with class(es) U, S, and TS, link 3925-4.5 between nodes 3920-4 and 3920-5 with class(es) U, S, and TS, link 3925-1.2 between nodes 3920-1 and 3920-2 with class U, link 3925-2.3 between nodes 3920-2 and 3920-4 with class U, link 3925-3.4 between nodes 3920-3 and 3920-4 with class(es) U and S, and link 3925-1.4 between nodes 3920-1 and 3920-4 with class(es) U and S), and/or any other suitable type(s) of link(s) with any other suitable class(es). Therefore, network 3901 may show a simple 5-node topology where only links through node 5 may be highly secured (e.g., can therefore carry any traffic including TS). Links (1,4) and (4,3) may be moderately secured (e.g., can carry S or U traffic) and links (1,2) and (2,3) may be unsecured (e.g., consumer-grade WiFi, and can only carry U traffic). A Link Metrics section 3901A may be presented, such as shown by screen 3900A of FIG. 39A, which may provide the user with the option to override the default metrics for any of the links in the topology. This may show how the product may classify traffic into the three security levels based on the server TCP ports of packets carrying a flow in the MLS variable set. Specifically, U traffic may use port 5001, S traffic may use port 5011, and T traffic may use port 5021. The policies may be defined for links as shown in the Topology tab above where, for example, Or(U, S, TS) may indicate all traffic classes are allowed. To exercise these policies, the following commands (C7), (C8), and (C9) may be entered in the command terminal:
(C7) % iperf-pair h1 h3 5001;
(C8) % iperf-pair h1 h3 5011; and
(C9) % iperf-pair h1 h3 5021.
   Repeated runs of each command may show that U (5001) traffic can use all three paths (1-2-3, 1-5-3, 1-4-3), S traffic can only use paths 1-5-3 and 1-4-3, and TS traffic may be restricted to 1-5-3. Note, from the paths taken, that the first two cases may use one hop paths that directly connect the two nodes, and the third case may be forced to use a two hop path that goes from 1 to 3 through node 5. When the following commands (C10) and (C11) are entered in the command terminal:
(C10) % iperf-pair h1 h2 5011; and
(C11) % iperf-pair h1 h2 5021,
   the output may show how S and TS traffic may be forced to go via node 5 to lay on a secure path to reach node 2.

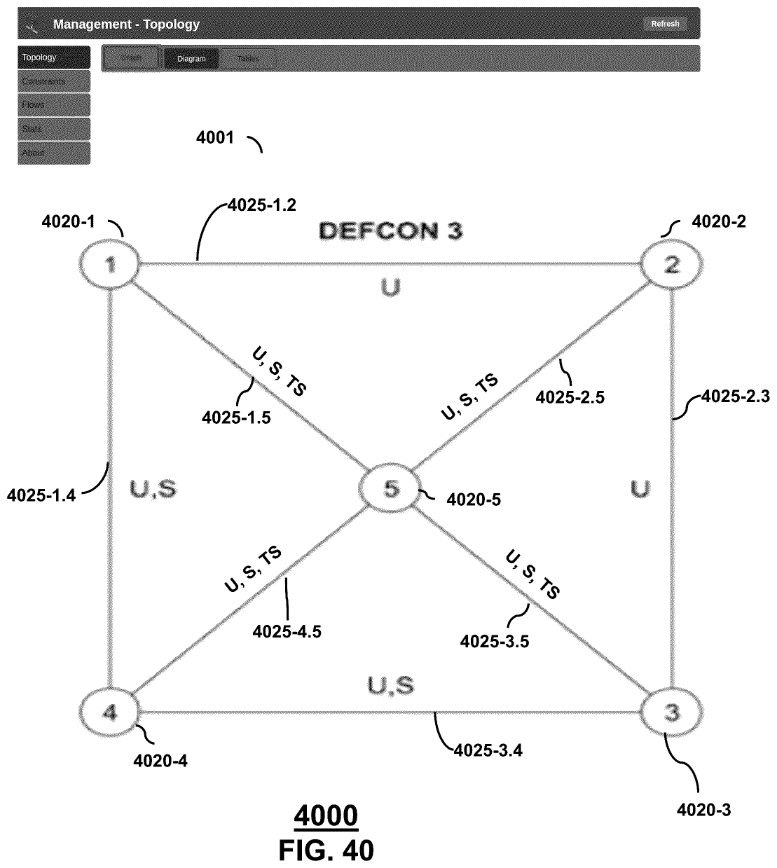

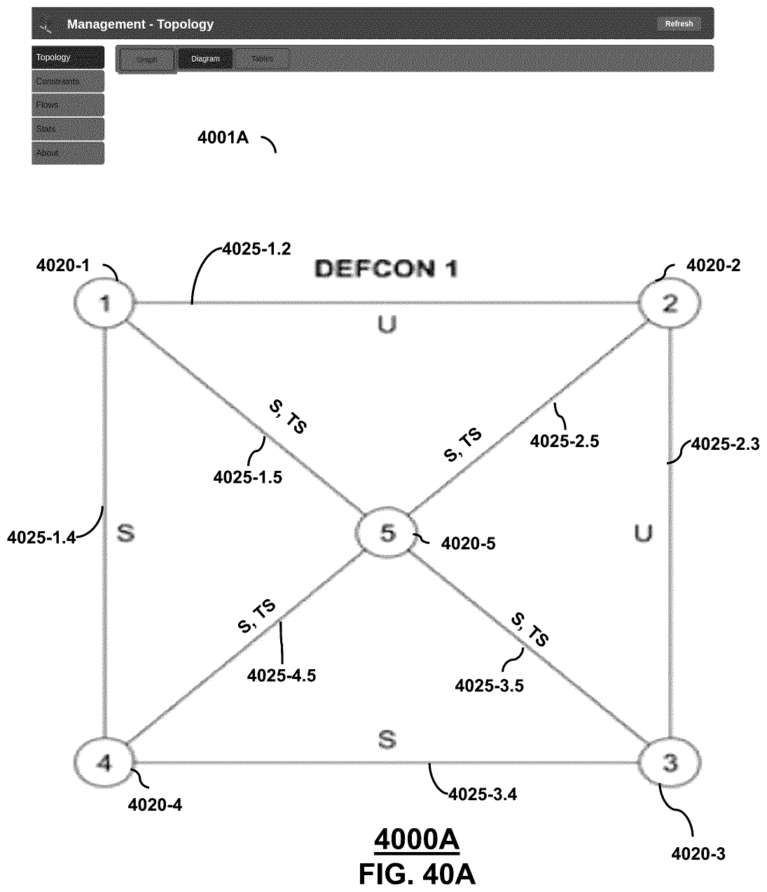

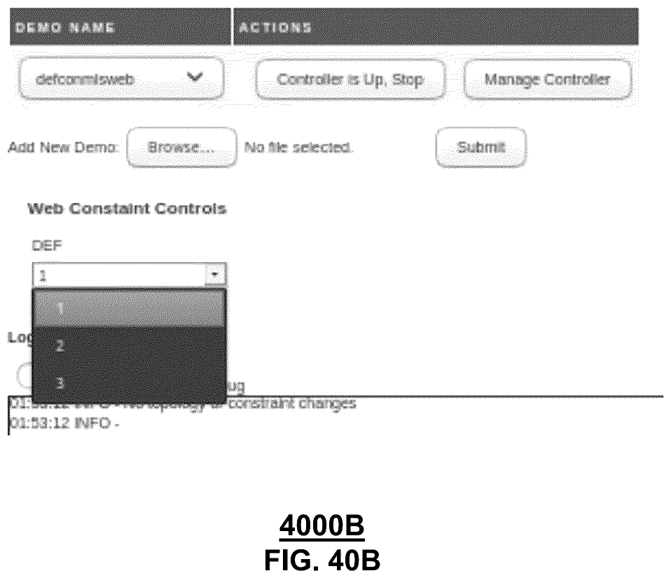

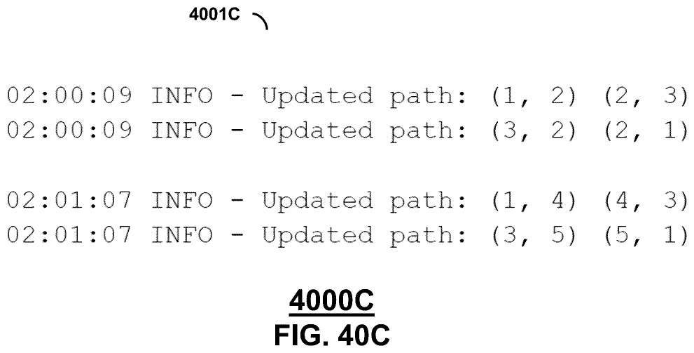

Building on the MLS scenario, an MLS with DEFCON scenario may add threat levels with the DEFCON variables. DEFCON levels may reflect threat levels, with lower numbered DEFCON levels representing greater threat levels (e.g., DEFCON 1 might indicate active or imminent attack). Two subscenarios may differ based on the threat level. In a DEFCON3 lower threat level subscenario of FIG. 40, the same scenario may be presented as in the MLS scenario of FIG. 39. For example, FIG. 40 illustrates at least a portion of a product UI screen 4000 that may include a display of a diagram of a network 4001 that may be configured for support of MLS with DEFCON level 3 low threat level. As shown, network 4001 may include any suitable number of nodes or router devices 4020, such as node 4020-1 (“node 1”), node 4020-2 (“node 2”), node 4020-3 (“node 3”), node 4020-4 (“node 4”), and node 4020-5 (“node 5”). Different nodes may be communicatively coupled to one another (e.g., using communication components of the nodes) over different communication links 4025, which may have any suitable class(es) (e.g., link 4025-1.5 between nodes 4020-1 and 4020-5 with class(es) U, S, and TS, link 4025-2.5 between nodes 4020-2 and 4020-5 with class(es) U, S, and TS, link 4025-3.5 between nodes 4020-3 and 4020-5 with class(es) U, S, and TS, link 4025-4.5 between nodes 4020-4 and 4020-5 with class(es) U, S, and TS, link 4025-1.2 between nodes 4020-1 and 4020-2 with class U, link 4025-2.3 between nodes 4020-2 and 4020-3 with class U, link 4025-3.4 between nodes 4020-3 and 4020-4 with class(es) U and S, and link 4025-1.4 between nodes 4020-1 and 4020-4 with class(es) U and S), and/or any other suitable type(s) of link(s) with any other suitable class(es). However, in a DEFCON 1 high threat level scenario of FIG. 40A, access may be removed to allow network resources to be dedicated to responding to the threat. That is, as shown by network 4001A of screen 4000A of FIG. 40A, link 4025-1.5 now only supports classes S and TS (and not also class U), link 4025-2.5 now only supports classes S and TS (and not also class U), link 4025-3.5 now only supports classes S and TS (and not also class U), link 4025-4.5 now only supports classes S and TS (and not also class U), link 4025-1.4 now only supports class S (and not also class U), and link 4025-3.4 now only supports class S (and not also class U). Therefore, in DEFCON 3, the traditional MLS scenario may be provided where more secured communications infrastructure can carry more sensitive levels of traffic. In contrast, in the DEFCON 1 scenario, support for unclassified (U) traffic may be significantly curtailed. Specifically, at DEFCON 1, U traffic may no longer be able to traverse the links to nodes 5 or 4. The purpose of this may be, in the presence of an active or imminent attack, network resources are being reserved for the higher sensitivity traffic. The Topology page may show how DEFCON levels may be implemented. For those links where DEFCON levels are enforced, the product may define a two part constraint composed of the 1) OR of two AND clauses that are composed of the DEFCON level at which the clause is enforced and 2) an OR of the MLS levels that may be allowed (e.g., at that DEFCON level for that link). The DEFCON1 and DEFCON3 diagrams may provide a visual depiction of the policies defined on the Topology page. For example the constraint “Or(And(‘WEBxDEFx3’, Or(‘U’,‘S’)), And(‘WEBxDEFx1’,‘S’))” that may be assigned to links 1-4 and 4-3 indicates at DEFCON 3, either U or S traffic may be allowed at these levels, while at DEFCON 1, only S traffic may be allowed. A new feature of this scenario may be the use of Web variables. Specifically, DEFCON levels may be implemented as WEBxDEFx1, WEBxDEFx2, and WEBxDEFx3. Web variables may be controlled on a Controller Admin page of the product, such as shown by screen 4000B of FIG. 40B. For example, to exercise the DEFCON web variables, in the command terminal, the following commands (C12), (C13), and (C14) may be entered:
(C12) % iperf-pair h1 h3 5001;
(C13) % iperf-pair h1 h3 5011; and
(C14) % iperf-pair h1 h3 5021.
   The S and TS traffic classes may be handled the same at both DEFCON levels (e.g., from h1 to h3). S traffic can use either the s4 or s5 paths, but TS traffic can only use the s5 path. However, U traffic may be handled differently. At DEFCON level 3, it may be handled the same as with the MLS policy (e.g., as any of the s2, s4 or s5 paths). At DEFCON level 1, it is restricted to the s2 path. Results 4001C of FIG. 40C may appear in a log window of a screen 4000C as an output for two U flows with this DEFCON/MLS policy, where the first pair are at level 1 and the second are at level 3.

Yet another scenario may layer QoS on top of the MLS-DEFCON scenario. As shown, for example, with reference to Table 5, which may show how things should behave for traffic from node 1 to node 3, notice that at DEFCON 1, U may only reach nodes 1, 2, and 3, and only with voice, while T can reach any node, but only with video. Voice may be on ports 5001, 5002, 5003 at U, S, and T, respectively, while video may be on ports 5011, 5012, and 5013. So, 10s digit may be voice (0) and video (1), and is digit may be U (1), S (2), and T (3). DEFCON levels may be controlled with the Web variable.

TABLE 5

| DEFCON | TYPE | LEVEL | PORT | BEHAVIOR |
|---|---|---|---|---|
| DEF3 | VoIP | U | 5001 | Both edge paths |
| | | S | 5002 | Counter-clockwise path only |
| | | T | 5003 | DEST UNREACHABLE |
| | Video | U | 5011 | Diagonal only |
| | | S | 5012 | Diagonal only |
| | | T | 5013 | Diagonal only |
| DEF1 | VoIP | U | 5001 | Clockwise path only |
| | | S | 5002 | Counter-clockwise path only |
| | | T | 5003 | DEST UNREACHABLE |
| | Video | U | 5011 | DEST UNREACHABLE |
| | | S | 5012 | Diagonal only |
| | | T | 5013 | Diagonal only |

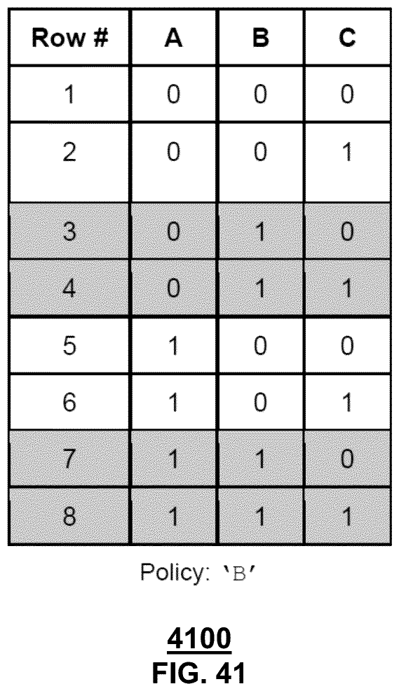

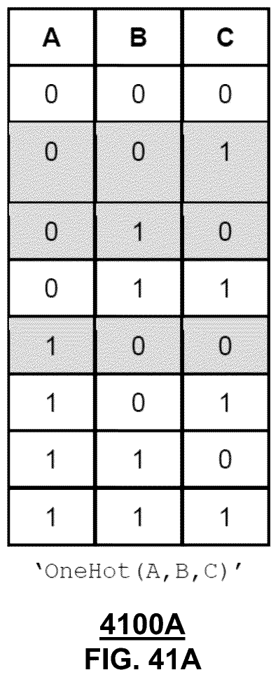

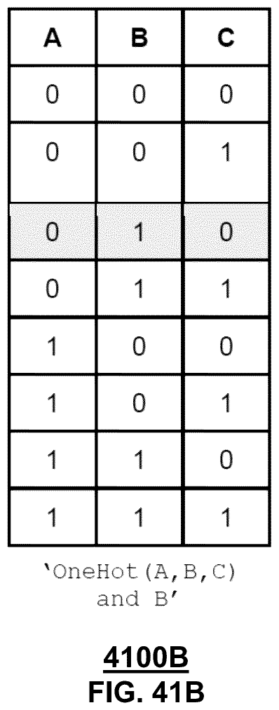

Next to the syntactic structure, a significance of a variable set may be that only one variable defined in the set can be True for a given flow. This constraint may be enforced by a OneHot( ) function over all variables in a variable set. To understand the importance of the OneHot( ) constraint, consider how Boolean constraints are evaluated. To understand this, recall the definition of truth tables. For a given set of Boolean variables, a truth table for those variables may contain a row for every possible value of those variables. For example, if policies are defined in terms of which of nodes A, B, and C can send traffic over links, and Boolean variables are defined for these nodes, the truth table would be as shown (e.g., where 1 is shorthand for True and 0 for False) by truth table 4100 of FIG. 41 (e.g., for “Policy: ‘B’”), by truth table 4100A of FIG. 41A (e.g., for “‘OneHot(ABC)’”), and by truth table 4100B of FIG. 41B (e.g., for “‘OneHot(ABC) and B’”). Considering the policy that a given link can only carry traffic from node B, such a policy could, naively, be interpreted as the set of rows from the full truth table where B is True (e.g., the rows highlighted in table 4100 of FIG. 41). Given this context, a request to send traffic from C over the link may be interpreted as the query “is there any truth assignment in the rows allowed by the link constraint that allow traffic from C?”. Based on the naive interpretation of the policy, the answer would be yes; rows 4 and 8 allow traffic from C, and the request would be allowed. However, this is generally not the intent of the policy “link can only carry traffic from node B”. The key to the real intent is the word “only” in this policy (i.e., the link is only usable by B). This is what the OneHot( ) constraint for a variable set may provide. “OneHot(A, B, C)” may be expanded to a truth table containing only rows 2, 3, and 5 (e.g., the highlighted rows in table 4100A of FIG. 41A, where only one variable is True). Including the OneHot( ) restriction, the constraint that a link may be usable by B is now interpreted as those rows where only one variable is true (e.g., OneHot( ) and B is True, which is only row 3 (e.g., the highlighted row in table 4100C of FIG. 41C). As a result, with the constraint “OneHot(A, B, C) and B” (e.g., where OneHot(A, B, C) would be for the variable set, and B would be a constraint on a link), the answer to the request to send traffic from C would not be allowed because C is not True in row 3. It is in this capacity that OneHot( ) may be used with variable sets. Using the example in tables 4100, 4100A, and 4100B, OneHot( ) may be used to indicate that only one of the source port variables (IPxTCPxSRCPxU, IPxTCPxSRCPxS, IPxTCPxSRCPxT) can be true for a given packet, and similarly for the destination ports. This may avoid these potential false positives. Said another way, this may enforce the semantics that only a constraint C of a set of mutually exclusive constraints A, B, and C is true.

A controller of the NwC system (e.g., controller 3402c (e.g., a Ryu controller)) may be configured to implement a REST-based or any other suitable type of API for many of its functions and to allow the extension of them for other uses. In some embodiments, a Flowmanager Web interface may be running as a module for the controller and may have various API calls (e.g., REST API calls) to perform its functions. The NwC system of this disclosure may add various specific API functions (e.g., REST API functions) and their use potential in external integrations may be summarized in the following table 6 of API endpoints:

TABLE 6

| Path | Use(s) | Function(s) |
|---|---|---|
| /home/* | Read | Flowmanager utility API call to fetch parts of |
| | | the web interface. Several web pages and |
| | | their images may be located here. |
| /data?list=switches | Read | Flowmanager API call to return a JavaScript |
| | | Object Notation (“JSON”) object of the |
| | | current known OpenVswitch devices. |
| /topology | Read | Flowmanager API call to return full network |
| | | connectivity details from the Openflow |
| | | switches. |
| /curated/config | Read | Provides the configuration information that |
| | | was passed to start the controller. Read only. |
| /curated/const | Read/Write | Provides the NwC constraint information, in |
| | | the running controller (e.g., Ryu) instance, as |
| | | a JSON object. |
| /curated/graph | Read/Write | Allows the export and import of a networkX |
| | | graph structure with NwC routing constraints |
| | | into the running instance. May be used by the |
| | | web interface forms. |
| /curated/defaultmetric | Read | Provides the current instance defaults for |
| | | routing metrics. Read only. May be used by |
| | | web forms. |
| /curated/dynamicport | Read | Provides the current instance dynamic port |
| | | range. Read only. May be used by web |
| | | forms. |
| /curated/optionalvarsets | Read | Provides the current optional varsets that may |
| | | be for specific NwC uses. Read only. May be |
| | | used by web forms. |
| /curated/webvarsets | Read/Write | An interface (e.g., REST interface) for the |
| | | manipulation of the state of webvars created |
| | | with the web interface. A sample program to |
| | | set their values with an external script may be |
| | | provided. |

The API call “GET /curated/config” may be configured to return a JSON structure when sent a GET request for the details of how the controller instance was started. The following JSON response may be provided:

```
{
  “graph_file”: “graph.edgelist”,
  “Const_file”: “/home/ubuntu/bradco-
demo/cn/nginx/../../TESTS/GNS3/mls.json”,
  “algorithm”: “ecmp”
}
```

that may include the following JSON components: “graph file” that may be the name of the graph file that may be deprecated currently and may always read “graph.edgelist”; “const_file” that may be the name of the constraints file that is being used to define the running scenario; and “algorithm” may be the NwC algorithm that may be in use by the scenario.

The API call “GET, PUT/curated/const” may be configured to return a JSON structure when sent a GET request of the active instance configuration of the controller. The following JSON response may be provided:

```
{
  “algorithm”: “ecmp-bc”,
  “routingconsts”: [
    {
      “name”: “only-one”,
      “expr”: “OneHot(‘U’,‘S’,‘TS’)”
    }
  ],
  “flowconsts”: [
    {
      “name”: “U”,
      “expr”: “Equal(‘U’, Or(‘IPxTCPxSRCPxU’,‘IPxTCPxDSTPxU’))”
    },
    {
      “name”: “S”,
      “expr”: “Equal(‘S’, Or(‘IPxTCPxSRCPxS’,‘IPxTCPxDSTPxS’))”
    },
    {
      “name”: “TS”,
      “expr”: “Equal(‘TS’, Or(‘IPxTCPxSRCPxT’,‘IPxTCPxDSTPxT’))”
    }
  ],
  “flowvars”: {
    “COMMENT”: “ipv4addr: no match = IPv4xSRCA/DSTAxUNASSIGNED”,
    “varsets”: {
    “MLS”: [
      {
        “type”: “ipport”,
        “portnum”: 5001,
        “proto”: “TCP”,
        “bname”: “U”
      },
      {
        “type”: “ipport”,
        “portnum”: 5011,
        “proto”: “TCP”,
        “bname”: “S”
      },
      {
        “type”: “ipport”,
        “portnum”: 5021,
        “proto”: “TCP”,
        “bname”: “T”
      }
    ]
    “THRT”: [
      {
        “type”: “web”,
        “default”: false,
        “bname”: “HI”
      },
      {
        “type”: “web”,
        “default”: true,
        “bname”: “LO”
      }
    ]
  }
},
“perfconsts”: [
  {
    “name”: “VoIP”,
    “proto”: “tcp”,
    “port”: 5001,
    “del”: 50,
    “bw”: 100,
    “weight”: “(50,100)”
  },
  {
    “name”: “Video”,
    “proto”: “tcp”,
    “port”: 5011,
    “del”: 500,
    “bw”: 3000,
    “weight”: “(500,3000)”
  }
],
“edgelist”:[
  [1,2,{“cost”:1,“boolc”:“‘U’”}],
  [1,4,{“cost”:1,“boolc”:“Or(‘U’,‘S’)”}],
  [1,5,{“cost”:1,“boolc”:“Or(‘U’,‘S’,‘TS’)”}],
  [2,3,{“cost”:1,“boolc”:“‘U’”}],
  [2,5,{“cost”:1,“boolc”:“Or(‘U’,‘S’,‘TS’)”}],
  [2,4,{“cost”:1,“del”:10000,“bw”:1000000,“boolc”:“True”}],
  [4,3,{“cost”:1,“boolc”:“Or(‘U’,‘S’)”}],
  [4,5,{“cost”:1,“boolc”:“Or(‘U’,‘S’,‘TS’)”}],
  [5,3,{“cost”:1,“boolc”:“Or(‘U’,‘S’,‘TS’)”}]
]
“rconst_expr”: “And(Or(~U, ~S), Or(~U, ~TS), Or(~S, ~TS), Or(U, S, TS))”,
“fconst_str”: “And(True , Equal(‘U’, Or(‘IPxTCPxSRCPxU’,‘IPxTCPxDSTPxU’)),
Equal(‘S’,
Or(‘IPxTCPxSRCPxS’,‘IPxTCPxDSTPxS’)), Equal(‘TS’,
Or(‘IPxTCPxSRCPxT’,‘IPxTCPxDSTPxT’)), OneHot(‘IPxTCPxSRCPxDYNAMIC’,
‘IPxTCPxSRCPxUNASSIGNED’, ‘IPxUDPxSRCPxDYNAMIC’,
‘IPxUDPxSRCPxUNASSIGNED’, ‘IPxTCPxSRCPxU’, ‘IPxTCPxSRCPxS’,
‘IPxTCPxSRCPxT’),
OneHot(‘IPxTCPxDSTPxDYNAMIC’, ‘IPxTCPxDSTPxUNASSIGNED’,
‘IPxUDPxDSTPxDYNAMIC’, ‘IPxUDPxDSTPxUNASSIGNED’, ‘IPxTCPxDSTPxU’,
“fconst_expr”: “And(Or(~IPxTCPxSRCPxDYNAMIC,
~IPxTCPxSRCPxUNASSIGNED),
Or(~IPxTCPxSRCPxDYNAMIC, ~IPxUDPxSRCPxDYNAMIC),
Or(~IPxTCPxSRCPxDYNAMIC, ~IPxUDPxSRCPxUNASSIGNED),
Or(~IPxTCPxSRCPxU,
~IPxTCPxSRCPxDYNAMIC), Or(~IPxTCPxSRCPxS,
~IPxTCPxSRCPxDYNAMIC),
Or(~IPxTCPxSRCPxT, ~IPxTCPxSRCPxDYNAMIC),
Or(~IPxTCPxSRCPxUNASSIGNED,
(truncated)
},
```

which may include the following JSON components: “algorithm” may be the name of the currently active NwC algorithm that may be in use by the scenario; “routingconsts” may be the currently active NwC routing constraints; “flowconsts” may be the currently active NwC flow constraints; “flowvars” may be the currently active flow variables that can be used in various NwC; “perfconsts” may be the currently active performance constraints; “edgelist” may be the currently active networkX graph edgelist with NwC routing constraints; “rconst_expr” may be the currently active NwC computed routing constraint Boolean expression; “fconst_str” may be the currently active NwC computed flow constraint Boolean expression; and “fconst_expr” may be the currently active NwC computed flow constraint Boolean expression.

The API call “GET, PUT /curated/graph” may be configured to return a JSON structure when sent a GET request of the active instance configuration of the controller. The following JSON response may be provided:

```
{
[
  [
    1,
    2,
    {
    “cost”: 1,
    “boolc”: “‘SEC’”
    }
  ],
  [
    1,
    4,
    {
      “cost”: 1,
      “boolc”:
“Or(And(‘WEBxTHRTxLO’,Or(‘SEC’,‘APP’)),And(‘WEBxTHRTxHI’,‘SEC’))”
    }
  ],
  (truncated)
}.
```

The currently active networkX graph settings may be combined with the NwC link constraints. This may allow the export and import of a networkX graph structure with Curated NwC routing constraints into the running instance and may be used by the web interface forms.

The API call “GET /curated/defaultmetric” may be configured to return a JSON structure when sent a GET request of the active instance configuration of the controller. The following JSON response may be provided:

```
{
  “cost”: 1,
  “del”: 10000,
  “bw”: 1000000,
  “boolc”: “True”
}.
```

This may provide the currently active default metrics that may be assigned to non-specified routing constraints (e.g., the current instance defaults for routing metrics, may be read only, and may be used by web forms).

The API call “GET curated/dynamicport” may be configured to return a JSON structure when sent a GET request of the active instance configuration of the controller. The following JSON response may be provided:

```
{
  “min”: 32768,
  “max”: 60999
}.
```

This may provide the settings that may define an ephemeral or dynamic port for use in flow constraint variables (e.g., the current instance dynamic port range, may be read only, and may be used by web forms).

The API call “GET /curated/optionalvarsets” may be configured to return a JSON structure when sent a GET request of the active instance configuration of the controller. The following JSON response may be provided:

```
{
  “eth-proto”: false,
  “ip-proto”: false
}.
```

This may provide the settings for two optional variable sets that can be used for scenario rules (e.g., the current optional varsets that may be for specific NwC uses, may be read only, and may be used by web forms).

The API call “GET, PUT /curated/webvarsets” may be configured to return a JSON structure when sent a GET request of the active instance configuration of the controller. The following JSON response may be provided:
{“THRT”:“WEBxTHRTxLO”}.
   This may provide the currently active settings for any of the variable web varsets (e.g., an API interface for the manipulation of the state of webvars created with the web interface). A sample program to set their values with an external script may be provided.

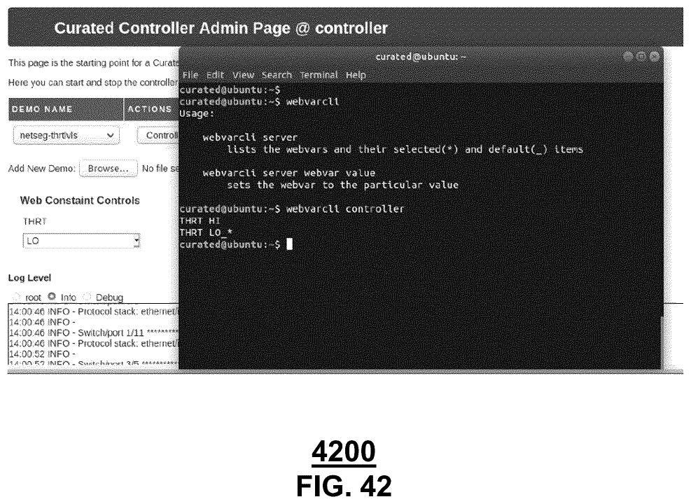

For example, a script may be provided to illustrate a method of reading and writing web variable sets. As shown by exemplary screen 4200 of FIG. 42, the command webvarcli may be used to show the defined webvars in the netseg-thrtlvls scenario. A default webvar entry may be followed by the underscore (“_”) character, which may correspond to the JSON value “default” being set to “true” in the webvar configuration. Therefore, the following JSON response may be provided for the API call “GET /curated/webvarsets”:

```
“THRT”:[
  {
  “type”: “web”,
  “default”: false,
  “bname”: “HI”
  },
  {
  “type”: “web”,
  “default”: true,
  “bname”: “LO”
  }
```

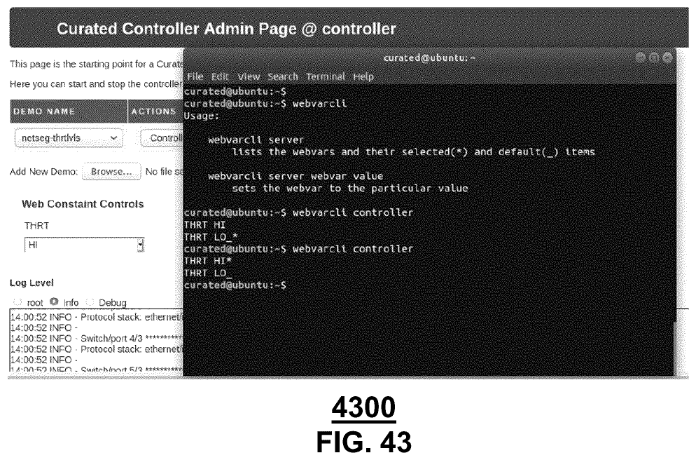

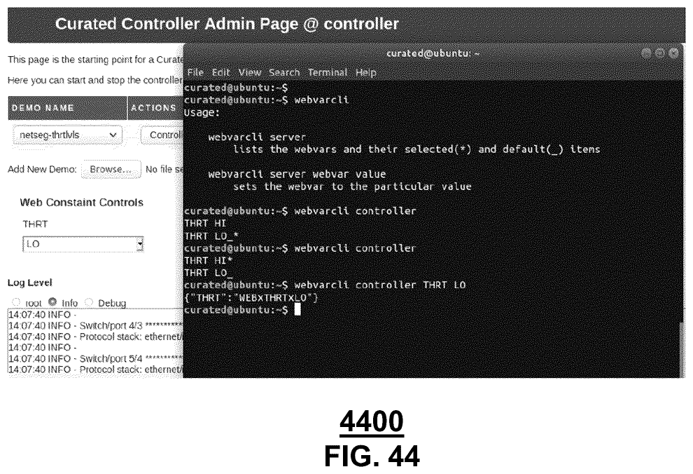

If the active setting on the web interface were to be changed, it may be reflected in the command-line interface (“CLI”) by the asterisk (“*”) symbol moving to the active webvar. As shown by exemplary screen 4300 of FIG. 43, the webvarcli may be used to read the current settings after web interface change. The active webvar may be changed by doing a POST to the /curated/webvarset of the name of the active webvar. When done, the web page may be refreshed (e.g., as shown in screen 4300). The POSTed JSON may be echoed to the screen for use in other commands, such as curl. As shown by screen 4400 of FIG. 44, the webvarcli may be used to write the active webvar.

Therefore, such an NwC system may be configured to provide support for remote control of Boolean variables. Such control may be enabled by the definition of any suitable interface for use in controlling these variables. As described, a platform provided by an NwC system may be implemented as an SDN controller with a web user interface, with which programmatic or remote control may be implemented as a representational state transfer (“REST”) service or any other suitable service for setting the values of Boolean variables, which may support the remote invocation of functions on a Web server (e.g., using HTTPS messages). Using such programmatic or remote control mechanisms, Boolean variables can be defined to reflect any state in the network or its environment that may have any significance for the network (e.g., policy significance for the network's configuration). With such variables, the network's configuration can be changed immediately, without the need for reconfiguration of network devices or reprogramming of SDN-based systems. Therefore, external control of the value for Boolean variables may be enabled. In some embodiments, variables (e.g., a variable representing DEFCON threat levels) may be set based solely or at least partially on external information (e.g., they may not require any information from the system or may require at least some information not from the network but from a remote or external source (e.g., not local data from a device or controller of the network)).

The NwC system may be configured to provide a much more general type of remote control, such as a solution where setting a value for a variable could be initiated by the system itself, rather than with an external system (e.g., as with DEFCON-like threat levels). For example, a new flow may be initiated by some specific user on a specific workstation intending to access some sensitive information via the NwC system. In such embodiments, a goal may be to set one or more variables indicating whether that particular user and/or that particular workstation are authorized to access the requested service of the NwC system, such that the system may be configured to make calls to some remote system to verify that (1) the user is authorized to access the NwC system and/or (2) the workstation is trusted for handling the requested information (e.g., to verify that the workstation is running the latest operating system release at some required patch level, etc. (e.g., data that may be accessible via query of a suitable network access control system)). For example, such variables may be “USER-AUTH-FOR-SERVICE” and “HOST-TRUSTED-FOR-SERVICE”. Part of the interface of the NwC system may be configured to include defining what information may be required by the external system to determine the value of these variables. For example, a remote Boolean variable source web interface may be provided by the NwC system (e.g., a web interface (e.g., an API and/or REST interface) between a network controller (e.g., controller device 100, controller 3402c, etc.) and a remote source (e.g., a particular data device 118, a user U of such a device, etc.) via any suitable communication coupling (e.g., via Internet 3402i. etc.), etc.). Such an interface may be configured to determine that the remote source is authorized to define a Boolean variable value before the interface may recognize a currently defined Boolean variable value from the remote source and implement that value in the network routing (e.g., to determine that certain external traffic coming to the network's controller is trusted to make a change to a Boolean variable value). For example, the interface may be configured to obtain any suitable information from the remote source to determine whether or not a remote source device is authorized to update a Boolean variable value (e.g., to verify that a workstation (e.g., a remote data device 118) is running the latest operating system release at some required patch level, etc. (e.g., “HOST-TRUSTED-FOR-SERVICE”)) and/or to obtain any suitable information from the remote source to determine whether or not a user of the remote source device is authorized to update a Boolean variable value (e.g., to verify that user U is authorized to access the NwC system using any suitable biometrics or any other suitable data that may be collected by device 118 from user U to authenticate the current user (e.g., “USER-AUTH-FOR-SERVICE”)). In some embodiments, if these verifications (e.g., remote user and/or remote device verifications) are able to be made, then the interface may be configured to enable that remote source device to provide any suitable update to any suitable Boolean variable value for any suitable Boolean variable that has been designated by the network as a variable that may be defined at least partially based on data from that remote source (e.g., not a variable that may be designated as only controllable by the network itself or otherwise (e.g., by a different remote source or otherwise)). Therefore, an interface may be provided to allow an external system to define or at least partially control (e.g., define a threshold that may be used to determine) the value of one or more Boolean variables of a network's routing algorithm(s) (e.g., for use at operation 1506 or otherwise). Therefore, such capability may have profound implications for network management. For example, in some embodiments, a system may be configured such that Boolean variables may be defined to reflect workstation configuration that may be acquired using network access control technology (e.g., operating system version and patch levels, etc.) and may be combined with variables that may be defined to represent information from threat feeds reflecting the severity of vulnerabilities discovered in operating system versions and patch levels. TE requirements may be defined that only allow workstations or subsystems or remote systems to access sensitive parts of a network if they are at patch levels with no known vulnerabilities, and traffic from vulnerable systems can be routed to sites that facilitate upgrades of vulnerable systems, with new vulnerabilities being configured to be integrated by the system into network behavior as soon as they are discovered. As shown with the backup traffic and DEFCON/MLS examples, the Boolean variable abstraction for TE requirements may provide a powerful mechanism for implementing programmatic or remote control of currently active network policies, enabling autonomic control of network services at time frames far shorter than is possible with humans in the control loop (e.g., when a DEFCON or other suitable Boolean variable value may be changed by a remote source, that change may be immediately ascertained by the network and used to immediately change the behavior of the network without a human network administrator interfacing the host or switch devices of the network themselves, such that autonomic networking may be enabled for remotely controlled Boolean variables).

It is to be noted that the concept of a REST API and REST service herein may be used to refer to a standard interface for managing state on a remote system using web URLs (e.g., a Web URL-based interface). It is to be understood that REST is also the name for a more general software architecture called “representational state transfer” that such a Web-style REST API may be based on.

One, some, or all of the processes and/or algorithms described with respect to FIGS. 1-44 and otherwise may each be partially or entirely implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of a network device 120). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from a central network controller device to a router device or from a data device to any network device. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure may be provided as a software construct, firmware construct, one or more hardware components, or a combination thereof. For example, any, each, or at least one module or component or subsystem of any suitable system may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of any suitable system of the disclosure may be stored in or otherwise accessible to a subsystem in any suitable manner (e.g., in memory 13). Any or each module of any suitable system of the disclosure may be implemented using any suitable technologies (e.g., as one or more integrated circuit devices), and different modules may or may not be identical in structure, capabilities, and operation. Any or all of the modules or other components of any suitable system of the disclosure may be mounted on an expansion card, mounted directly on a system motherboard, or integrated into a system chipset component (e.g., into a “north bridge” chip). At least a portion of one or more of the modules of any system of the disclosure may be stored in or otherwise accessible any suitable component(s) in any suitable manner. Any or each module of any suitable system of the disclosure may be implemented using any suitable technologies (e.g., as one or more integrated circuit devices), and different modules may or may not be identical in structure, capabilities, and operation. Any or all of the modules or other components of any suitable system of the disclosure may be mounted on an expansion card, mounted directly on a system motherboard, or integrated into a system chipset component (e.g., into a “north bridge” chip).

Any or each module of any suitable system of the disclosure may be a dedicated system implemented using one or more expansion cards adapted for various bus standards. For example, all of the modules may be mounted on different interconnected expansion cards or all of the modules may be mounted on one expansion card. With respect to system 1, by way of example only, modules of system 1 may interface with a motherboard or processor assembly 12 (e.g., of subsystem 120) through an expansion slot (e.g., a peripheral component interconnect (“PCI”) slot or a PCI express slot). Alternatively, modules of system 1 need not be removable but may include one or more dedicated modules that may include memory (e.g., RAM) dedicated to the utilization of the module. In other embodiments, modules of system 1 may be at least partially integrated into a subsystem (e.g., subsystem 120 (e.g., a server)). For example, a module of system 1 may utilize a portion of memory 13 of a subsystem. Any or each module of system 1 may include its own processing circuitry and/or memory. Alternatively, any or each module of system 1 may share processing circuitry and/or memory with any other module of system 1 and/or processor assembly 12 and/or memory assembly 13 of a subsystem (e.g., subsystem 120).

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof).

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As may be used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As may be used herein, the terms “computer,” “personal computer,” “device,” “computing device,” “router device,” and “controller device” may refer to any programmable computer system that is known or that will be developed in the future. In certain embodiments, a computer will be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As may be used herein, the terms “component,” “module,” and “system,” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

While there have been described systems, methods, and computer-readable media for providing remote control of Boolean variables defining expressions determining resource utilization of a data network, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. Various ones of FIGS. 1-44 may show illustrative user interfaces that may be presented to a user (e.g., by a graphical output component of any suitable user's user device) during different stages of use of the NwC system or otherwise. For example, a touch screen I/O component 16 may include a display output component that may be used to display a visual or graphic user interface (“GUI”), which may allow a user to interact with the user device. The GUI may include various layers, windows, screens, templates, elements, menus, and/or other components of a currently running application (e.g., application 19) that may be displayed in all or some of the areas of the display output component. For each presentation of a user interface, screens may be displayed on a display output component and may include various user interface elements. Additionally or alternatively, for each presentation, various other types of non-visual information may be provided to a user via various other output components of the user device. For example, in some embodiments, the user device may not include a user interface component operative to provide a GUI but may instead provide an audio output component and mechanical or other suitable user input components for selecting and interacting with the system.

Therefore, those skilled in the art will appreciate that the concepts of the disclosure can be practiced by other than the described embodiments, which are presented for purposes of illustration rather than of limitation.

1-16. (canceled)

17. A method for communicating data in a system comprising a data network and a remote data device communicatively coupled to the data network, the data network comprising a plurality of router nodes, the method comprising:
computing with the data network, for each router node of the plurality of router nodes, a best set of routes subject to a partial ordering;
assigning with the data network, at each router node of the plurality of router nodes, a local label that is unique to the particular router node for each computed route of the computed best set of routes for the particular router node;
defining with the data network, at a first router node of the plurality of router nodes, a next hop label for a first computed route of the computed best set of routes for the first router node based on the local label assigned for the first computed route at a second router node of the plurality of router nodes that is the next hop router node from the first router node for the first computed route;
receiving, at the first router node, at least one initial packet of a flow;
determining, with the data network, a plurality of flow constraints of the flow based on the received at least one initial packet, wherein the determining comprises identifying a first flow constraint of the plurality of flow constraints, and wherein the identifying comprises accessing, with the data network, a value of a first Boolean constraint variable from the remote data device using a web uniform resource locator (“URL”)-based interface;
selecting the first computed route from the computed best set of routes for the first router node based on at least the identified first flow constraint; and
forwarding, from the first router node to the second router node, a packet of the flow along with the defined next hop label for the selected first computed route for the first router node.

18. The method of claim 17, wherein:
the partial ordering is for a full range of routing constraints of the data network; and
the first flow constraint is not one of the routing constraints.

19. The method of claim 17, further comprising defining, at the second router node of the plurality of router nodes, a next hop label for the first computed route of the computed best set of routes for the second router node based on the local label assigned for the first computed route at a third router node of the plurality of router nodes that is the next hop router node from the second router node for the first computed route.

20. The method of claim 19, further comprising:
receiving, at the second router node, a packet of a flow along with a forwarded label;
identifying, at the second router node, an assigned local label for the second router node that is equal to the received forwarded label;
identifying, at the second router node, the defined next hop label for the second router node is associated with same computed route as the identified local label for the second router node; and
forwarding, from the second router node to a third router node, the received packet along with the identified defined next hop label for the second router node.

21. The method of claim 17, wherein the partial ordering is for a full range of routing constraints of the data network.

22. The method of claim 17, wherein the first flow constraint comprises a first Boolean expression that comprises at least the first Boolean constraint variable.

23. The method of claim 22, wherein:
the first Boolean expression further comprises a second Boolean constraint variable; and
the identifying the first flow constraint further comprises accessing, with the data network, a value of the second Boolean constraint variable.

24. The method of claim 23, wherein the accessing the value of the second Boolean constraint variable comprises accessing, with the data network, the value of the second Boolean constraint variable from a data source internal to the data network.

25. The method of claim 23, wherein:
the system further comprises another remote data device communicatively coupled to the data network; and
the accessing the value of the second Boolean constraint variable comprises accessing, with the data network, the value of the second Boolean constraint variable from the other remote data device using the web URL-based interface.

26. A method for communicating data in a system comprising a data network and a remote data device communicatively coupled to the data network, the data network comprising a plurality of router nodes, the method comprising:
defining Boolean variables reflecting states relevant to policies for resource utilization of the data network;
defining Boolean expressions with the defined Boolean variables for providing constraints;
computing routes and forwarding traffic within the data network based on the defined Boolean expressions;
determining when a state change occurs that results in a change in a value of any defined Boolean variable, wherein the determining comprises accessing, with the data network, a value of a first Boolean constraint variable from the remote data device using a web uniform resource locator (“URL”)-based interface; and
in response to the determining, at least one of:
recomputing the routes; or
updating forwarding rules associated with the routes.

27. The method of claim 26, further comprising, in response to the determining:
recomputing the routes; and
updating forwarding rules associated with the routes.

28. The method of claim 26, further comprising, in response to the determining, recomputing the routes.

29. The method of claim 26, further comprising, in response to the determining, updating forwarding rules associated with the routes.

30. The method of claim 26, wherein the determining further comprises accessing, with the data network, a value of a second Boolean constraint variable from a data source internal to the data network.

31. The method of claim 26, wherein:
the system further comprises another remote data device communicatively coupled to the data network; and
the determining further comprises accessing, with the data network, a value of a second Boolean constraint variable from the other remote data device using the web URL-based interface.

32. A method for communicating data in a system comprising a data network and a remote data device communicatively coupled to the data network, the data network comprising a plurality of router nodes, the method comprising:
identifying Boolean variables relevant to policies for resource utilization of the data network, wherein the identifying comprises accessing, with the data network, a value of a first identified Boolean variable of the identified Boolean variables from the remote data device using a web uniform resource locator (“URL”)-based interface;
classifying each identified Boolean variable as at least one of:
a routing variable; or
a forwarding variable;
using at least one classified routing variable to carry out a routing computation for the data network; and
using at least one classified forwarding variable to carry out a path selection computation for the data network.

33. The method of claim 32, wherein the identifying further comprises accessing, with the data network, a value of a second identified Boolean variable of the identified Boolean variables from a data source internal to the data network.

34. The method of claim 32, wherein:
the system further comprises; and
the determining further comprises accessing, with the data network, a value of a second Boolean constraint variable from another remote data device communicatively coupled to the data network using the web URL-based interface.

35-41. (canceled)
